SEQUENCE LISTING (888 sequences)

SEQ ID NO: 1 - DNA, 21 bp, Homo sapiens
tgaaggtcaacgacaaagagg

SEQ ID NO: 2 - DNA, 25 bp, Homo sapiens
catccctgtagtttactttctgagg

SEQ ID NO: 3 - DNA, 23 bp, Homo sapiens
catgagagcagacacagaatgac

SEQ ID NO: 4 - DNA, 23 bp, Homo sapiens
aacgacattttggttattgatgg

SEQ ID NO: 5 - DNA, 21 bp, Homo sapiens
tgtccggccttagttaatgtg

SEQ ID NO: 6 - DNA, 23 bp, Homo sapiens
atccatccaaccagtcatacaac

SEQ ID NO: 7 - DNA, 23 bp, Homo sapiens
gaaactgcactctctgacctctg

SEQ ID NO: 8 - DNA, 23 bp, Homo sapiens
gattctgttggtacagtgtgtcg

SEQ ID NO: 9 - DNA, 23 bp, Homo sapiens
tgttatgagaagtgacagccaga

SEQ ID NO: 10 - DNA, 24 bp, Homo sapiens
agctgaagatattcattagctggc

SEQ ID NO: 11 - DNA, 23 bp, Homo sapiens
tggaatcctacaggaatgtgaag

SEQ ID NO: 12 - DNA, 23 bp, Homo sapiens
caacacctgttagatgtctgctg

SEQ ID NO: 13 - DNA, 22 bp, Homo sapiens
ccagacatctcctaaatggagc

SEQ ID NO: 14 - DNA, 22 bp, Homo sapiens
gccacatcttagaaatgccttc

SEQ ID NO: 15 - DNA, 22 bp, Homo sapiens
cacagctagtggcagatcactc

SEQ ID NO: 16 - DNA, 23 bp, Homo sapiens
attctgtagggaaaggacagctc

SEQ ID NO: 17 - DNA, 24 bp, Homo sapiens
agagttggaaaacagttggagaag

SEQ ID NO: 18 - DNA, 23 bp, Homo sapiens
caccctagagttacacgttcctg

SEQ ID NO: 19 - DNA, 22 bp, Homo sapiens
atatggagcaggtctcctgtgt

SEQ ID NO: 20 - DNA, 25 bp, Homo sapiens
aatgacagtgagtggaagacaaagg

SEQ ID NO: 21 - DNA, 25 bp, Homo sapiens
cttcacccgtaaatggaggtcatag

SEQ ID NO: 22 - DNA, 21 bp, Homo sapiens
gcggggctgtaagggacgaag

SEQ ID NO: 23 - DNA, 28 bp, Homo sapiens
aagttttctccgattccacctaaagctc

SEQ ID NO: 24 - DNA, 21 bp, Homo sapiens
ctgggcgaatgaagcggcgtg

SEQ ID NO: 25 - DNA, 21 bp, Homo sapiens
caggaggcggaggtagcggtc

SEQ ID NO: 26 - DNA, 28 bp, Homo sapiens
tttaggaatctctcccacagctataacg

SEQ ID NO: 27 - DNA, 28 bp, Homo sapiens
gtgaatctctcaataaatggcgaatctg

SEQ ID NO: 28 - DNA, 28 bp, Homo sapiens
cctacacagttgacaattaaaaggttcc

SEQ ID NO: 29 - DNA, 28 bp, Homo sapiens
agtgacaaaatcttccataagcattagc

SEQ ID NO: 30 - DNA, 21 bp, Homo sapiens
gctttcctgccttactccacg

SEQ ID NO: 31 - DNA, 28 bp, Homo sapiens
tggtacagcaaaatgacatcccaacagc

SEQ ID NO: 32 - DNA, 28 bp, Homo sapiens
ccaacaccacaaggatttccatgtagac

SEQ ID NO: 33 - DNA, 28 bp, Homo sapiens
gataacatgcaacaacgtggttgactcc

SEQ ID NO: 34 - DNA, 28 bp, Homo sapiens
ctctcactcaaagtgcagaccaaatcag

SEQ ID NO: 35 - DNA, 21 bp, Homo sapiens
atcacctggttcaccgtatgg

SEQ ID NO: 36 - DNA, 21 bp, Homo sapiens
gcacaggtggggagagggtag

SEQ ID NO: 37 - DNA, 28 bp, Homo sapiens
ctcacagcatggataaagctgcgggaag

SEQ ID NO: 38 - DNA, 21 bp, Homo sapiens
cgggaagggactcacggacag

SEQ ID NO: 39 - DNA, 21 bp, Homo sapiens
gtatccatcaccaaagcagcg

SEQ ID NO: 40 - DNA, 28 bp, Homo sapiens
caagtaaacagtcaagaaattccgtaag

SEQ ID NO: 41 - DNA, 28 bp, Homo sapiens
catttggctacctgatgttgtccctcac

SEQ ID NO: 42 - DNA, 28 bp, Homo sapiens
ttacggttacctgaaagactggtacggg

SEQ ID NO: 43 - DNA, 21 bp, Homo sapiens
tccacccaactctgacgcctc

SEQ ID NO: 44 - DNA, 28 bp, Homo sapiens
gaggtaaactcagccaagtaggaggaac

SEQ ID NO: 45 - DNA, 28 bp, Homo sapiens
tgaactgccttagagtaaatccgctttc

SEQ ID NO: 46 - DNA, 21 bp, Homo sapiens
ccaggcaaaccctctgacccg

SEQ ID NO: 47 - DNA, 21 bp, Homo sapiens
acgggaataacagagggtgcg

SEQ ID NO: 48 - DNA, 28 bp, Homo sapiens
tatgtcatttcaaagtagtggtgcgaac

SEQ ID NO: 49 - DNA, 28 bp, Homo sapiens
gagggagaacttagagccattcactacg

SEQ ID NO: 50 - DNA, 21 bp, Homo sapiens
cagatactcagcggcattgcg

SEQ ID NO: 51 - DNA, 23 bp, Homo sapiens
aggaccaatgtatgtgtatctgg

SEQ ID NO: 52 - DNA, 23 bp, Homo sapiens
ccccaagagacacagaaactgcg

SEQ ID NO: 53 - DNA, 28 bp, Homo sapiens
gcacacagccatcagacagaaggcaacc

SEQ ID NO: 54 - DNA, 23 bp, Homo sapiens
gctcagcccaaccctgcgtatgc

SEQ ID NO: 55 - DNA, 28 bp, Homo sapiens
atacgaggacaagaggatgtttcaaatc

SEQ ID NO: 56 - DNA, 28 bp, Homo sapiens
ctaacctgggtggagaaagccgaagaag

SEQ ID NO: 57 - DNA, 28 bp, Homo sapiens
tccttctcagggctttgcgtttagtaag

SEQ ID NO: 58 - DNA, 23 bp, Homo sapiens
tacagccacacagcagattcggc

SEQ ID NO: 59 - DNA, 23 bp, Homo sapiens
gggagcagtgcctggctacggtc

SEQ ID NO: 60 - DNA, 23 bp, Homo sapiens
aacccactctgagcactcggcac

SEQ ID NO: 61 - DNA, 21 bp, Homo sapiens
tggaaggtgccctccgcatcg

SEQ ID NO: 62 - DNA, 21 bp, Homo sapiens
cgagttgcacagtccaattcg

SEQ ID NO: 63 - DNA, 23 bp, Homo sapiens
cttgggcagaacctgggcagtcg

SEQ ID NO: 64 - DNA, 23 bp, Homo sapiens
actgacccactgccgtgtgaacc

SEQ ID NO: 65 - DNA, 23 bp, Homo sapiens
actcaggtggggacttgtgacgc

SEQ ID NO: 66 - DNA, 25 bp, Homo sapiens
atccaaacaggctgatgctcttcac

SEQ ID NO: 67 - DNA, 23 bp, Homo sapiens
gtccaagtgaggaggaaatacac

SEQ ID NO: 68 - DNA, 25 bp, Homo sapiens
aggctctggacctcacgggattcgg

SEQ ID NO: 69 - DNA, 25 bp, Homo sapiens
taagttgtatccttcgcctaatggg

SEQ ID NO: 70 - DNA, 25 bp, Homo sapiens
taggtggtttctttgttcttgactc

SEQ ID NO: 71 - DNA, 25 bp, Homo sapiens
ggtatttggtggtggctgttatttc

SEQ ID NO: 72 - DNA, 25 bp, Homo sapiens
tgagtaggaagcgaatagcgtgaag

SEQ ID NO: 73 - DNA, 23 bp, Homo sapiens
ggaggtaggaggcttcccgttag

SEQ ID NO: 74 - DNA, 23 bp, Homo sapiens
ggcttgtgttccactgggcaatc

SEQ ID NO: 75 - DNA, 28 bp, Homo sapiens
ggctgaccactcggaggaggagaagaag

SEQ ID NO: 76 - DNA, 28 bp, Homo sapiens
cccctccctccagagcggaacctgaatc

SEQ ID NO: 77 - DNA, 23 bp, Homo sapiens
aatgatgtcaccttggaacagtc

SEQ ID NO: 78 - DNA, 23 bp, Homo sapiens
cgccttccaaaagagcctcaacg

SEQ ID NO: 79 - DNA, 25 bp, Homo sapiens
gaagtgtgctctgaacaggacgaac

SEQ ID NO: 80 - DNA, 26 bp, Homo sapiens
tctgcttctgtgaccacgggacggtg

SEQ ID NO: 81 - DNA, 26 bp, Homo sapiens
ctcttacttgactctccacggctgag

SEQ ID NO: 82 - DNA, 26 bp, Homo sapiens
gatagagaagaatgtgaagaccgagc

SEQ ID NO: 83 - DNA, 21 bp, Homo sapiens
tcggagcagcggcttgatgcc

SEQ ID NO: 84 - DNA, 21 bp, Homo sapiens
gcgtgtgttccctccccaacg

SEQ ID NO: 85 - DNA, 21 bp, Homo sapiens
gttgggcttgctcaatcgctc

SEQ ID NO: 86 - DNA, 21 bp, Homo sapiens
taggaggcagaactcggttgg

SEQ ID NO: 87 - DNA, 21 bp, Homo sapiens
taccaaacagcccacaatgcg

SEQ ID NO: 88 - DNA, 21 bp, Homo sapiens
cacagcaatcactccgcacac

SEQ ID NO: 89 - DNA, 21 bp, Homo sapiens
gtcctctggaaagtaaggtcg

SEQ ID NO: 90 - DNA, 21 bp, Homo sapiens
gggagacgaacagagaagtcg

SEQ ID NO: 91 - DNA, 21 bp, Homo sapiens
tctccattacagtcggtgggc

SEQ ID NO: 92 - DNA, 21 bp, Homo sapiens
gtctcccattaccgttcgtcc

SEQ ID NO: 93 - DNA, 21 bp, Homo sapiens
gtgccaggtgaccatacgctc

SEQ ID NO: 94 - DNA, 21 bp, Homo sapiens
ccaggagtgacatcgctaagg

SEQ ID NO: 95 - DNA, 21 bp, Homo sapiens
tggggacttcattcttcaccg

SEQ ID NO: 96 - DNA, 21 bp, Homo sapiens
taacgaatgtgcccagcgaac

SEQ ID NO: 97 - DNA, 21 bp, Homo sapiens
cctccaaaactatttccgccc

SEQ ID NO: 98 - DNA, 21 bp, Homo sapiens
gaacacgacctctgaccaacg

SEQ ID NO: 99 - DNA, 21 bp, Homo sapiens
atctccctgtttcagcgtcgg

SEQ ID NO: 100 - DNA, 28 bp, Homo sapiens
gagttctgctcttctgtgtctctgctcg

SEQ ID NO: 101 - DNA, 28 bp, Homo sapiens
gcacacagtgatttgcagtgtaatagtc

SEQ ID NO: 102 - DNA, 21 bp, Homo sapiens
atgtcagttcagccgtgattc

SEQ ID NO: 103 - DNA, 21 bp, Homo sapiens
ggagaacaggagaacgcatcc

SEQ ID NO: 104 - DNA, 21 bp, Homo sapiens
tcactccaacataggcggaac

SEQ ID NO: 105 - DNA, 21 bp, Homo sapiens
ttacacaggagatgggttagc

SEQ ID NO: 106 - DNA, 28 bp, Homo sapiens
gcaaacaaagacactaccttccagacgc

SEQ ID NO: 107 - DNA, 28 bp, Homo sapiens
ctttttcagtgatactaaaccgcatagg

SEQ ID NO: 108 - DNA, 21 bp, Homo sapiens
tatgcgtttagggtcctgacg

SEQ ID NO: 109 - DNA, 21 bp, Homo sapiens
ggttgcttaggttgttgaccg

SEQ ID NO: 110 - DNA, 21 bp, Homo sapiens
tccttctcattcccagtaacg

SEQ ID NO: 111 - DNA, 21 bp, Homo sapiens
aacctctccccacattcccgc

SEQ ID NO: 112 - DNA, 21 bp, Homo sapiens
tgtctctctgtaaacccgctg

SEQ ID NO: 113 - DNA, 21 bp, Homo sapiens
tgcctctgacggctaaactcg

SEQ ID NO: 114 - DNA, 21 bp, Homo sapiens
gtgggtttgaaaagatgcgac

SEQ ID NO: 115 - DNA, 28 bp, Homo sapiens
tcggctgagctgagaaatgctaccgcag

SEQ ID NO: 116 - DNA, 21 bp, Homo sapiens
atggcttggctttatgtagcg

SEQ ID NO: 117 - DNA, 21 bp, Homo sapiens
ccccatacggttctgtggtcg

SEQ ID NO: 118 - DNA, 21 bp, Homo sapiens
tggatggacacactggcgtcg

SEQ ID NO: 119 - DNA, 21 bp, Homo sapiens
tcttcacaaacccaccgcaag

SEQ ID NO: 120 - DNA, 21 bp, Homo sapiens
ggggaccctaactgacccgtc

SEQ ID NO: 121 - DNA, 21 bp, Homo sapiens
cagggtgctcaggtagcctcg

SEQ ID NO: 122 - DNA, 21 bp, Homo sapiens
tagaacctcagttggcgtctg

SEQ ID NO: 123 - DNA, 21 bp, Homo sapiens
cccagcgtgctccctgtatcg

SEQ ID NO: 124 - DNA, 28 bp, Homo sapiens
atgaacagaatctggcttcctcgcattc

SEQ ID NO: 125 - DNA, 28 bp, Homo sapiens
atgaacagaatctggcttcctcgcattc

SEQ ID NO: 126 - DNA, 21 bp, Homo sapiens
aaatgagagaagccgttgccc

SEQ ID NO: 127 - DNA, 21 bp, Homo sapiens
tccaggtgggcaggaacgctc

SEQ ID NO: 128 - DNA, 21 bp, Homo sapiens
cagccctttgatttcactcgc

SEQ ID NO: 129 - DNA, 28 bp, Homo sapiens
gatcaagttgactggtagtgccgtttag

SEQ ID NO: 130 - DNA, 21 bp, Homo sapiens
tgaagacccttgggagttacg

SEQ ID NO: 131 - DNA, 21 bp, Homo sapiens
ggatggggtgtggaagagacg

SEQ ID NO: 132 - DNA, 23 bp, Homo sapiens
cttgcttctggtgggtgccttag

SEQ ID NO: 133 - DNA, 23 bp, Homo sapiens
tacctcgctgctcacccactcgg

SEQ ID NO: 134 - DNA, 26 bp, Homo sapiens
aggtgtggcttctgctaactatctac

SEQ ID NO: 135 - DNA, 23 bp, Homo sapiens
ggagaaagaaggatggcggtatc

SEQ ID NO: 136 - DNA, 24 bp, Homo sapiens
caacagtcaaaggtgtccgaatag

SEQ ID NO: 137 - DNA, 23 bp, Homo sapiens
cccagcacacagcaggactcggc

SEQ ID NO: 138 - DNA, 23 bp, Homo sapiens
ggggcaggcttcataacttgtgg

SEQ ID NO: 139 - DNA, 23 bp, Homo sapiens
caactttattgagaccttgcgtg

SEQ ID NO: 140 - DNA, 23 bp, Homo sapiens
gaccgttgaactgaccgtaacag

SEQ ID NO: 141 - DNA, 23 bp, Homo sapiens
tccaagggcatacctgactattc

SEQ ID NO: 142 - DNA, 23 bp, Homo sapiens
tggtagtcctcacacctttgccg

SEQ ID NO: 143 - DNA, 23 bp, Homo sapiens
ggatgatttggttggaacgaagc

SEQ ID NO: 144 - DNA, 23 bp, Homo sapiens
tagagtcaaacaggctggtctgc

SEQ ID NO: 145 - DNA, 23 bp, Homo sapiens
atgggtgagtgggtgagtgaacg

SEQ ID NO: 146 - DNA, 23 bp, Homo sapiens
gcccagacagcctttcggtggag

SEQ ID NO: 147 - DNA, 26 bp, Homo sapiens
tgattgtcagactgaaacaggtagtg

SEQ ID NO: 148 - DNA, 24 bp, Homo sapiens
ggaaggtccataataacaaatcgc

SEQ ID NO: 149 - DNA, 25 bp, Homo sapiens
aacaaatgtaggttgaatgatgacc

SEQ ID NO: 150 - DNA, 24 bp, Homo sapiens
agtagatttagcatagacgagccg

SEQ ID NO: 151 - DNA, 23 bp, Homo sapiens
gagggtaggaggtggcaggtgcg

SEQ ID NO: 152 - DNA, 23 bp, Homo sapiens
agagtggcagcaagagtagcgtc

SEQ ID NO: 153 - DNA, 23 bp, Homo sapiens
gaatgacggttccctgccagtcc

SEQ ID NO: 154 - DNA, 23 bp, Homo sapiens
acccttccacctctgaaagcgac

SEQ ID NO: 155 - DNA, 25 bp, Homo sapiens
tttcagaccaaccagaatagttacg

SEQ ID NO: 156 - DNA, 23 bp, Homo sapiens
tgctctgacaaactgccgtagac

SEQ ID NO: 157 - DNA, 23 bp, Homo sapiens
tgctggtggtagtcattagcggg

SEQ ID NO: 158 - DNA, 23 bp, Homo sapiens
ttggagagtcttggggattgttg

SEQ ID NO: 159 - DNA, 23 bp, Homo sapiens
aacccagaagttccagatgaccg

SEQ ID NO: 160 - DNA, 23 bp, Homo sapiens
aaagtatgttggattggcacaag

SEQ ID NO: 161 - DNA, 23 bp, Homo sapiens
gggtcagtcagttgagtaagtgg

SEQ ID NO: 162 - DNA, 25 bp, Homo sapiens
agttccttctctgtagatagcccag

SEQ ID NO: 163 - DNA, 23 bp, Homo sapiens
ggagagcaaaactgtggctaagc

SEQ ID NO: 164 - DNA, 23 bp, Homo sapiens
gtggctaaaggaggatgagtcag

SEQ ID NO: 165 - DNA, 23 bp, Homo sapiens
actcctcatttgccactcccctg

SEQ ID NO: 166 - DNA, 25 bp, Homo sapiens
tgattcaccttactgttgcctattg

SEQ ID NO: 167 - DNA, 23 bp, Homo sapiens
atgttgaagccctactcccgttg

SEQ ID NO: 168 - DNA, 23 bp, Homo sapiens
gcagcacagaaactgaaatgccc

SEQ ID NO: 169 - DNA, 23 bp, Homo sapiens
gaagaggctcggagaaggacacg

SEQ ID NO: 170 - DNA, 23 bp, Homo sapiens
agttgagattcctgctccgtcac

SEQ ID NO: 171 - DNA, 23 bp, Homo sapiens
aagtgctgtaaactgtaggcgtg

SEQ ID NO: 172 - DNA, 23 bp, Homo sapiens
tgagagggctttagcaatcaggc

SEQ ID NO: 173 - DNA, 25 bp, Homo sapiens
gttatgtatcttgttgctgtgaggg

SEQ ID NO: 174 - DNA, 24 bp, Homo sapiens
caaagaaggctaatggaatggaag

SEQ ID NO: 175 - DNA, 26 bp, Homo sapiens
gtttgatacatagttagggctgttcg

SEQ ID NO: 176 - DNA, 23 bp, Homo sapiens
tagcacccttgattgagaagtcg

SEQ ID NO: 177 - DNA, 24 bp, Homo sapiens
gccttctacatcctgttcttcacc

SEQ ID NO: 178 - DNA, 23 bp, Homo sapiens
ctgggacactgtgctgttggctg

SEQ ID NO: 179 - DNA, 23 bp, Homo sapiens
ggctaacccatcttgtatccgtg

SEQ ID NO: 180 - DNA, 23 bp, Homo sapiens
atgtgggctctcatctccgttac

SEQ ID NO: 181 - DNA, 23 bp, Homo sapiens
tatgaggaggcacttggtcgttc

SEQ ID NO: 182 - DNA, 25 bp, Homo sapiens
ccagaataagaacaacaaacggaag

SEQ ID NO: 183 - DNA, 28 bp, Homo sapiens
gtaaataccaccataaacctaatcaacc

SEQ ID NO: 184 - DNA, 24 bp, Homo sapiens
catagattagcaggttgttccacg

SEQ ID NO: 185 - DNA, 23 bp, Homo sapiens
gatgaagaagtcagagtgcgaag

SEQ ID NO: 186 - DNA, 24 bp, Homo sapiens
gagagagaaaaggagaataagcgg

SEQ ID NO: 187 - DNA, 23 bp, Homo sapiens
tagaaacaaggcaccccaggaac

SEQ ID NO: 188 - DNA, 23 bp, Homo sapiens
gctttggtcagtgttgttaggtc

SEQ ID NO: 189 - DNA, 23 bp, Homo sapiens
ggactaccagccatttgctacgc

SEQ ID NO: 190 - DNA, 26 bp, Homo sapiens
gaagacaatagacagtgtgcgttatg

SEQ ID NO: 191 - DNA, 23 bp, Homo sapiens
aagtcctccatcaccagaccgac

SEQ ID NO: 192 - DNA, 23 bp, Homo sapiens
cacattccagaccaagaaacgac

SEQ ID NO: 193 - DNA, 24 bp, Homo sapiens
gccttgtcttacttgtatttcccg

SEQ ID NO: 194 - DNA, 23 bp, Homo sapiens
ggggtattgtggatggcagcggg

SEQ ID NO: 195 - DNA, 23 bp, Homo sapiens
gctcagttgtttgcttccctgcg

SEQ ID NO: 196 - DNA, 23 bp, Homo sapiens
aaccaatacaaaaacccatttcg

SEQ ID NO: 197 - DNA, 23 bp, Homo sapiens
tggaaagggaacacaactcatcg

SEQ ID NO: 198 - DNA, 23 bp, Homo sapiens
agcaaggcttacctggctgtcgg

SEQ ID NO: 199 - DNA, 23 bp, Homo sapiens
tcactgccactcgccaccgtctg

SEQ ID NO: 200 - DNA, 23 bp, Homo sapiens
aagggagtcacacaaggcgggag

SEQ ID NO: 201 - DNA, 23 bp, Homo sapiens
accagagaagccccttttgatac

SEQ ID NO: 202 - DNA, 23 bp, Homo sapiens
gaagagatgggaagggtcgtttg

SEQ ID NO: 203 - DNA, 23 bp, Homo sapiens
tgggacagggacaagtttgacgg

SEQ ID NO: 204 - DNA, 23 bp, Homo sapiens
aacaagacttcaggtcacgctcg

SEQ ID NO: 205 - DNA, 23 bp, Homo sapiens
actctggacaggaggggcgaagg

SEQ ID NO: 206 - DNA, 23 bp, Homo sapiens
ggtcacccttacctttgcggctc

SEQ ID NO: 207 - DNA, 23 bp, Homo sapiens
tgaccaaacaaataaatcccgtg

SEQ ID NO: 208 - DNA, 23 bp, Homo sapiens
attcctacctcgttgagtcatcg

SEQ ID NO: 209 - DNA, 23 bp, Homo sapiens
cccacaacagaggaggcgtattc

SEQ ID NO: 210 - DNA, 23 bp, Homo sapiens
aagtggactgccaaatgttctcg

SEQ ID NO: 211 - DNA, 23 bp, Homo sapiens
tgtgagttagagagggtgcttcg

SEQ ID NO: 212 - DNA, 23 bp, Homo sapiens
tcctgagccttcttaccatagcg

SEQ ID NO: 213 - DNA, 23 bp, Homo sapiens
tatggtgaggcttgctgtagatg

SEQ ID NO: 214 - DNA, 23 bp, Homo sapiens
atgggaaagaaggtggcgtggac

SEQ ID NO: 215 - DNA, 23 bp, Homo sapiens
ggttctatgataatgcccgattg

SEQ ID NO: 216 - DNA, 23 bp, Homo sapiens
aggcattcttcccattcaaacgg

SEQ ID NO: 217 - DNA, 28 bp, Homo sapiens
aatggtgtatttcttctgttcacgatag

SEQ ID NO: 218 - DNA, 23 bp, Homo sapiens
tggtccacactgcatccgtggtc

SEQ ID NO: 219 - DNA, 25 bp, Homo sapiens
tttccaagttctttccctatctacg

SEQ ID NO: 220 - DNA, 23 bp, Homo sapiens
ccctactcagtacatctgtcccg

SEQ ID NO: 221 - DNA, 23 bp, Homo sapiens
acaatgggctttgctatcgttgc

SEQ ID NO: 222 - DNA, 23 bp, Homo sapiens
aggtcttgggagttcttcgtctg

SEQ ID NO: 223 - DNA, 23 bp, Homo sapiens
atgagactgctactgtccatccg

SEQ ID NO: 224 - DNA, 23 bp, Homo sapiens
tgctgcttcaggaggttcacggc

SEQ ID NO: 225 - DNA, 23 bp, Homo sapiens
caagcaggactttctaagcaccg

SEQ ID NO: 226 - DNA, 23 bp, Homo sapiens
ggaggtgctaccctggaccatcg

SEQ ID NO: 227 - DNA, 23 bp, Homo sapiens
aggtcacacagggttctcgcttc

SEQ ID NO: 228 - DNA, 23 bp, Homo sapiens
ctgattcaagacagtgttggtcg

SEQ ID NO: 229 - DNA, 24 bp, Homo sapiens
gccatacaacttattagcatcccg

SEQ ID NO: 230 - DNA, 23 bp, Homo sapiens
actgtgtgactactttcgggcac

SEQ ID NO: 231 - DNA, 23 bp, Homo sapiens
cagagaatggatgagtgaacgag

SEQ ID NO: 232 - DNA, 23 bp, Homo sapiens
tctccctgagtctcttacgcatc

SEQ ID NO: 233 - DNA, 23 bp, Homo sapiens
tcccaagttatgaaacggatagc

SEQ ID NO: 234 - DNA, 23 bp, Homo sapiens
aagtgtggggatacaggcgttag

SEQ ID NO: 235 - DNA, 23 bp, Homo sapiens
tcagtaagtcagagccctcgcac

SEQ ID NO: 236 - DNA, 23 bp, Homo sapiens
tgggtttctgagagtcctcggcg

SEQ ID NO: 237 - DNA, 23 bp, Homo sapiens
gttccaggtgccactgaccaatc

SEQ ID NO: 238 - DNA, 23 bp, Homo sapiens
tgcctatgggagcctacaggacg

SEQ ID NO: 239 - DNA, 23 bp, Homo sapiens
cctgtgccgttctcctaatagcg

SEQ ID NO: 240 - DNA, 23 bp, Homo sapiens
tacatctttgagaggtcgtcacg

SEQ ID NO: 241 - DNA, 23 bp, Homo sapiens
ccaaaatggtctggacgagaaag

SEQ ID NO: 242 - DNA, 23 bp, Homo sapiens
gtccaagtttgagggcgagtgtc

SEQ ID NO: 243 - DNA, 23 bp, Homo sapiens
ggagaactggatgaacacgggac

SEQ ID NO: 244 - DNA, 23 bp, Homo sapiens
atgtgacaatcagggttgcgatg

SEQ ID NO: 245 - DNA, 23 bp, Homo sapiens
ctgtgaggtctggttccccgacg

SEQ ID NO: 246 - DNA, 23 bp, Homo sapiens
gtaaatggtaaggtgaaagccgc

SEQ ID NO: 247 - DNA, 23 bp, Homo sapiens
gcacaaataagaatgacaagcgg

SEQ ID NO: 248 - DNA, 23 bp, Homo sapiens
tctcaatgccccaagaacgcacc

SEQ ID NO: 249 - DNA, 23 bp, Homo sapiens
gtctttcctcaaccttcgcattc

SEQ ID NO: 250 - DNA, 23 bp, Homo sapiens
gctcagcatcaaagtccatcgtg

SEQ ID NO: 251 - DNA, 23 bp, Homo sapiens
tccctgtgtccttgtaccgtcac

SEQ ID NO: 252 - DNA, 23 bp, Homo sapiens
acagccatctggtagacggtcag

SEQ ID NO: 253 - DNA, 23 bp, Homo sapiens
caggagtttgaatcagacgatgc

SEQ ID NO: 254 - DNA, 23 bp, Homo sapiens
caggagacccctcaccgaccaac

SEQ ID NO: 255 - DNA, 23 bp, Homo sapiens
cagttcactcagacatcggtggc

SEQ ID NO: 256 - DNA, 23 bp, Homo sapiens
gaggctggctaaacaaacggtag

SEQ ID NO: 257 - DNA, 23 bp, Homo sapiens
gtgattagagggggtgcgaggcg

SEQ ID NO: 258 - DNA, 23 bp, Homo sapiens
ttgactcttccccactccactac

SEQ ID NO: 259 - DNA, 23 bp, Homo sapiens
ttgccaggacttaggtttcggag

SEQ ID NO: 260 - DNA, 23 bp, Homo sapiens
tcaagtaaatctccctggcacgc

SEQ ID NO: 261 - DNA, 23 bp, Homo sapiens
ggcagtgttcctcttcggtgttc

SEQ ID NO: 262 - DNA, 23 bp, Homo sapiens
agagaaaacaaagggggacaacg

SEQ ID NO: 263 - DNA, 23 bp, Homo sapiens
acctgatacctgcctaactggtc

SEQ ID NO: 264 - DNA, 23 bp, Homo sapiens
gagttccaggaggaccccttgcg

SEQ ID NO: 265 - DNA, 24 bp, Homo sapiens
gcctgactctgacttgtgaatgtc

SEQ ID NO: 266 - DNA, 23 bp, Homo sapiens
ggcgggattcaggtggaaggcgg

SEQ ID NO: 267 - DNA, 23 bp, Homo sapiens
gtgtctttgtttcccacggctgc

SEQ ID NO: 268 - DNA, 23 bp, Homo sapiens
gttggatgtggtggagcggtttg

SEQ ID NO: 269 - DNA, 23 bp, Homo sapiens
agtttaggggcagagcgagtaag

SEQ ID NO: 270 - DNA, 24 bp, Homo sapiens
tcactgagccctggacccaatcgc

SEQ ID NO: 271 - DNA, 24 bp, Homo sapiens
acactcaaaaatgtgactcggtcc

SEQ ID NO: 272 - DNA, 24 bp, Homo sapiens
gagccaccagccacctccgcacag

SEQ ID NO: 273 - DNA, 24 bp, Homo sapiens
gatggggtgtgaggtagtttgacg

SEQ ID NO: 274 - DNA, 24 bp, Homo sapiens
agacaaatagcggctgacggcggg

SEQ ID NO: 275 - DNA, 24 bp, Homo sapiens
tgctgtccacatactgttggtgac

SEQ ID NO: 276 - DNA, 24 bp, Homo sapiens
aagcagcactgtcctcgcacgcac

SEQ ID NO: 277 - DNA, 24 bp, Homo sapiens
gaacacaggcgtggtttccagttg

SEQ ID NO: 278 - DNA, 24 bp, Homo sapiens
aaaagtcggagtggggctaagtgg

SEQ ID NO: 279 - DNA, 24 bp, Homo sapiens
ctgtccacactacacacccgtccg

SEQ ID NO: 280 - DNA, 26 bp, Homo sapiens
tctgtctctgtctttctccgttactc

SEQ ID NO: 281 - DNA, 24 bp, Homo sapiens
tggaggatgggtggactgacggag

SEQ ID NO: 282 - DNA, 24 bp, Homo sapiens
ggaaccctcaaaaatgtgattcgg

SEQ ID NO: 283 - DNA, 23 bp, Homo sapiens
ctctgcccccactctcggtctac

SEQ ID NO: 284 - DNA, 25 bp, Homo sapiens
ctattttcactatctccatacgggg

SEQ ID NO: 285 - DNA, 24 bp, Homo sapiens
tggggggcaggaggagcaaggagc

SEQ ID NO: 286 - DNA, 24 bp, Homo sapiens
gatgacaaaggagaagatgagcgg

SEQ ID NO: 287 - DNA, 24 bp, Homo sapiens
atgctgtccccactcatctgcgac

SEQ ID NO: 288 - DNA, 24 bp, Homo sapiens
cattcttcctgttccttgctggac

SEQ ID NO: 289 - DNA, 24 bp, Homo sapiens
taaccatcctccagacctacttcc

SEQ ID NO: 290 - DNA, 24 bp, Homo sapiens
catttgctaagatgctccgtaagc

SEQ ID NO: 291 - DNA, 29 bp, Homo sapiens
caagacacaaactgtaaaagacttattgg

SEQ ID NO: 292 - DNA, 24 bp, Homo sapiens
tcttatttgcctcttatgcgtagc

SEQ ID NO: 293 - DNA, 26 bp, Homo sapiens
gagaggtatttgaaggaagttatggg

SEQ ID NO: 294 - DNA, 24 bp, Homo sapiens
cacgcctcctgggaagactcgccg

SEQ ID NO: 295 - DNA, 24 bp, Homo sapiens
gtgaggtctccacacccaacgcac

SEQ ID NO: 296 - DNA, 24 bp, Homo sapiens
ggagcattctcaggggctgtcgtg

SEQ ID NO: 297 - DNA, 24 bp, Homo sapiens
aggcaccagggaccagtctcggag

SEQ ID NO: 298 - DNA, 24 bp, Homo sapiens
tcacacagtcagagacaacgaacc

SEQ ID NO: 299 - DNA, 24 bp, Homo sapiens
acccacagcatcacacggtccatc

SEQ ID NO: 300 - DNA, 24 bp, Homo sapiens
gtgatttgtgggcaacttatgaac

SEQ ID NO: 301 - DNA, 24 bp, Homo sapiens
cagaaggacaacagtgagggttac

SEQ ID NO: 302 - DNA, 24 bp, Homo sapiens
ggagtttcttccctgtgcggagtc

SEQ ID NO: 303 - DNA, 24 bp, Homo sapiens
ccctcctgtgtccagaccaatccg

SEQ ID NO: 304 - DNA, 24 bp, Homo sapiens
ccctcctgtgtccagaccaatccg

SEQ ID NO: 305 - DNA, 24 bp, Homo sapiens
ctctccactccctgcgtatccccg

SEQ ID NO: 306 - DNA, 24 bp, Homo sapiens
cactgttggtggttatggaaatcg

SEQ ID NO: 307 - DNA, 24 bp, Homo sapiens
atggtgacctgggaccgtttgagg

SEQ ID NO: 308 - DNA, 24 bp, Homo sapiens
agacgagaaaaaggcactcctacg

SEQ ID NO: 309 - DNA, 24 bp, Homo sapiens
cactcccttgttctaatcaccccg

SEQ ID NO: 310 - DNA, 25 bp, Homo sapiens
ttgacttgttatctatgttgctcgc

SEQ ID NO: 311 - DNA, 27 bp, Homo sapiens
ttatgtttgaagttgacactctatcgc

SEQ ID NO: 312 - DNA, 23 bp, Homo sapiens
tgtgctgaggggcgggacggtgg

SEQ ID NO: 313 - DNA, 23 bp, Homo sapiens
gggatggggatgggcagtgattg

SEQ ID NO: 314 - DNA, 23 bp, Homo sapiens
ccccacccgatgtctcccacaac

SEQ ID NO: 315 - DNA, 23 bp, Homo sapiens
gtcctggggatgagaaatcaaac

SEQ ID NO: 316 - DNA, 23 bp, Homo sapiens
acgagaaacacaaagtctacgcc

SEQ ID NO: 317 - DNA, 23 bp, Homo sapiens
gacacaacctggaggcggcaaag

SEQ ID NO: 318 - DNA, 24 bp, Homo sapiens
gctaatcttgtttcaactaccgcc

SEQ ID NO: 319 - DNA, 23 bp, Homo sapiens
ccattcacttcccgctcatacgc

SEQ ID NO: 320 - DNA, 23 bp, Homo sapiens
attgacccatctgtgcgtaaaac

SEQ ID NO: 321 - DNA, 23 bp, Homo sapiens
ttttcagtggaacctggtagtcg

SEQ ID NO: 322 - DNA, 24 bp, Homo sapiens
aaacagggatgaacctaaacttcg

SEQ ID NO: 323 - DNA, 23 bp, Homo sapiens
tggttgttggatttagggcactc

SEQ ID NO: 324 - DNA, 23 bp, Homo sapiens
cctcccaaatccctaactaccac

SEQ ID NO: 325 - DNA, 23 bp, Homo sapiens
aatcagaatgaaagacggggagc

SEQ ID NO: 326 - DNA, 23 bp, Homo sapiens
tcggggatggtttcaggactatc

SEQ ID NO: 327 - DNA, 23 bp, Homo sapiens
ggtgtcttttatgggcacgcttc

SEQ ID NO: 328 - DNA, 23 bp, Homo sapiens
agtgtgaggatagcaggtcgtgc

SEQ ID NO: 329 - DNA, 23 bp, Homo sapiens
agcaacctacagcacaaccacgc

SEQ ID NO: 330 - DNA, 23 bp, Homo sapiens
tctgatgaggagggaggactgcg

SEQ ID NO: 331 - DNA, 23 bp, Homo sapiens
ctgattgagggctttccgagagg

SEQ ID NO: 332 - DNA, 23 bp, Homo sapiens
tcaggattcacctccagggaacg

SEQ ID NO: 333 - DNA, 23 bp, Homo sapiens
acagatgacttgccaaagccgtc

SEQ ID NO: 334 - DNA, 24 bp, Homo sapiens
tgattctctttgtatccctttccg

SEQ ID NO: 335 - DNA, 24 bp, Homo sapiens
ctaaaggagttcaggtagggttgg

SEQ ID NO: 336 - DNA, 23 bp, Homo sapiens
tcccaacaaagcattacaaaccg

SEQ ID NO: 337 - DNA, 23 bp, Homo sapiens
tgaaaggacacacaaagcgtatc

SEQ ID NO: 338 - DNA, 25 bp, Homo sapiens
gagcatcaatgagttttacgacatc

SEQ ID NO: 339 - DNA, 23 bp, Homo sapiens
acacgctcttttgttacttgccg

SEQ ID NO: 340 - DNA, 23 bp, Homo sapiens
cctctcttcctcggcgtccttgc

SEQ ID NO: 341 - DNA, 23 bp, Homo sapiens
gtgaatggtagtgccttcgctcc

SEQ ID NO: 342 - DNA, 23 bp, Homo sapiens
aaccacgcatcacacggcacttc

SEQ ID NO: 343 - DNA, 23 bp, Homo sapiens
tcaaggctgggtcacgcaaggtc

SEQ ID NO: 344 - DNA, 23 bp, Homo sapiens
atccccctcaccctcctatcggc

SEQ ID NO: 345 - DNA, 23 bp, Homo sapiens
ttcagcctatcaacttccttgcc

SEQ ID NO: 346 - DNA, 23 bp, Homo sapiens
agaagaccgctctgatgggagtg

SEQ ID NO: 347 - DNA, 24 bp, Homo sapiens
gagattcctgaagtgttctttggc

SEQ ID NO: 348 - DNA, 25 bp, Homo sapiens
gtaaaaccacacattagaggacacg

SEQ ID NO: 349 - DNA, 24 bp, Homo sapiens
cctcctttagaaaaccatagcgtc

SEQ ID NO: 350 - DNA, 23 bp, Homo sapiens
tgtgaaactcttggcaactctcc

SEQ ID NO: 351 - DNA, 23 bp, Homo sapiens
tctggagaaatcagggtatcggc

SEQ ID NO: 352 - DNA, 23 bp, Homo sapiens
taaccctaaaacgaggaagcgtc

SEQ ID NO: 353 - DNA, 23 bp, Homo sapiens
gctgaaagccagtgcccatacgg

SEQ ID NO: 354 - DNA, 23 bp, Homo sapiens
ggagatggaatgtgctgactcgc

SEQ ID NO: 355 - DNA, 23 bp, Homo sapiens
taggctcactgtggcagaaagcg

SEQ ID NO: 356 - DNA, 23 bp, Homo sapiens
tagtcctggctgagggtctctcg

SEQ ID NO: 357 - DNA, 23 bp, Homo sapiens
ttcacactccacatctttgcgtc

SEQ ID NO: 358 - DNA, 23 bp, Homo sapiens
ttctgacccaggttgctatcaag

SEQ ID NO: 359 - DNA, 23 bp, Homo sapiens
atcaggatgaggggtgcgggttg

SEQ ID NO: 360 - DNA, 23 bp, Homo sapiens
caaggtgaggattttcaaggacg

SEQ ID NO: 361 - DNA, 23 bp, Homo sapiens
gtattttcaatctggcatcaggg

SEQ ID NO: 362 - DNA, 23 bp, Homo sapiens
cctcgctctctctctgcctttgc

SEQ ID NO: 363 - DNA, 23 bp, Homo sapiens
gtggaatgagatggaggacaacc

SEQ ID NO: 364 - DNA, 21 bp, Homo sapiens
ctctctgcactgttttcctgg

SEQ ID NO: 365 - DNA, 22 bp, Homo sapiens
ccattgttgatggagtcagatg

SEQ ID NO: 366 - DNA, 23 bp, Homo sapiens
gacagtgacttagtgtgtggctg

SEQ ID NO: 367 - DNA, 22 bp, Homo sapiens
gtgagtacatgcactgagaggg

SEQ ID NO: 368 - DNA, 22 bp, Homo sapiens
gctggaattcgtgtagtgcttc

SEQ ID NO: 369 - DNA, 22 bp, Homo sapiens
ctgctgagggagtagagtcctg

SEQ ID NO: 370 - DNA, 30 bp, Homo sapiens
ggctgctctgccctggtcccctgagctcca

SEQ ID NO: 371 - DNA, 22 bp, Homo sapiens
ctgctgagggagtagagtcctg

SEQ ID NO: 372 - DNA, 30 bp, Homo sapiens; identical to SEQ ID NO: 370

SEQ ID NO: 373 - DNA, 30 bp, Homo sapiens; identical to SEQ ID NO: 370

SEQ ID NO: 374 - DNA, 22 bp, Homo sapiens
ctgctgagggagtagagtcctg

SEQ ID NO: 375 - DNA, 21 bp, Homo sapiens
ctctctgcactgttttcctgg

SEQ ID NO: 376 - DNA, 22 bp, Homo sapiens
ccattgttgatggagtcagatg

SEQ ID NO: 377 - DNA, 23 bp, Homo sapiens
gacagtgacttagtgtgtggctg

SEQ ID NO: 378 - DNA, 22 bp, Homo sapiens
gtgagtacatgcactgagaggg

SEQ ID NO: 379 - DNA, 21 bp, Homo sapiens
ctgggattcgtgtagtgcttc

SEQ ID NO: 380 - DNA, 22 bp, Homo sapiens
ctgctgagggagtagagtcctg

SEQ ID NO: 381 - DNA, 30 bp, Homo sapiens; identical to SEQ ID NO: 370

SEQ ID NO: 382 - DNA, 30 bp, Homo sapiens; identical to SEQ ID NO: 370

SEQ ID NO: 383 - DNA, 30 bp, Homo sapiens; identical to SEQ ID NO: 370

SEQ ID NO: 384 - DNA, 30 bp, Homo sapiens; identical to SEQ ID NO: 370

SEQ ID NO: 385 - DNA, 30 bp, Homo sapiens; identical to SEQ ID NO: 370

SEQ ID NO: 386 - DNA, 30 bp, Homo sapiens; identical to SEQ ID NO: 370

SEQ ID NO: 387 - DNA, 30 bp, Homo sapiens; identical to SEQ ID NO: 370

SEQ ID NO: 388 - DNA, 22 bp, Homo sapiens
ctgctgagggagtagagtcctg

SEQ ID NO: 389 - DNA, 30 bp, Homo sapiens; identical to SEQ ID NO: 370

SEQ ID NO: 390 - DNA, 22 bp, Homo sapiens
gctgctgatgtcagagttgttc

SEQ ID NO: 391 - DNA, 22 bp, Homo sapiens
cttacctgaggagacggtgacc

SEQ ID NO: 392 - DNA, 23 bp, Homo sapiens
gttagcacagtggttctcagctc

SEQ ID NO: 393 - DNA, 23 bp, Homo sapiens
gacaataaccacacctggaactg

SEQ ID NO: 394 - DNA, 21 bp, Homo sapiens
gactctgagcccagtgctgta

SEQ ID NO: 395 - DNA, 22 bp, Homo sapiens
ctttaggtgtggggtgagcact

SEQ ID NO: 396 - DNA, 23 bp, Homo sapiens
ccatagctgtatccaccacagtc

SEQ ID NO: 397 - DNA, 23 bp, Homo sapiens
ccatagctgtatccaccacagtc

SEQ ID NO: 398 - DNA, 23 bp, Homo sapiens
gtgtttctctagtggcaggtgag

SEQ ID NO: 399 - DNA, 22 bp, Homo sapiens
gcatctgtccctatgtccctac

SEQ ID NO: 400 - DNA, 22 bp, Homo sapiens
gcatctgtccctatgtccctac

SEQ ID NO: 401 - DNA, 22 bp, Homo sapiens
gcatctgtccctatgtccctac

SEQ ID NO: 402 - DNA, 22 bp, Homo sapiens
gcatctgtccctatgtccctac

SEQ ID NO: 403 - DNA, 22 bp, Homo sapiens
gcatctgtccctatgtccctac

SEQ ID NO: 404 - DNA, 22 bp, Homo sapiens
gcatctgtccctatgtccctac

SEQ ID NO: 405 - DNA, 22 bp, Homo sapiens
gcatctgtccctatgtccctac

SEQ ID NO: 406 - DNA, 22 bp, Homo sapiens
gcatctgtccctatgtccctac

SEQ ID NO: 407 - DNA, 22 bp, Homo sapiens
gcatctgtccctatgtccctac

SEQ ID NO: 408 - DNA, 22 bp, Homo sapiens
gcatctgtccctatgtccctac

SEQ ID NO: 409 - DNA, 21 bp, Homo sapiens
tgaaggtcaacgacaaagagg

SEQ ID NO: 410 - DNA, 25 bp, Homo sapiens
catccctgtagtttactttctgagg

SEQ ID NO: 411 - DNA, 23 bp, Homo sapiens
catgagagcagacacagaatgac

SEQ ID NO: 412 - DNA, 23 bp, Homo sapiens
aacgacattttggttattgatgg

SEQ ID NO: 413 - DNA, 21 bp, Homo sapiens
tgtccggccttagttaatgtg

SEQ ID NO: 414 - DNA, 23 bp, Homo sapiens
atccatccaaccagtcatacaac

SEQ ID NO: 415 - DNA, 23 bp, Homo sapiens
gaaactgcactctctgacctctg

SEQ ID NO: 416 - DNA, 23 bp, Homo sapiens
gattctgttggtacagtgtgtcg

SEQ ID NO: 417 - DNA, 23 bp, Homo sapiens
tgttatgagaagtgacagccaga

SEQ ID NO: 418 - DNA, 24 bp, Homo sapiens
agctgaagatattcattagctggc

SEQ ID NO: 419 - DNA, 23 bp, Homo sapiens
tggaatcctacaggaatgtgaag

SEQ ID NO: 420 - DNA, 23 bp, Homo sapiens
caacacctgttagatgtctgctg

SEQ ID NO: 421 - DNA, 22 bp, Homo sapiens
ccagacatctcctaaatggagc

SEQ ID NO: 422 - DNA, 22 bp, Homo sapiens
gccacatcttagaaatgccttc

SEQ ID NO: 423 - DNA, 22 bp, Homo sapiens
cacagctagtggcagatcactc

SEQ ID NO: 424 - DNA, 23 bp, Homo sapiens
attctgtagggaaaggacagctc

SEQ ID NO: 425 - DNA, 24 bp, Homo sapiens
agagttggaaaacagttggagaag

SEQ ID NO: 426 - DNA, 23 bp, Homo sapiens
caccctagagttacacgttcctg

SEQ ID NO: 427 - DNA, 22 bp, Homo sapiens
atatggagcaggtctcctgtgt

SEQ ID NO: 428 - DNA, 23 bp, Homo sapiens
aggcttggaaggaagaatgtaac

SEQ ID NO: 429 - DNA, 23 bp, Homo sapiens
tctcatagccgtgtactctgttg

SEQ ID NO: 430 - DNA, 23 bp, Homo sapiens
atgctatagacctggaaaggctc

SEQ ID NO: 431 - DNA, 23 bp, Homo sapiens
gataacatcaggcttctgtccac

SEQ ID NO: 432 - DNA, 23 bp, Homo sapiens
atacagttaagagctgtcgctgg

SEQ ID NO: 433 - DNA, 22 bp, Homo sapiens
cccagcctgaaactcttaacac

SEQ ID NO: 434 - DNA, 22 bp, Homo sapiens
aagttctgcagagagggttgtc

SEQ ID NO: 435 - DNA, 23 bp, Homo sapiens
gactctgaggctgagggttaaag

SEQ ID NO: 436 - DNA, 23 bp, Homo sapiens
agatctcagagacacgaaagcac

SEQ ID NO: 437 - DNA, 23 bp, Homo sapiens
tatgagcactgactcacagaacg

SEQ ID NO: 438 - DNA, 23 bp, Homo sapiens
acttgaagctccaaactcctttc

SEQ ID NO: 439 - DNA, 21 bp, Homo sapiens
aatgatgaatgccaaagcaac

SEQ ID NO: 440 - DNA, 24 bp, Homo sapiens
acaggatagcctgcagagaactac

SEQ ID NO: 441 - DNA, 22 bp, Homo sapiens
cctgaggtcataaatctccacc

SEQ ID NO: 442 - DNA, 22 bp, Homo sapiens
agagctttcagtctctggatgg

SEQ ID NO: 443 - DNA, 23 bp, Homo sapiens
atgaccaattatgctcaatctgc

SEQ ID NO: 444 - DNA, 21 bp, Homo sapiens
gtgtgttcatgccaagggtat

SEQ ID NO: 445 - DNA, 23 bp, Homo sapiens
ccactaaacaccagtcaaaggac

SEQ ID NO: 446 - DNA, 24 bp, Homo sapiens
ccaatctatagacacagccaactg

SEQ ID NO: 447 - DNA, 23 bp, Homo sapiens
gcctaattccagttgtaaatccc

SEQ ID NO: 448 - DNA, 24 bp, Homo sapiens
agtaaagaagtgtcatggctgttg

SEQ ID NO: 449 - DNA, 23 bp, Homo sapiens
cacattgcaagtggtcaatactc

SEQ ID NO: 450 - DNA, 23 bp, Homo sapiens
ttgaacgacaacatgaaatgaag

SEQ ID NO: 451 - DNA, 22 bp, Homo sapiens
tccaacttctcttgctttctcc

SEQ ID NO: 452 - DNA, 23 bp, Homo sapiens
gactatgtggagacaagggagtg

SEQ ID NO: 453 - DNA, 23 bp, Homo sapiens
tatggccattattagagacggtg

SEQ ID NO: 454 - DNA, 26 bp, Homo sapiens
tgaagtcctaatctctggtacttgtg

SEQ ID NO: 455 - DNA, 24 bp, Homo sapiens
agcagtttatcacctggaaatagc

SEQ ID NO: 456 - DNA, 23 bp, Homo sapiens
aatgacaatgtctggcttaccac

SEQ ID NO: 457 - DNA, 25 bp, Homo sapiens
aatgtgatactttgctaggctcaac

SEQ ID NO: 458 - DNA, 24 bp, Homo sapiens
agagaattcccctgaattacacag

SEQ ID NO: 459 - DNA, 23 bp, Homo sapiens
ggaaatgagctaaatgacacacc

SEQ ID NO: 460 - DNA, 23 bp, Homo sapiens
ccagatctaaaccaaactgcaag

SEQ ID NO: 461 - DNA, 22 bp, Homo sapiens
tctccagtggtattgttagggg

SEQ ID NO: 462 - DNA, 22 bp, Homo sapiens
gtgtgtgtattcacatccctgc

SEQ ID NO: 463 - DNA, 24 bp, Homo sapiens
tcttggagtgatgaaatcaagaag

SEQ ID NO: 464 - DNA, 23 bp, Homo sapiens
caaatccactacaagtctccagg

SEQ ID NO: 465 - DNA, 23 bp, Homo sapiens
tttaaacctctgtctgctggaag

SEQ ID NO: 466 - DNA, 23 bp, Homo sapiens
agaatgaagttggtagcttgcag

SEQ ID NO: 467 - DNA, 23 bp, Homo sapiens
catgaggttgtttgagaacactg

SEQ ID NO: 468 - DNA, 23 bp, Homo sapiens
tgctctacttctagggtgactgc

SEQ ID NO: 469 - DNA, 23 bp, Homo sapiens
agagctctttctgtgtggagatg

SEQ ID NO: 470 - DNA, 25 bp, Homo sapiens
tctcatccctttattttctcaacag

SEQ ID NO: 471 - DNA, 22 bp, Homo sapiens
tcttcagaagcaagtcatctgc

SEQ ID NO: 472 - DNA, 23 bp, Homo sapiens
aatctctgagcatgactttggac

SEQ ID NO: 473 - DNA, 23 bp, Homo sapiens
agactgaaatgaggacacctgag

SEQ ID NO: 474 - DNA, 23 bp, Homo sapiens
tcctctcacagcaacactctatg

SEQ ID NO: 475 - DNA, 24 bp, Homo sapiens
gtccaaagaccacactgtgaatag

SEQ ID NO: 476 - DNA, 23 bp, Homo sapiens
gcatcctttctgttctttgattg

SEQ ID NO: 477 - DNA, 24 bp, Homo sapiens
ctcatgtgccaaacagatattctc

SEQ ID NO: 478 - DNA, 23 bp, Homo sapiens
gacaactccattgtcctcagttc

SEQ ID NO: 479 - DNA, 24 bp, Homo sapiens
agactcctgctatttcctgatgtc

SEQ ID NO: 480 - DNA, 24 bp, Homo sapiens
ttgcatatagtaatggatgccttc

SEQ ID NO: 481 - DNA, 23 bp, Homo sapiens
ctcctgcagctgaaaggtagtag

SEQ ID NO: 482 - DNA, 23 bp, Homo sapiens
tgtggatgatataaatccccttg

SEQ ID NO: 483 - DNA, 23 bp, Homo sapiens
agctcttgttaaggctgtcactg

SEQ ID NO: 484 - DNA, 23 bp, Homo sapiens
tccagtcttcggtaaactattgc

SEQ ID NO: 485 - DNA, 24 bp, Homo sapiens
ctatgcattttagttggggatagg

SEQ ID NO: 486 - DNA, 23 bp, Homo sapiens
taaaatgtttcagttcccacgac

SEQ ID NO: 487 - DNA, 22 bp, Homo sapiens
gttgtggatcagggaagttagc

SEQ ID NO: 488 - DNA, 25 bp, Homo sapiens
cagattagaagcacttagccttgag

SEQ ID NO: 489 - DNA, 23 bp, Homo sapiens
cagaatctacaatggatgccttc

SEQ ID NO: 490 - DNA, 22 bp, Homo sapiens
gagagcagtgttgtgaagaacg

SEQ ID NO: 491 - DNA, 24 bp, Homo sapiens
acttctgttcctataacacccagg

SEQ ID NO: 492 - DNA, 23 bp, Homo sapiens
tgtattgccaagtctgttgtgag

SEQ ID NO: 493 - DNA, 23 bp, Homo sapiens
atctaatctgccagaaagtgtgg

SEQ ID NO: 494 - DNA, 22 bp, Homo sapiens
agattcctaagcctcccatctc

SEQ ID NO: 495 - DNA, 25 bp, Homo sapiens
tgagatgatttcctagtaatgaggc

SEQ ID NO: 496 - DNA, 25 bp, Homo sapiens
aatgacagtgagtggaagacaaagg

SEQ ID NO: 497 - DNA, 25 bp, Homo sapiens
cttcacccgtaaatggaggtcatag

SEQ ID NO: 498 - DNA, 21 bp, Homo sapiens
gcggggctgtaagggacgaag

SEQ ID NO: 499 - DNA, 28 bp, Homo sapiens
aagttttctccgattccacctaaagctc

SEQ ID NO: 500 - DNA, 21 bp, Homo sapiens
ctgggcgaatgaagcggcgtg

SEQ ID NO: 501 - DNA, 21 bp, Homo sapiens
caggaggcggaggtagcggtc

SEQ ID NO: 502 - DNA, 28 bp, Homo sapiens
tttaggaatctctcccacagctataacg

SEQ ID NO: 503 - DNA, 28 bp, Homo sapiens
gtgaatctctcaataaatggcgaatctg

SEQ ID NO: 504 - DNA, 28 bp, Homo sapiens
cctacacagttgacaattaaaaggttcc

SEQ ID NO: 505 - DNA, 28 bp, Homo sapiens
agtgacaaaatcttccataagcattagc

SEQ ID NO: 506 - DNA, 21 bp, Homo sapiens
gctttcctgccttactccacg

SEQ ID NO: 507 - DNA, 28 bp, Homo sapiens
tggtacagcaaaatgacatcccaacagc

SEQ ID NO: 508 - DNA, 28 bp, Homo sapiens
ccaacaccacaaggatttccatgtagac

SEQ ID NO: 509 - DNA, 28 bp, Homo sapiens
gataacatgcaacaacgtggttgactcc

SEQ ID NO: 510 - DNA, 28 bp, Homo sapiens
ctctcactcaaagtgcagaccaaatcag

SEQ ID NO: 511 - DNA, 21 bp, Homo sapiens
atcacctggttcaccgtatgg

SEQ ID NO: 512 - DNA, 21 bp, Homo sapiens
gcacaggtggggagagggtag

SEQ ID NO: 513 - DNA, 28 bp, Homo sapiens
ctcacagcatggataaagctgcgggaag

SEQ ID NO: 514 - DNA, 21 bp, Homo sapiens
cgggaagggactcacggacag

SEQ ID NO: 515 - DNA, 21 bp, Homo sapiens
gtatccatcaccaaagcagcg

SEQ ID NO: 516 - DNA, 28 bp, Homo sapiens
caagtaaacagtcaagaaattccgtaag

SEQ ID NO: 517 - DNA, 28 bp, Homo sapiens
catttggctacctgatgttgtccctcac

SEQ ID NO: 518 - DNA, 28 bp, Homo sapiens
ttacggttacctgaaagactggtacggg

SEQ ID NO: 519 - DNA, 21 bp, Homo sapiens
tccacccaactctgacgcctc

SEQ ID NO: 520 - DNA, 28 bp, Homo sapiens
gaggtaaactcagccaagtaggaggaac

SEQ ID NO: 521 - DNA, 28 bp, Homo sapiens
tgaactgccttagagtaaatccgctttc

SEQ ID NO: 522 - DNA, 21 bp, Homo sapiens
ccaggcaaaccctctgacccg

SEQ ID NO: 523 - DNA, 21 bp, Homo sapiens
acgggaataacagagggtgcg

SEQ ID NO: 524 - DNA, 28 bp, Homo sapiens
tatgtcatttcaaagtagtggtgcgaac

SEQ ID NO: 525 - DNA, 28 bp, Homo sapiens
gagggagaacttagagccattcactacg

SEQ ID NO: 526 - DNA, 21 bp, Homo sapiens
cagatactcagcggcattgcg

SEQ ID NO: 527 - DNA, 23 bp, Homo sapiens
aggaccaatgtatgtgtatctgg

SEQ ID NO: 528 - DNA, 23 bp, Homo sapiens
ccccaagagacacagaaactgcg

SEQ ID NO: 529 - DNA, 28 bp, Homo sapiens
gcacacagccatcagacagaaggcaacc

SEQ ID NO: 530 - DNA, 23 bp, Homo sapiens
gctcagcccaaccctgcgtatgc

SEQ ID NO: 531 - DNA, 28 bp, Homo sapiens
atacgaggacaagaggatgtttcaaatc

SEQ ID NO: 532 - DNA, 28 bp, Homo sapiens
ctaacctgggtggagaaagccgaagaag

SEQ ID NO: 533 - DNA, 28 bp, Homo sapiens
tccttctcagggctttgcgtttagtaag

SEQ ID NO: 534 - DNA, 23 bp, Homo sapiens
tacagccacacagcagattcggc

SEQ ID NO: 535 - DNA, 23 bp, Homo sapiens
gggagcagtgcctggctacggtc

SEQ ID NO: 536 - DNA, 23 bp, Homo sapiens
aacccactctgagcactcggcac

SEQ ID NO: 537 - DNA, 21 bp, Homo sapiens
tggaaggtgccctccgcatcg

SEQ ID NO: 538 - DNA, 21 bp, Homo sapiens
cgagttgcacagtccaattcg

SEQ ID NO: 539 - DNA, 23 bp, Homo sapiens
cttgggcagaacctgggcagtcg

SEQ ID NO: 540 - DNA, 23 bp, Homo sapiens
actgacccactgccgtgtgaacc

SEQ ID NO: 541 - DNA, 23 bp, Homo sapiens
actcaggtggggacttgtgacgc

SEQ ID NO: 542 - DNA, 25 bp, Homo sapiens
atccaaacaggctgatgctcttcac

SEQ ID NO: 543 - DNA, 23 bp, Homo sapiens
gtccaagtgaggaggaaatacac

SEQ ID NO: 544 - DNA, 25 bp, Homo sapiens
aggctctggacctcacgggattcgg

SEQ ID NO: 545 - DNA, 25 bp, Homo sapiens
taagttgtatccttcgcctaatggg

SEQ ID NO: 546 - DNA, 25 bp, Homo sapiens
taggtggtttctttgttcttgactc

SEQ ID NO: 547 - DNA, 25 bp, Homo sapiens
ggtatttggtggtggctgttatttc

SEQ ID NO: 548 - DNA, 25 bp, Homo sapiens
tgagtaggaagcgaatagcgtgaag

SEQ ID NO: 549 - DNA, 23 bp, Homo sapiens
ggaggtaggaggcttcccgttag

SEQ ID NO: 550 - DNA, 23 bp, Homo sapiens
ggcttgtgttccactgggcaatc

SEQ ID NO: 551 - DNA, 28 bp, Homo sapiens
ggctgaccactcggaggaggagaagaag

SEQ ID NO: 552 - DNA, 28 bp, Homo sapiens
cccctccctccagagcggaacctgaatc

SEQ ID NO: 553 - DNA, 23 bp, Homo sapiens
aatgatgtcaccttggaacagtc

SEQ ID NO: 554 - DNA, 23 bp, Homo sapiens
cgccttccaaaagagcctcaacg

SEQ ID NO: 555 - DNA, 25 bp, Homo sapiens
gaagtgtgctctgaacaggacgaac

SEQ ID NO: 556 - DNA, 26 bp, Homo sapiens
tctgcttctgtgaccacgggacggtg

SEQ ID NO: 557 - DNA, 26 bp, Homo sapiens
ctcttacttgactctccacggctgag

SEQ ID NO: 558 - DNA, 26 bp, Homo sapiens
gatagagaagaatgtgaagaccgagc

SEQ ID NO: 559 - DNA, 21 bp, Homo sapiens
tcggagcagcggcttgatgcc

SEQ ID NO: 560 - DNA, 21 bp, Homo sapiens
gcgtgtgttccctccccaacg

SEQ ID NO: 561 - DNA, 21 bp, Homo sapiens
gttgggcttgctcaatcgctc

SEQ ID NO: 562 - DNA, 21 bp, Homo sapiens
taggaggcagaactcggttgg

SEQ ID NO: 563 - DNA, 21 bp, Homo sapiens
taccaaacagcccacaatgcg

SEQ ID NO: 564 - DNA, 21 bp, Homo sapiens
cacagcaatcactccgcacac

SEQ ID NO: 565 - DNA, 21 bp, Homo sapiens
gtcctctggaaagtaaggtcg

SEQ ID NO: 566 - DNA, 21 bp, Homo sapiens
gggagacgaacagagaagtcg

SEQ ID NO: 567 - DNA, 21 bp, Homo sapiens
tctccattacagtcggtgggc

SEQ ID NO: 568 - DNA, 21 bp, Homo sapiens
gtctcccattaccgttcgtcc

SEQ ID NO: 569 - DNA, 21 bp, Homo sapiens
gtgccaggtgaccatacgctc

SEQ ID NO: 570 - DNA, 21 bp, Homo sapiens
ccaggagtgacatcgctaagg

SEQ ID NO: 571 - DNA, 21 bp, Homo sapiens
tggggacttcattcttcaccg

SEQ ID NO: 572 - DNA, 21 bp, Homo sapiens
taacgaatgtgcccagcgaac

SEQ ID NO: 573 - DNA, 21 bp, Homo sapiens
cctccaaaactatttccgccc

SEQ ID NO: 574 - DNA, 21 bp, Homo sapiens
gaacacgacctctgaccaacg

SEQ ID NO: 575 - DNA, 21 bp, Homo sapiens
atctccctgtttcagcgtcgg

SEQ ID NO: 576 - DNA, 28 bp, Homo sapiens
gagttctgctcttctgtgtctctgctcg

SEQ ID NO: 577 - DNA, 28 bp, Homo sapiens
gcacacagtgatttgcagtgtaatagtc

SEQ ID NO: 578 - DNA, 21 bp, Homo sapiens
atgtcagttcagccgtgattc

SEQ ID NO: 579 - DNA, 21 bp, Homo sapiens
ggagaacaggagaacgcatcc

SEQ ID NO: 580 - DNA, 21 bp, Homo sapiens
tcactccaacataggcggaac

SEQ ID NO: 581 - DNA, 21 bp, Homo sapiens
ttacacaggagatgggttagc

SEQ ID NO: 582 - DNA, 28 bp, Homo sapiens
gcaaacaaagacactaccttccagacgc

SEQ ID NO: 583 - DNA, 28 bp, Homo sapiens
ctttttcagtgatactaaaccgcatagg

SEQ ID NO: 584 - DNA, 21 bp, Homo sapiens
tatgcgtttagggtcctgacg

SEQ ID NO: 585 - DNA, 21 bp, Homo sapiens
ggttgcttaggttgttgaccg

SEQ ID NO: 586 - DNA, 21 bp, Homo sapiens
tccttctcattcccagtaacg

SEQ ID NO: 587 - DNA, 21 bp, Homo sapiens
aacctctccccacattcccgc

SEQ ID NO: 588 - DNA, 21 bp, Homo sapiens
tgtctctctgtaaacccgctg

SEQ ID NO: 589 - DNA, 21 bp, Homo sapiens
tgcctctgacggctaaactcg

SEQ ID NO: 590 - DNA, 21 bp, Homo sapiens
gtgggtttgaaaagatgcgac

SEQ ID NO: 591 - DNA, 28 bp, Homo sapiens
tcggctgagctgagaaatgctaccgcag

SEQ ID NO: 592 - DNA, 21 bp, Homo sapiens
atggcttggctttatgtagcg

SEQ ID NO: 593 - DNA, 21 bp, Homo sapiens
ccccatacggttctgtggtcg

SEQ ID NO: 594 - DNA, 21 bp, Homo sapiens
tggatggacacactggcgtcg

SEQ ID NO: 595 - DNA, 21 bp, Homo sapiens
tcttcacaaacccaccgcaag

SEQ ID NO: 596 - DNA, 21 bp, Homo sapiens
ggggaccctaactgacccgtc

SEQ ID NO: 597 - DNA, 21 bp, Homo sapiens
cagggtgctcaggtagcctcg

SEQ ID NO: 598 - DNA, 21 bp, Homo sapiens
tagaacctcagttggcgtctg

SEQ ID NO: 599 - DNA, 21 bp, Homo sapiens
cccagcgtgctccctgtatcg

SEQ ID NO: 600 - DNA, 21 bp, Homo sapiens
tccccacaataggacatcggc

SEQ ID NO: 601 - DNA, 28 bp, Homo sapiens
atgaacagaatctggcttcctcgcattc

SEQ ID NO: 602 - DNA, 21 bp, Homo sapiens
aaatgagagaagccgttgccc

SEQ ID NO: 603 - DNA, 21 bp, Homo sapiens
tccaggtgggcaggaacgctc

SEQ ID NO: 604 - DNA, 21 bp, Homo sapiens
cagccctttgatttcactcgc

SEQ ID NO: 605 - DNA, 28 bp, Homo sapiens
gatcaagttgactggtagtgccgtttag

SEQ ID NO: 606 - DNA, 21 bp, Homo sapiens
tgaagacccttgggagttacg

SEQ ID NO: 607 - DNA, 21 bp, Homo sapiens
ggatggggtgtggaagagacg

SEQ ID NO: 608 - DNA, 23 bp, Homo sapiens
cttgcttctggtgggtgccttag

SEQ ID NO: 609 - DNA, 23 bp, Homo sapiens
tacctcgctgctcacccactcgg

SEQ ID NO: 610 - DNA, 26 bp, Homo sapiens
aggtgtggcttctgctaactatctac

SEQ ID NO: 611 - DNA, 23 bp, Homo sapiens
ggagaaagaaggatggcggtatc

SEQ ID NO: 612 - DNA, 24 bp, Homo sapiens
caacagtcaaaggtgtccgaatag

SEQ ID NO: 613 - DNA, 23 bp, Homo sapiens
cccagcacacagcaggactcggc

SEQ ID NO: 614 - DNA, 23 bp, Homo sapiens
ggggcaggcttcataacttgtgg

SEQ ID NO: 615 - DNA, 23 bp, Homo sapiens
caactttattgagaccttgcgtg

SEQ ID NO: 616 - DNA, 23 bp, Homo sapiens
gaccgttgaactgaccgtaacag

SEQ ID NO: 617 - DNA, 23 bp, Homo sapiens
tccaagggcatacctgactattc

SEQ ID NO: 618 - DNA, 23 bp, Homo sapiens
tggtagtcctcacacctttgccg

SEQ ID NO: 619 - DNA, 23 bp, Homo sapiens
ggatgatttggttggaacgaagc

SEQ ID NO: 620 - DNA, 23 bp, Homo sapiens
tagagtcaaacaggctggtctgc

SEQ ID NO: 621 - DNA, 23 bp, Homo sapiens
atgggtgagtgggtgagtgaacg

SEQ ID NO: 622 - DNA, 23 bp, Homo sapiens
gcccagacagcctttcggtggag

SEQ ID NO: 623 - DNA, 26 bp, Homo sapiens
tgattgtcagactgaaacaggtagtg

SEQ ID NO: 624 - DNA, 24 bp, Homo sapiens
ggaaggtccataataacaaatcgc

SEQ ID NO: 625 - DNA, 25 bp, Homo sapiens
aacaaatgtaggttgaatgatgacc

SEQ ID NO: 626 - DNA, 24 bp, Homo sapiens
agtagatttagcatagacgagccg

SEQ ID NO: 627 - DNA, 23 bp, Homo sapiens
gagggtaggaggtggcaggtgcg

SEQ ID NO: 628 - DNA, 23 bp, Homo sapiens
agagtggcagcaagagtagcgtc

SEQ ID NO: 629 - DNA, 23 bp, Homo sapiens
gaatgacggttccctgccagtcc

SEQ ID NO: 630 - DNA, 23 bp, Homo sapiens
acccttccacctctgaaagcgac

SEQ ID NO: 631 - DNA, 25 bp, Homo sapiens
tttcagaccaaccagaatagttacg

SEQ ID NO: 632 - DNA, 23 bp, Homo sapiens
tgctctgacaaactgccgtagac

SEQ ID NO: 633 - DNA, 23 bp, Homo sapiens
tgctggtggtagtcattagcggg

SEQ ID NO: 634 - DNA, 23 bp, Homo sapiens
ttggagagtcttggggattgttg

SEQ ID NO: 635 - DNA, 23 bp, Homo sapiens
aacccagaagttccagatgaccg

SEQ ID NO: 636 - DNA, 23 bp, Homo sapiens
aaagtatgttggattggcacaag

SEQ ID NO: 637 - DNA, 23 bp, Homo sapiens
gggtcagtcagttgagtaagtgg

SEQ ID NO: 638 - DNA, 25 bp, Homo sapiens
agttccttctctgtagatagcccag

SEQ ID NO: 639 - DNA, 23 bp, Homo sapiens
ggagagcaaaactgtggctaagc

SEQ ID NO: 640 - DNA, 23 bp, Homo sapiens
gtggctaaaggaggatgagtcag

SEQ ID NO: 641 - DNA, 23 bp, Homo sapiens
actcctcatttgccactcccctg

SEQ ID NO: 642 - DNA, 25 bp, Homo sapiens
tgattcaccttactgttgcctattg

SEQ ID NO: 643 - DNA, 23 bp, Homo sapiens
atgttgaagccctactcccgttg

SEQ ID NO: 644 - DNA, 23 bp, Homo sapiens
gcagcacagaaactgaaatgccc

SEQ ID NO: 645 - DNA, 23 bp, Homo sapiens
gaagaggctcggagaaggacacg

SEQ ID NO: 646 - DNA, 23 bp, Homo sapiens
agttgagattcctgctccgtcac

SEQ ID NO: 647 - DNA, 23 bp, Homo sapiens
aagtgctgtaaactgtaggcgtg

SEQ ID NO: 648 - DNA, 23 bp, Homo sapiens
tgagagggctttagcaatcaggc

SEQ ID NO: 649 - DNA, 25 bp, Homo sapiens
gttatgtatcttgttgctgtgaggg

SEQ ID NO: 650 - DNA, 24 bp, Homo sapiens
caaagaaggctaatggaatggaag

SEQ ID NO: 651 - DNA, 26 bp, Homo sapiens
gtttgatacatagttagggctgttcg

SEQ ID NO: 652 - DNA, 23 bp, Homo sapiens
tagcacccttgattgagaagtcg

SEQ ID NO: 653 - DNA, 24 bp, Homo sapiens
gccttctacatcctgttcttcacc

SEQ ID NO: 654 - DNA, 23 bp, Homo sapiens
ctgggacactgtgctgttggctg

SEQ ID NO: 655 - DNA, 23 bp, Homo sapiens
ggctaacccatcttgtatccgtg

SEQ ID NO: 656 - DNA, 23 bp, Homo sapiens
atgtgggctctcatctccgttac

SEQ ID NO: 657 - DNA, 23 bp, Homo sapiens
tatgaggaggcacttggtcgttc

SEQ ID NO: 658 - DNA, 25 bp, Homo sapiens
ccagaataagaacaacaaacggaag

SEQ ID NO: 659 - DNA, 28 bp, Homo sapiens
gtaaataccaccataaacctaatcaacc

SEQ ID NO: 660 - DNA, 24 bp, Homo sapiens
catagattagcaggttgttccacg

SEQ ID NO: 661 - DNA, 23 bp, Homo sapiens
gatgaagaagtcagagtgcgaag

SEQ ID NO: 662 - DNA, 24 bp, Homo sapiens
gagagagaaaaggagaataagcgg

SEQ ID NO: 663 - DNA, 23 bp, Homo sapiens
tagaaacaaggcaccccaggaac

SEQ ID NO: 664 - DNA, 23 bp, Homo sapiens
gctttggtcagtgttgttaggtc

SEQ ID NO: 665 - DNA, 23 bp, Homo sapiens
ggactaccagccatttgctacgc

SEQ ID NO: 666 - DNA, 26 bp, Homo sapiens
gaagacaatagacagtgtgcgttatg

SEQ ID NO: 667 - DNA, 23 bp, Homo sapiens
aagtcctccatcaccagaccgac

SEQ ID NO: 668 - DNA, 23 bp, Homo sapiens
cacattccagaccaagaaacgac

SEQ ID NO: 669 - DNA, 24 bp, Homo sapiens
gccttgtcttacttgtatttcccg

SEQ ID NO: 670 - DNA, 23 bp, Homo sapiens
ggggtattgtggatggcagcggg

SEQ ID NO: 671 - DNA, 23 bp, Homo sapiens
gctcagttgtttgcttccctgcg

SEQ ID NO: 672 - DNA, 23 bp, Homo sapiens
aaccaatacaaaaacccatttcg

SEQ ID NO: 673 - DNA, 23 bp, Homo sapiens
tggaaagggaacacaactcatcg

SEQ ID NO: 674 - DNA, 23 bp, Homo sapiens
agcaaggcttacctggctgtcgg

SEQ ID NO: 675 - DNA, 23 bp, Homo sapiens
tcactgccactcgccaccgtctg

SEQ ID NO: 676 - DNA, 23 bp, Homo sapiens
aagggagtcacacaaggcgggag

SEQ ID NO: 677 - DNA, 23 bp, Homo sapiens
accagagaagccccttttgatac

SEQ ID NO: 678 - DNA, 23 bp, Homo sapiens
gaagagatgggaagggtcgtttg

SEQ ID NO: 679 - DNA, 23 bp, Homo sapiens
tgggacagggacaagtttgacgg

SEQ ID NO: 680 - DNA, 23 bp, Homo sapiens
aacaagacttcaggtcacgctcg

SEQ ID NO: 681 - DNA, 23 bp, Homo sapiens
actctggacaggaggggcgaagg

SEQ ID NO: 682 - DNA, 23 bp, Homo sapiens
ggtcacccttacctttgcggctc

SEQ ID NO: 683 - DNA, 23 bp, Homo sapiens
tgaccaaacaaataaatcccgtg

SEQ ID NO: 684 - DNA, 23 bp, Homo sapiens
attcctacctcgttgagtcatcg

SEQ ID NO: 685 - DNA, 23 bp, Homo sapiens
cccacaacagaggaggcgtattc

SEQ ID NO: 686 - DNA, 23 bp, Homo sapiens
aagtggactgccaaatgttctcg

SEQ ID NO: 687 - DNA, 23 bp, Homo sapiens
tgtgagttagagagggtgcttcg

SEQ ID NO: 688 - DNA, 23 bp, Homo sapiens
tcctgagccttcttaccatagcg

SEQ ID NO: 689 - DNA, 23 bp, Homo sapiens
tatggtgaggcttgctgtagatg

SEQ ID NO: 690 - DNA, 23 bp, Homo sapiens
atgggaaagaaggtggcgtggac

SEQ ID NO: 691 - DNA, 23 bp, Homo sapiens
ggttctatgataatgcccgattg

SEQ ID NO: 692 - DNA, 23 bp, Homo sapiens
aggcattcttcccattcaaacgg

SEQ ID NO: 693 - DNA, 28 bp, Homo sapiens
aatggtgtatttcttctgttcacgatag

SEQ ID NO: 694 - DNA, 23 bp, Homo sapiens
tggtccacactgcatccgtggtc

SEQ ID NO: 695 - DNA, 25 bp, Homo sapiens
tttccaagttctttccctatctacg

SEQ ID NO: 696 - DNA, 23 bp, Homo sapiens
ccctactcagtacatctgtcccg

SEQ ID NO: 697 - DNA, 23 bp, Homo sapiens
acaatgggctttgctatcgttgc

SEQ ID NO: 698 - DNA, 23 bp, Homo sapiens
aggtcttgggagttcttcgtctg

SEQ ID NO: 699 - DNA, 23 bp, Homo sapiens
atgagactgctactgtccatccg

SEQ ID NO: 700 - DNA, 23 bp, Homo sapiens
tgctgcttcaggaggttcacggc

SEQ ID NO: 701 - DNA, 23 bp, Homo sapiens
caagcaggactttctaagcaccg

SEQ ID NO: 702 - DNA, 23 bp, Homo sapiens
ggaggtgctaccctggaccatcg

SEQ ID NO: 703 - DNA, 23 bp, Homo sapiens
aggtcacacagggttctcgcttc

SEQ ID NO: 704 - DNA, 23 bp, Homo sapiens
ctgattcaagacagtgttggtcg

SEQ ID NO: 705 - DNA, 24 bp, Homo sapiens
gccatacaacttattagcatcccg

SEQ ID NO: 706 - DNA, 23 bp, Homo sapiens
actgtgtgactactttcgggcac

SEQ ID NO: 707 - DNA, 23 bp, Homo sapiens
cagagaatggatgagtgaacgag

SEQ ID NO: 708 - DNA, 23 bp, Homo sapiens
tctccctgagtctcttacgcatc

SEQ ID NO: 709 - DNA, 23 bp, Homo sapiens
tcccaagttatgaaacggatagc

SEQ ID NO: 710 - DNA, 23 bp, Homo sapiens
aagtgtggggatacaggcgttag

SEQ ID NO: 711 - DNA, 23 bp, Homo sapiens
tcagtaagtcagagccctcgcac

SEQ ID NO: 712 - DNA, 23 bp, Homo sapiens
tgggtttctgagagtcctcggcg

SEQ ID NO: 713 - DNA, 23 bp, Homo sapiens
gttccaggtgccactgaccaatc

SEQ ID NO: 714 - DNA, 23 bp, Homo sapiens
tgcctatgggagcctacaggacg

SEQ ID NO: 715 - DNA, 23 bp, Homo sapiens
cctgtgccgttctcctaatagcg

SEQ ID NO: 716 - DNA, 23 bp, Homo sapiens
tacatctttgagaggtcgtcacg

SEQ ID NO: 717 - DNA, 23 bp, Homo sapiens
ccaaaatggtctggacgagaaag

SEQ ID NO: 718 - DNA, 23 bp, Homo sapiens
gtccaagtttgagggcgagtgtc

SEQ ID NO: 719 - DNA, 23 bp, Homo sapiens
ggagaactggatgaacacgggac

SEQ ID NO: 720 - DNA, 23 bp, Homo sapiens
atgtgacaatcagggttgcgatg

SEQ ID NO: 721 - DNA, 23 bp, Homo sapiens
ctgtgaggtctggttccccgacg

SEQ ID NO: 722 - DNA, 23 bp, Homo sapiens
gtaaatggtaaggtgaaagccgc

SEQ ID NO: 723 - DNA, 23 bp, Homo sapiens
gcacaaataagaatgacaagcgg

SEQ ID NO: 724 - DNA, 23 bp, Homo sapiens
tctcaatgccccaagaacgcacc

SEQ ID NO: 725 - DNA, 23 bp, Homo sapiens
gtctttcctcaaccttcgcattc

SEQ ID NO: 726 - DNA, 23 bp, Homo sapiens
gctcagcatcaaagtccatcgtg

SEQ ID NO: 727 - DNA, 23 bp, Homo sapiens
tccctgtgtccttgtaccgtcac

SEQ ID NO: 728 - DNA, 23 bp, Homo sapiens
acagccatctggtagacggtcag

SEQ ID NO: 729 - DNA, 23 bp, Homo sapiens
caggagtttgaatcagacgatgc

SEQ ID NO: 730 - DNA, 23 bp, Homo sapiens
caggagacccctcaccgaccaac

SEQ ID NO: 731 - DNA, 23 bp, Homo sapiens
cagttcactcagacatcggtggc

SEQ ID NO: 732 - DNA, 23 bp, Homo sapiens
gaggctggctaaacaaacggtag

SEQ ID NO: 733 - DNA, 23 bp, Homo sapiens
gtgattagagggggtgcgaggcg

SEQ ID NO: 734 - DNA, 23 bp, Homo sapiens
ttgactcttccccactccactac

SEQ ID NO: 735 - DNA, 23 bp, Homo sapiens
ttgccaggacttaggtttcggag

SEQ ID NO: 736 - DNA, 23 bp, Homo sapiens
tcaagtaaatctccctggcacgc

SEQ ID NO: 737 - DNA, 23 bp, Homo sapiens
ggcagtgttcctcttcggtgttc

SEQ ID NO: 738 - DNA, 23 bp, Homo sapiens
agagaaaacaaagggggacaacg

SEQ ID NO: 739 - DNA, 23 bp, Homo sapiens
acctgatacctgcctaactggtc

SEQ ID NO: 740 - DNA, 23 bp, Homo sapiens
gagttccaggaggaccccttgcg

SEQ ID NO: 741 - DNA, 24 bp, Homo sapiens
gcctgactctgacttgtgaatgtc

SEQ ID NO: 742 - DNA, 23 bp, Homo sapiens
ggcgggattcaggtggaaggcgg

SEQ ID NO: 743 - DNA, 23 bp, Homo sapiens
gtgtctttgtttcccacggctgc

SEQ ID NO: 744 - DNA, 23 bp, Homo sapiens
gttggatgtggtggagcggtttg

SEQ ID NO: 745 - DNA, 23 bp, Homo sapiens
agtttaggggcagagcgagtaag

SEQ ID NO: 746 - DNA, 24 bp, Homo sapiens
tcactgagccctggacccaatcgc

SEQ ID NO: 747 - DNA, 24 bp, Homo sapiens
acactcaaaaatgtgactcggtcc

SEQ ID NO: 748 - DNA, 24 bp, Homo sapiens
gagccaccagccacctccgcacag

SEQ ID NO: 749 - DNA, 24 bp, Homo sapiens
gatggggtgtgaggtagtttgacg

SEQ ID NO: 750 - DNA, 24 bp, Homo sapiens
agacaaatagcggctgacggcggg

SEQ ID NO: 751 - DNA, 24 bp, Homo sapiens
tgctgtccacatactgttggtgac

SEQ ID NO: 752 - DNA, 24 bp, Homo sapiens
aagcagcactgtcctcgcacgcac

SEQ ID NO: 753 - DNA, 24 bp, Homo sapiens
gaacacaggcgtggtttccagttg

SEQ ID NO: 754 - DNA, 24 bp, Homo sapiens
aaaagtcggagtggggctaagtgg

SEQ ID NO: 755 - DNA, 24 bp, Homo sapiens
ctgtccacactacacacccgtccg

SEQ ID NO: 756 - DNA, 26 bp, Homo sapiens
tctgtctctgtctttctccgttactc

SEQ ID NO: 757 - DNA, 24 bp, Homo sapiens
tggaggatgggtggactgacggag

SEQ ID NO: 758 - DNA, 24 bp, Homo sapiens
ggaaccctcaaaaatgtgattcgg

SEQ ID NO: 759 - DNA, 23 bp, Homo sapiens
ctctgcccccactctcggtctac

SEQ ID NO: 760 - DNA, 25 bp, Homo sapiens
ctattttcactatctccatacgggg

SEQ ID NO: 761 - DNA, 24 bp, Homo sapiens
tggggggcaggaggagcaaggagc

SEQ ID NO: 762 - DNA, 24 bp, Homo sapiens
gatgacaaaggagaagatgagcgg

SEQ ID NO: 763 - DNA, 24 bp, Homo sapiens
atgctgtccccactcatctgcgac

SEQ ID NO: 764 - DNA, 24 bp, Homo sapiens
cattcttcctgttccttgctggac

SEQ ID NO: 765 - DNA, 24 bp, Homo sapiens
taaccatcctccagacctacttcc

SEQ ID NO: 766 - DNA, 24 bp, Homo sapiens
catttgctaagatgctccgtaagc

SEQ ID NO: 767 - DNA, 29 bp, Homo sapiens
caagacacaaactgtaaaagacttattgg

SEQ ID NO: 768 - DNA, 24 bp, Homo sapiens
tcttatttgcctcttatgcgtagc

SEQ ID NO: 769 - DNA, 26 bp, Homo sapiens
gagaggtatttgaaggaagttatggg

SEQ ID NO: 770 - DNA, 24 bp, Homo sapiens
cacgcctcctgggaagactcgccg

SEQ ID NO: 771 - DNA, 24 bp, Homo sapiens
gtgaggtctccacacccaacgcac

SEQ ID NO: 772 - DNA, 24 bp, Homo sapiens
ggagcattctcaggggctgtcgtg

SEQ ID NO: 773 - DNA, 24 bp, Homo sapiens
aggcaccagggaccagtctcggag

SEQ ID NO: 774 - DNA, 24 bp, Homo sapiens
tcacacagtcagagacaacgaacc

SEQ ID NO: 775 - DNA, 24 bp, Homo sapiens
acccacagcatcacacggtccatc

SEQ ID NO: 776 - DNA, 24 bp, Homo sapiens
gtgatttgtgggcaacttatgaac

SEQ ID NO: 777 - DNA, 24 bp, Homo sapiens
cagaaggacaacagtgagggttac

SEQ ID NO: 778 - DNA, 24 bp, Homo sapiens
ggagtttcttccctgtgcggagtc

SEQ ID NO: 779 - DNA, 24 bp, Homo sapiens
ccctcctgtgtccagaccaatccg

SEQ ID NO: 780 - DNA, 26 bp, Homo sapiens
ggtcaatcttattctgaaaatcaccg

SEQ ID NO: 781 - DNA, 24 bp, Homo sapiens
ctctccactccctgcgtatccccg

SEQ ID NO: 782 - DNA, 24 bp, Homo sapiens
cactgttggtggttatggaaatcg

SEQ ID NO: 783 - DNA, 24 bp, Homo sapiens
atggtgacctgggaccgtttgagg

SEQ ID NO: 784 - DNA, 24 bp, Homo sapiens
agacgagaaaaaggcactcctacg

SEQ ID NO: 785 - DNA, 24 bp, Homo sapiens
cactcccttgttctaatcaccccg

SEQ ID NO: 786 - DNA, 25 bp, Homo sapiens
ttgacttgttatctatgttgctcgc

SEQ ID NO: 787 - DNA, 27 bp, Homo sapiens
ttatgtttgaagttgacactctatcgc

SEQ ID NO: 788 - DNA, 23 bp, Homo sapiens
tgtgctgaggggcgggacggtgg

SEQ ID NO: 789 - DNA, 23 bp, Homo sapiens
gggatggggatgggcagtgattg

SEQ ID NO: 790 - DNA, 23 bp, Homo sapiens
ccccacccgatgtctcccacaac

SEQ ID NO: 791 - DNA, 23 bp, Homo sapiens
gtcctggggatgagaaatcaaac

SEQ ID NO: 792 - DNA, 23 bp, Homo sapiens
acgagaaacacaaagtctacgcc

SEQ ID NO: 793 - DNA, 23 bp, Homo sapiens
gacacaacctggaggcggcaaag

SEQ ID NO: 794 - DNA, 24 bp, Homo sapiens
gctaatcttgtttcaactaccgcc

SEQ ID NO: 795 - DNA, 23 bp, Homo sapiens
ccattcacttcccgctcatacgc

SEQ ID NO: 796 - DNA, 23 bp, Homo sapiens
attgacccatctgtgcgtaaaac

SEQ ID NO: 797 - DNA, 23 bp, Homo sapiens
ttttcagtggaacctggtagtcg

SEQ ID NO: 798 - DNA, 24 bp, Homo sapiens
aaacagggatgaacctaaacttcg

SEQ ID NO: 799 - DNA, 23 bp, Homo sapiens
tggttgttggatttagggcactc

SEQ ID NO: 800 - DNA, 23 bp, Homo sapiens
cctcccaaatccctaactaccac

SEQ ID NO: 801 - DNA, 23 bp, Homo sapiens
aatcagaatgaaagacggggagc

SEQ ID NO: 802 - DNA, 23 bp, Homo sapiens
tcggggatggtttcaggactatc

SEQ ID NO: 803 - DNA, 23 bp, Homo sapiens
ggtgtcttttatgggcacgcttc

SEQ ID NO: 804 - DNA, 23 bp, Homo sapiens
agtgtgaggatagcaggtcgtgc

SEQ ID NO: 805 - DNA, 23 bp, Homo sapiens
agcaacctacagcacaaccacgc

SEQ ID NO: 806 - DNA, 23 bp, Homo sapiens
tctgatgaggagggaggactgcg

SEQ ID NO: 807 - DNA, 23 bp, Homo sapiens
ctgattgagggctttccgagagg

SEQ ID NO: 808 - DNA, 23 bp, Homo sapiens
tcaggattcacctccagggaacg

SEQ ID NO: 809 - DNA, 23 bp, Homo sapiens
acagatgacttgccaaagccgtc

SEQ ID NO: 810 - DNA, 24 bp, Homo sapiens
tgattctctttgtatccctttccg

SEQ ID NO: 811 - DNA, 24 bp, Homo sapiens
ctaaaggagttcaggtagggttgg

SEQ ID NO: 812 - DNA, 23 bp, Homo sapiens
tcccaacaaagcattacaaaccg

SEQ ID NO: 813 - DNA, 23 bp, Homo sapiens
tgaaaggacacacaaagcgtatc

SEQ ID NO: 814 - DNA, 25 bp, Homo sapiens
gagcatcaatgagttttacgacatc

SEQ ID NO: 815 - DNA, 23 bp, Homo sapiens
acacgctcttttgttacttgccg

SEQ ID NO: 816 - DNA, 23 bp, Homo sapiens
cctctcttcctcggcgtccttgc

SEQ ID NO: 817 - DNA, 23 bp, Homo sapiens
gtgaatggtagtgccttcgctcc

SEQ ID NO: 818 - DNA, 23 bp, Homo sapiens
aaccacgcatcacacggcacttc

SEQ ID NO: 819 - DNA, 23 bp, Homo sapiens
tcaaggctgggtcacgcaaggtc

SEQ ID NO: 820 - DNA, 23 bp, Homo sapiens
atccccctcaccctcctatcggc

SEQ ID NO: 821 - DNA, 23 bp, Homo sapiens
ttcagcctatcaacttccttgcc

SEQ ID NO: 822 - DNA, 23 bp, Homo sapiens
agaagaccgctctgatgggagtg

SEQ ID NO: 823 - DNA, 24 bp, Homo sapiens
gagattcctgaagtgttctttggc

SEQ ID NO: 824 - DNA, 25 bp, Homo sapiens
gtaaaaccacacattagaggacacg

SEQ ID NO: 825 - DNA, 24 bp, Homo sapiens
cctcctttagaaaaccatagcgtc

SEQ ID NO: 826 - DNA, 23 bp, Homo sapiens
tgtgaaactcttggcaactctcc

SEQ ID NO: 827 - DNA, 23 bp, Homo sapiens
tctggagaaatcagggtatcggc

SEQ ID NO: 828 - DNA, 23 bp, Homo sapiens
taaccctaaaacgaggaagcgtc

SEQ ID NO: 829 - DNA, 23 bp, Homo sapiens
gctgaaagccagtgcccatacgg

SEQ ID NO: 830 - DNA, 23 bp, Homo sapiens
ggagatggaatgtgctgactcgc

SEQ ID NO: 831 - DNA, 23 bp, Homo sapiens
taggctcactgtggcagaaagcg

SEQ ID NO: 832 - DNA, 23 bp, Homo sapiens
tagtcctggctgagggtctctcg

SEQ ID NO: 833 - DNA, 23 bp, Homo sapiens
ttcacactccacatctttgcgtc

SEQ ID NO: 834 - DNA, 23 bp, Homo sapiens
ttctgacccaggttgctatcaag

SEQ ID NO: 835 - DNA, 23 bp, Homo sapiens
atcaggatgaggggtgcgggttg

SEQ ID NO: 836 - DNA, 23 bp, Homo sapiens
caaggtgaggattttcaaggacg

SEQ ID NO: 837 - DNA, 23 bp, Homo sapiens
gtattttcaatctggcatcaggg

SEQ ID NO: 838 - DNA, 23 bp, Homo sapiens
cctcgctctctctctgcctttgc

SEQ ID NO: 839 - DNA, 23 bp, Homo sapiens
gtggaatgagatggaggacaacc

SEQ ID NO: 840 - DNA, 22 bp, Homo sapiens
gaaggtcaaggtcacgcatctc

SEQ ID NO: 841 - DNA, 22 bp, Homo sapiens
ccaaacgctgctccaaatactg

SEQ ID NO: 842 - DNA, 22 bp, Homo sapiens
ggtcaaggtcacgcatctcagg

SEQ ID NO: 843 - DNA, 23 bp, Homo sapiens
tgggagtcatcagagtatggctg

SEQ ID NO: 844 - DNA, 25 bp, Homo sapiens
acaccccacccacatcccacatcac

SEQ ID NO: 845 - DNA, 23 bp, Homo sapiens
gacacccctgttccagagtaacg

SEQ ID NO: 846 - DNA, 23 bp, Homo sapiens
acgagttgtgtgctctaaggtgc

SEQ ID NO: 847 - DNA, 23 bp, Homo sapiens
tccctaaggcagttaccaggaag

SEQ ID NO: 848 - DNA, 22 bp, Homo sapiens
cggaaatggaaccactaagaag

SEQ ID NO: 849 - DNA, 21 bp, Homo sapiens
atgtttggggctgataatgtg

SEQ ID NO: 850 - DNA, 23 bp, Homo sapiens
acacccatgaaatcagtagatgc

SEQ ID NO: 851 - DNA, 23 bp, Homo sapiens
ccttccaaatcaaacacattacc

SEQ ID NO: 852 - DNA, 23 bp, Homo sapiens
gcctggtaaaacagacagttcag

SEQ ID NO: 853 - DNA, 21 bp, Homo sapiens
taacacagcttcagcttcttg

SEQ ID NO: 854 - DNA, 22 bp, Homo sapiens
acactgctctgggagacctaag

SEQ ID NO: 855 - DNA, 23 bp, Homo sapiens
cttaagtgttgtggaggtaacgc

SEQ ID NO: 856 - DNA, 24 bp, Homo sapiens
ttccagtagccacttaacttctcc

SEQ ID NO: 857 - DNA, 23 bp, Homo sapiens
gaacttcagtgtgttccatagcc

SEQ ID NO: 858 - DNA, 24 bp, Homo sapiens
gttctcttaaggtactggagcctg

SEQ ID NO: 859 - DNA, 22 bp, Homo sapiens
aacaaataggctgtgtgtggtg

SEQ ID NO: 860 - DNA, 23 bp, Homo sapiens
tacatacatcacgaaatggttgc

SEQ ID NO: 861 - DNA, 24 bp, Homo sapiens
aggaagtgcaggatatggagatag

SEQ ID NO: 862 - DNA, 23 bp, Homo sapiens
aatcatgccagctactctctcag

SEQ ID NO: 863 - DNA, 24 bp, Homo sapiens
ccactgatattgaacaaaaggatg

SEQ ID NO: 864 - DNA, 23 bp, Homo sapiens
acagttcatgaaatagaaacccg

SEQ ID NO: 865 - DNA, 23 bp, Homo sapiens
agccagcgaatctaatgtacttg

SEQ ID NO: 866 - DNA, 23 bp, Homo sapiens
aagtacattagattcgctggctg

SEQ ID NO: 867 - DNA, 23 bp, Homo sapiens
aagtcagcttaggcactgttcac

SEQ ID NO: 868 - DNA, 23 bp, Homo sapiens
taggatgcaacactgacataacg

SEQ ID NO: 869 - DNA, 24 bp, Homo sapiens
aacacaacaaccaccatcatattc

SEQ ID NO: 870 - DNA, 25 bp, Homo sapiens
ttagaatatgatggtggttgttgtg

SEQ ID NO: 871 - DNA, 23 bp, Homo sapiens
cttggtcacattccttacactcc

SEQ ID NO: 872 - DNA, 20 bp, Homo sapiens
ggaaggccccacagcrtctt

SEQ ID NO: 873 - DNA, 20 bp, Homo sapiens
agcatgggtaagacaagcaa

SEQ ID NO: 874 - DNA, 21 bp, Homo sapiens
cggcactgtcagaaaggaatc

SEQ ID NO: 875 - DNA, 20 bp, Homo sapiens
cttccacttccactttgaaa

SEQ ID NO: 876 - DNA, 24 bp, Homo sapiens
ttaccaggcgaagttactatgagc

SEQ ID NO: 877 - DNA, 22 bp, Homo sapiens
gtgttgttccactgccaaagag

SEQ ID NO: 878 - DNA, 22 bp, Homo sapiens
gatgtagtccgccagaggatag

SEQ ID NO: 879 - DNA, 22 bp, Homo sapiens
acatataggtgggtggtgaagg

SEQ ID NO: 880 - DNA, 24 bp, Homo sapiens
ccctacttgatttcagccttttag

SEQ ID NO: 881 - DNA, 23 bp, Homo sapiens
tctctacctgtggaaccttgcta

SEQ ID NO: 882 - DNA, 22 bp, Homo sapiens
gatgtagtccgccagaggatag

SEQ ID NO: 883 - DNA, 22 bp, Homo sapiens
acatataggtgggtggtgaagg

SEQ ID NO: 884 - DNA, 24 bp, Homo sapiens
ggccagtggagataacactctaag

SEQ ID NO: 885 - DNA, 23 bp, Homo sapiens
gatcctttcccaaagttgtaacc

SEQ ID NO: 886 - DNA, 23 bp, Homo sapiens
gtgtggaagaaatacagcctgac

SEQ ID NO: 887 - DNA, 23 bp, Homo sapiens
aatcgccttcctcagtctaactc

SEQ ID NO: 888 - DNA, 22 bp, Homo sapiens
gagatcaaacaccctaacctgg

(19) United States
(12) Patent Application Publication
(10) Pub. No.: US 2011/0086772 A1
(43) Pub. Date: Apr. 14, 2011

(54) MULTIPLEX (+/-) STRANDED ARRAYS AND ASSAYS FOR DETECTING CHROMOSOMAL ABNORMALITIES ASSOCIATED WITH CANCER AND OTHER DISEASES

(75) Inventors: Lisa McDaniel, Spokane, WA (US); Blake Ballif, Greenacres, WA (US); Roger Schultz, Spokane, WA (US); Brice Tebbs, Spokane, WA (US); Bassem Bejjani, Spokane, WA (US); Lisa Shaffer, Colbert, WA (US)

(73) Assignee: Signature Genomics Laboratories LLC, Spokane, WA (US)

(21) Appl. No.: 12/891,623

(22) Filed: Sep. 27, 2010

Related U.S. Application Data
(60) Provisional application No. 61/246,077, filed on Sep. 25, 2009.

(51) Int. Cl. C40B 30/04; C40B 40/08

(52) U.S. Cl. 506/9; 506/17

(57) ABSTRACT

Multiplex (+/−) stranded analyses, such as array comparative genomic hybridization (aCGH), are provided for detecting chromosomal rearrangements associated with cancer and other diseases. For example, an illustrative multiplex array for CGH includes discrete plus (+) strand and minus (−) strand DNA probes, complementary to each other but separable on the CGH array. The minus (−) strand DNA probes recover diagnostic information lost to conventional microarrays, since many genes transcribe from the minus (−) strand. In an illustrative system, patient and control DNA samples are prepared for CGH by amplification and labeling using comprehensive primers that generate both plus (+) strands and minus (−) strands of DNA in the samples. The breakpoints of a translocated chromosome may be detected on a multiplex microarray by DNA probes of one polarity, while DNA copy number changes associated with the translocation region may be detected by corresponding DNA probes of the complementary polarity. Related methods for identifying translocation partner genes are also provided.

### RELATED APPLICATIONS

This patent application claims priority to U.S. Provisional Patent Application No. 61/246,077 to McDaniel et al., entitled, “Detecting Balanced Chromosomal Translocations” filed Sep. 25, 2009, and incorporated herein by reference in its entirety.

### STATEMENT REGARDING SEQUENCE LISTING

The Sequence Listing associated with this application is provided in text format in lieu of a paper copy, and is hereby incorporated by reference into the specification. The name of the text file containing the Sequence Listing is 220058_{—}412_SEQUENCE_LISTING.txt. The text file is 131 KB; it was created on Sep. 27, 2010; and it is being submitted electronically via EFS-Web, concurrent with the filing of the specification.

### BACKGROUND OF THE INVENTION

1. Field of the Invention

The present invention relates generally to multiplex (+/−) stranded arrays, e.g., (+/−) stranded comparative genomic hybridization arrays, and their use in detecting chromosomal abnormalities, such as balanced chromosomal translocations.

2. Description of the Related Art

Comparative hybridization methods test the ability of two nucleic acids to interact with a third target nucleic acid. In particular, comparative genomic hybridization (CGH) is a method for detecting chromosomal abnormalities. CGH was originally developed to detect and identify the location of gain or loss of DNA sequences, such as deletions, duplications or amplifications commonly seen in tumors (Kallioniemi et al., Science 258:818-821, 1992). For example, genetic changes resulting in an abnormal number of one or more chromosomes (i.e., aneuploidy) have provided useful diagnostic indicators of human disease, specifically as cancer markers. Changes in chromosomal copy number are found in nearly all major human tumor types. (See, e.g., Mittelman et al., “Catalog of Chromosome Aberrations” in CANCER, Vol. 2 (Wiley-Liss, 1994).

Early CGH techniques employed a competitive in situ hybridization between test DNA and normal reference DNA, each labeled with a different color, and a metaphase chromosomal spread. Chromosomal regions in the test DNA, which are at increased or decreased copy number as compared to the normal reference DNA can be quickly identified by detecting regions where the ratio of signal from the two different colors is altered. For example, those genomic regions that have been decreased in copy number in the test cells will show relatively lower signal from the test DNA than the reference (compared to other regions of the genome (e.g., a deletion)); while regions that have been increased in copy number in the test cells will show relatively higher signal from the test DNA (e.g., a duplication). Where a decrease or an increase in copy number is limited to the loss or gain of one copy of a sequence, CGH resolution is usually about 5-10 Megabases (Mb).

CGH has more recently been adapted to analyze individual genomic nucleic acid sequences rather than a metaphase chromosomal spread. Individual nucleic acid sequences are arrayed on a solid support, and the sequences can represent the entirety of one or more chromosome regions, chromosomes, or the entire genome. The hybridization of the labeled nucleic acids to the array targets is detected using different labels, e.g., two color fluorescence. Thus, array-based CGH with a plurality of individual nucleic acid sequences allows one to gain more specific information than a chromosomal spread, is potentially more sensitive, and facilitates the analysis of samples.

For example, in a typical array-based CGH, equitable amounts of total genomic nucleic acid from cells of a test sample and a normal reference sample are labeled with two different colors of fluorescent dye and co-hybridized to an array of BACs which contain the cloned nucleic acid fragments that collectively cover the cell's genome. The resulting co-hybridization produces a fluorescently labeled array, the coloration of which reflects the competitive hybridization of sequences in the test and reference genomic DNAs to the homologous sequences within the arrayed BACs. Theoretically, the copy number ratio of homologous sequences in the test and reference genomic nucleic acid samples should be directly proportional to the ratio of their respective colored fluorescent signal intensities at discrete BACs within the array. Array-based CGH is described in U.S. Pat. Nos. 5,830,645 and 6,562,565 for example, using target nucleic acids immobilized on a solid support in lieu of a metaphase chromosomal spread.

Although CGH is a powerful tool for genetic analysis, CGH has not been successfully adapted to comprehensively detect balanced chromosomal translocation events. A chromosomal translocation is a type of genetic anomaly that occurs when genetic material from one chromosomal region transfers to another. The phenotypic effects of certain translocations may be minor or unnoticeable; however, some translocations may have more severe phenotypic consequences including cellular transformation, mental retardation, infertility, congenital malformations, and dysmorphic features.

When such a “balanced” translocation occurs between two or more chromosomes in a cell, there is often no net gain or loss of genetic material. This results in a change that cannot be detected using conventional aCGH analysis, which relies on changes in DNA copy number (e.g., duplications, deletions) to provide observable results.

When the translocation is associated with causing a cancer, typically one of the products of the translocation is physiologically relevant and the rearranged chromosome now expresses an aberrant chimeric protein. Alternatively, a normal protein may become deregulated based on expression changes resulting from the translocation and its over-expression and/or over-activity may contribute to a disease phenotype. The reciprocal translocation, i.e., the other segment of swapped DNA on the other partner chromosome, often has no physiologic affect on the cancer cells or the prognosis of the patient.

Several attempts to detect genomic translocations via array CGH have been described. For example, U.S. patent application Ser. No. 11/288,982 to Mohammed (U.S. Published Patent Application No. 20070122820), entitled, “Balanced translocation in comparative hybridization,” describes hybridization using one or more special probes for detecting balanced translocations. Such probes are designed with the intent of being complementary to the moving genomic segment that is translocated, or may be complementary to the region of the translocation breakpoint.

Detection of balanced translocations at known genomic loci using aCGH is also described in International Patent Application PCT/US2008/083014 to Greisman (WO 2009/062166), entitled, “DNA Microarray Based Identification and Mapping of Balanced Translocation Breakpoints.” Greisman describes linear amplification primers that target known translocation breakpoint hotspots, e.g., near MYC and BCLG exon 1. That is, genomic DNA sequences associated with predetermined translocation breakpoints undergo linear amplification to become hybrid DNA fragments or “probes” that start in one genomic locus, extend across the translocation breakpoint, and into a translocation partner locus. The linear amplification may proceed across the breakpoint between the two translocated chromosomes using thermostable polymerases in a reaction resembling a PCR reaction without the reverse primer. This amplification uses gene specific primers annealed to the DNA. The primers act as a starting point for the DNA polymerase to synthesize a new strand of DNA during the amplification. This amplified patient DNA is labeled in one color and amplified control DNA labeled in another color for the aCGH procedure, i.e., the amplified patient DNA is labeled and subjected to array hybridization together with differentially labeled genomic reference DNA.

In certain specific cases, such as when applying the Greisman technique to identify immunoglobulin heavy chain (IgH) translocations, hybridization of the amplified and labeled genomic DNA to a tiling-density oligo array that is designed to represent the partner locus enables the Greisman techniques to identify the translocation partner and to map the genomic breakpoint to a conventional high resolution. When reading the CGH array, a decline in patient DNA should be observed following the breakpoint due to the amplified product crossing to another chromosome. There should also be a corresponding increase in the patient DNA observed on the array where the translocation partner is amplified, while this should not be observed for the control DNA that lacks the translocation.

Because a second primer targeting the partner locus is not required for amplification, the Greisman technique can detect, in some instances, translocation breakpoints scattered over large genomic regions and in multiple partner loci using a single array. Since amplified normal genomic DNA is used as the reference sample for array hybridization, in some instances the Greisman techniques can detect genomic imbalances and balanced translocations on the same array.

The Greisman technique uses conventional aCGH arrays made up of only positive or “plus” (+) strands of DNA that enable only the plus (+) strands of DNA (made minus (−) during labeling) to hybridize to the conventional array. Conventional aCGH arrays use genomic DNA that is numbered according to the upper strand of DNA when starting at the top or short arm of a chromosome. The plus (+) strand is also variously called the sense strand, the coding strand, or the non-template strand. The plus (+) strand is the DNA strand that has the same sequence as mRNA (except it has T bases instead of U bases). The other strand, variously called the minus (−) strand, antisense strand, or template strand, is complementary to the mRNA.

This numbering and polarity scheme, however, has no relationship to the strand off which a gene is transcribed. Approximately half of the genes in the genome are transcribed as the minus (−) strand of the genomic DNA. These genes exist as the physiologically important strand of DNA often neglected because it is the complementary reciprocal of (and therefore conventionally considered redundant to) the conventionally numbered DNA of the plus (+) strand. The physiologically important minus (−) strand is also omitted when reckoning oligo placement on conventionally designed CGH arrays.

Thus, the Greisman method has some drawbacks. The Greisman techniques detect a relatively small set of specific balanced translocations, but cannot detect many important balanced translocations, including many of the balanced translocations needed to investigate a cancer condition.

Besides limited coverage, the Greisman method requires pre-knowledge of a fairly specific location of each translocation breakpoint in order to generate a probe to span across the predetermined breakpoint location. More fundamentally, the Greisman techniques do not address the difference in polarity in different transcriptional strands. This is a limitation. Genes such as ABL1, for example, have multiple possible translocation partners that do not all occur on the same strand. ABL1 has six possible translocation partner genes, half of them on the plus (+) strand and half of them on the minus (−) strand. The MLL gene has 73 possible translocation partners on the plus (+) strand or the minus (−) strand. Thus, if a strand-specific labeling technique is used the Greisman techniques may not detect the translocation partner if the translocation partner is on the same strand as the probes on the array.

Thus, with respect to translocations that are important for cancer diagnoses, often only one end of a translocated segment is generally biologically relevant. Prior techniques detect the irrelevant end in many instances, not the end that contributes to a cancer or other disease phenotype. Further, prior techniques may incompletely characterize a translocation or may miss detecting a translocation and incorrectly conclude that no translocations are present.

Accordingly, in light of the deficiencies associated with prior methods, there remains a significant need for improved techniques for the detection of balanced translocations and other genetic rearrangements. The present invention fulfills these needs and offers other related advantages

### SUMMARY OF THE INVENTION

Multiplex (+/−) stranded array comparative genomic hybridization (CGH) methods and related arrays for detecting translocation signatures of cancer and other diseases are described. An illustrative multiplex array for CGH includes discrete plus (+) strand and minus (−) strand DNA probes, complementary to each other but separable on the CGH array. The minus (−) strand DNA probes recover diagnostic information lost to conventional arrays, since many genes are transcribed from the minus (−) strand. In an example system, subject and control DNA samples are prepared for array CGH by amplification of selected chromosomal regions (e.g., regions of diagnostic significance) using a comprehensive set of primers that generates both plus (+) strands and minus (−) strands of DNA in the samples. After equilibration and labeling, the breakpoint of a translocated chromosome may be detected on a multiplex (+/−) stranded array by DNA probes of one polarity, while DNA copy number gains and losses that may be associated with the translocation region can be detected by corresponding DNA probes of the complementary polarity. Translocation partner genes are also identified. The combined information obtained by detecting the rearrangement of a genomic locus using both plus (+) and minus (−) strand probes enables techniques to provide more comprehensive and accurate profile signatures for cancer and other diseases.

Therefore, according to a general aspect of the present invention, there is provided a method for detecting chromosomal abnormalities, comprising receiving a DNA sample; and analyzing the DNA sample via comparative genomic hybridization for chromosomal rearrangements using an array of plus (+)-stranded DNA probes and minus (−)-stranded DNA probes.

In one illustrative embodiment of the method, at least some of the plus (+)-stranded DNA probes each have a corresponding minus (−)-stranded DNA probe, wherein a plus (+)-stranded DNA probe and a corresponding minus (−)-stranded DNA probe are complementary reciprocals of each other.

In another illustrative embodiment of the method, a plus (+)-stranded DNA probe and a corresponding minus (−)-stranded DNA probe provide complementary hybridization targets for analyzing the chromosomal rearrangement of at least part of a DNA sequence of a genomic locus.

In yet another embodiment, the method may further comprise visualizing hybridization results at the plus (+)-stranded DNA probes and the minus (−)-stranded DNA probes as separate analyses defining one or more chromosomal rearrangements at genomic loci.

In still another embodiment, the step of analyzing the DNA sample includes performing an array analysis using an array that includes discrete plus (+)-stranded DNA probes and discrete minus (−)-stranded DNA probes as separate hybridization targets.

According to another aspect of the invention, there is provided a method for detecting chromosomal rearrangements, comprising: receiving a subject DNA sample extracted from a cell or tissue; receiving a control DNA sample; adding primers to the subject DNA sample and the control DNA sample for amplifying chromosomal regions (e.g., regions of diagnostic significance); amplifying the subject DNA sample to produce plus (+) strands of subject DNA and minus (−) strands of subject DNA representing the chromosomal regions, the (+) strands of subject DNA and the minus (−) strands of subject DNA within a subject DNA product that includes amplified subject DNA and unamplified subject DNA; labeling the plus (+) strands and the minus (−) strands of the subject DNA product with at least a first label to provide a labeled subject DNA product; amplifying the control DNA sample to produce plus (+) strands of control DNA and minus (−) strands of control DNA representing the chromosomal regions, the (+) strands of control DNA and the minus (−) strands of control DNA within a control DNA product that includes amplified control DNA and unamplified control DNA; and labeling the plus (+) strands and the minus (−) strands of the control DNA product with at least a second label to provide a labeled control DNA product.

In one illustrative embodiment, the method includes plus (+) strand DNA hybridization targets and minus (−) strand DNA hybridization targets attached to a single comparative genomic hybridization (CGH) array or other array type for simultaneously detecting: balanced translocations in the chromosomal regions; translocation partner genes associated with detected balanced translocations; and copy number gains and losses within or across the human genome.

In another embodiment, the method may further comprise attaching microRNAs to the CGH array as hybridization targets for diagnosing cancers.

In yet another embodiment, the method may further comprise analyzing the subject DNA sample, including hybridizing the labeled subject DNA product and the labeled control DNA product to the CGH array, the CGH array including a plurality of plus (+) strand DNA hybridization targets and the minus (−) strand DNA hybridization targets corresponding to the plurality of genomic loci.

In a related embodiment, the method may further comprise detecting a DNA copy number variation, if any, at the genomic locus via at least one of the complementary reciprocal DNA hybridization targets.

In another related embodiment, the method may further comprise detecting a prenatal or a postnatal disease condition using one of the plus (+) strand DNA hybridization targets or the minus (−) strand DNA hybridization targets. In still another embodiment, the method may further comprise detecting a balanced chromosomal translocation at a genomic locus of the subject DNA sample using either at least one of the plus (+) strand DNA hybridization targets or at least one of the minus (−) strand DNA hybridization targets.

In another related embodiment, the method may further comprise identifying a translocation partner gene associated with the balanced chromosomal translocation.

In still other embodiments, the step of detecting a balanced chromosomal translocation at a genomic locus in the subject DNA sample includes detecting a hybridization pattern on the array, the pattern indicating one or more of a decline in a subject DNA fluorescence signal following or adjacent to a translocation breakpoint in the DNA sequence representing the genomic locus; a corresponding increase in a subject DNA fluorescence signal at one or more DNA hybridization targets representing the translocation partner gene on the array; and an absence of corresponding declines and increases in the corresponding control DNA fluorescence signals.

In one exemplary embodiment, a method herein provides comprehensive or substantially complete coverage of chromosomal regions comprising one or more of the genes associated with a disease of interest. In a more specific embodiment, the one or more genes are selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB. In a more specific embodiment, the method provides comprehensive or substantially complete coverage of chromosomal regions comprising at least 2, at least 3, at least 4, at least 5, at least 10, at least 15, or all of the genes selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB. In a more specific embodiment, exemplary primers in this respect are set forth in Tables 1 and 2. In addition, other disease-associated genes that may be targeted using the methods and arrays herein can be found in Table 3.

In still another embodiment of the invention, a method herein may further comprise selecting additional primers to provide plus (+) strand DNA products and minus (−) strand DNA products that enable detection of translocation partner genes.

In a further embodiment, a method herein may further comprise labeling the subject DNA sample and the control DNA sample non-enzymatically to prevent making additional plus (+) and/or minus (−) strand copies of DNA during the labeling.

In another embodiment, a method herein may further comprise labeling each DNA polarity species in the amplified subject DNA product and in the amplified control DNA product with separate labels, wherein each separate label can be differentiated, e.g., in a CGH fluorescence scanner.

In yet another aspect of the present invention, there is provided a method for detecting chromosomal rearrangements, comprising: obtaining a DNA sample; amplifying the DNA sample to produce plus (+)-stranded DNA and minus (−)-stranded DNA representing chromosomal regions (e.g., of diagnostic significance) within a DNA product that includes amplified DNA and unamplified DNA; labeling the plus (+)-stranded DNA and the minus (−)-stranded DNA with at least a first label to provide a labeled DNA product; hybridizing the labeled DNA product to an array that includes plus (+)-stranded DNA targets and complementary minus (−)-stranded DNA targets of reverse polarity; and analyzing the array to detect a chromosomal translocation in the labeled DNA product. In a related embodiment, the method may further comprise visualizing hybridization results at the plus (+)-stranded DNA probes and the minus (−)-stranded DNA probes as separate analyses, wherein some chromosomal translocations are detected by the (+)-stranded DNA targets while other chromosomal translocations are detected by the (−)-stranded DNA targets.

Other exemplary methods of the present invention provide multiplex analysis of many types of genomic rearrangements indicative of cancer using a single array and estimate genomic signatures of numerous diseases. Further techniques provide quality control of amplification across multiple plus (+) and minus (−) strand DNA polarity species; simultaneous separate analyses of translocation and copy number variations visualized according to plus (+) and minus (−) DNA strands; display of average probe intensities across each chromosome partitioned into plus (+) strand intensities and minus (−) strand intensities; assessment of mosaicism in cancer patients based on the average probe intensities; and reports prioritizing remarkable genes and conditions.

According to yet another aspect of the present invention, there are provided arrays, both planar and three-dimensional, as described herein, wherein the arrays comprise plus (+)-stranded DNA probes and minus (−)-stranded DNA probes, and wherein the arrays are preferably effective for detecting chromosomal rearrangements in genes of diagnostic interest, such as those described herein. In one illustrative embodiment, at least some, and preferably substantially all, of the plus (+)-stranded DNA probes present in the array each have a corresponding minus (−)-stranded DNA probe, wherein a plus (+)-stranded DNA probe and a corresponding minus (−)-stranded DNA probe are complementary reciprocals of each other.

These and other aspects of the present invention will become apparent upon reference to the following detailed description and attached drawings. All references disclosed herein are hereby incorporated by reference in their entirety as if each was incorporated individually.

### BRIEF DESCRIPTION OF THE DRAWINGS

FIG. 1 is a diagram of an exemplary (+/−) stranded array CGH procedure.

FIG. 2 is a diagram of an exemplary multiplex (+/−) stranded CGH microarray.

FIG. 3 is a diagram of an exemplary environment for a (+/−) stranded array CGH system.

FIG. 4 is a block diagram of an exemplary (+/−) stranded array hybridization analyzer.

FIG. 5 is a diagram of exemplary hybridization results shown in a dual view that includes a plus (+) strand visual track and a corresponding minus (−) strand visual track.

FIG. 6 is a block diagram of an exemplary quality control engine for verifying amplification results.

FIG. 7 is a diagram of exemplary probe intensity zones for internal quality control.

FIG. 8 is a block diagram of an exemplary aneuploidy/mosaicism analyzer.

FIG. 9 is a flow diagram of an exemplary method of analyzing patient genomic DNA using an array that includes both plus (+) strand DNA probes and minus (−) strand DNA probes.

FIG. 10 is a flow diagram of an exemplary method of analyzing multiple hybridization results obtained from a multiplex (+/−) stranded CGH array.

FIG. 11 is a flow diagram of an exemplary method of performing (+/−) stranded array CGH.

FIG. 12 is a flow diagram of an exemplary method of performing amplification with primers to produce plus (+) strand DNA products and minus (−) strand DNA products representing regions of diagnostic significance in patient and control genomic DNA samples; and selecting plus (+) strand probes and minus (−) strand probes for a microarray to test the regions of diagnostic significance.

FIG. 13 is a flow diagram of an exemplary method of compiling a genomic signature characterizing a cancer.

FIG. 14 is a flow diagram of an exemplary method of performing quality control of amplification used in (+/−) stranded array CGH.

FIG. 15 is a flow diagram of an exemplary method of displaying hybridization results of (+/−) stranded in at least two visual tracks.

FIG. 16 is a flow diagram of an exemplary method of analyzing aneuploidy and mosaicism in a patient genomic DNA sample tested on a (+/−) stranded CGH array.

FIG. 17 is a screenshot diagram of amplification of BCR crossing the translocation breakpoint into ABL1.

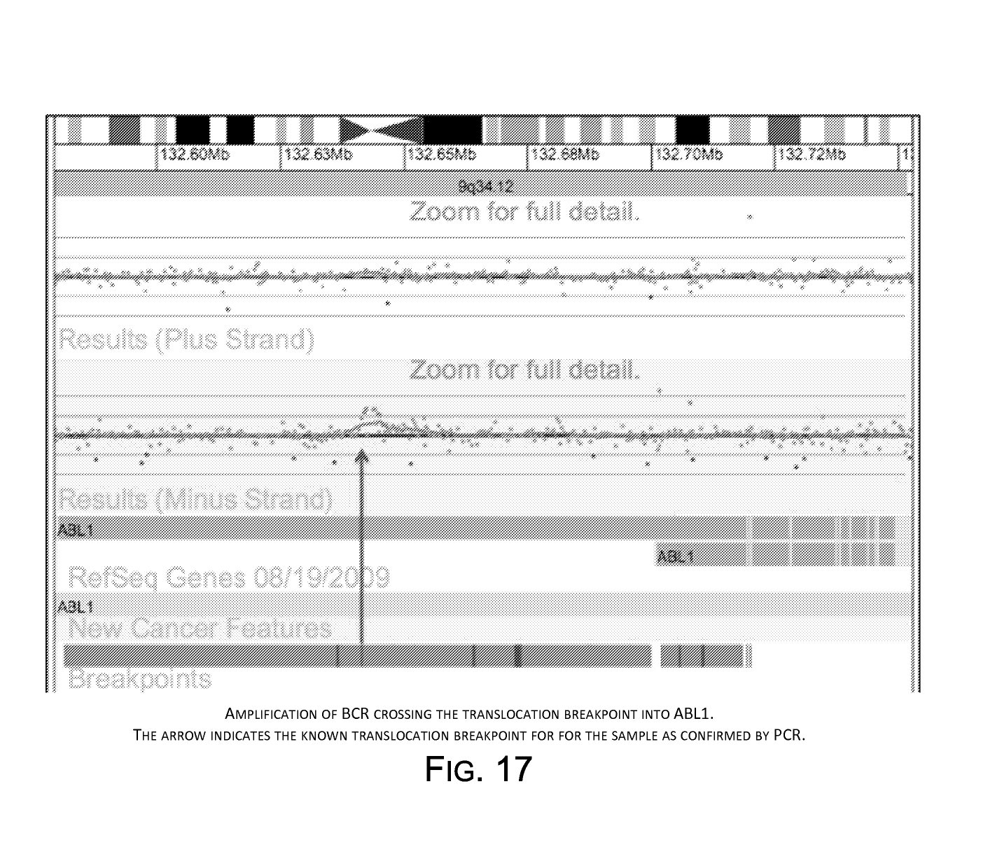

FIG. 18 is screenshot diagram of amplified genes in a patient sample co-hybridized with unamplified control DNA.

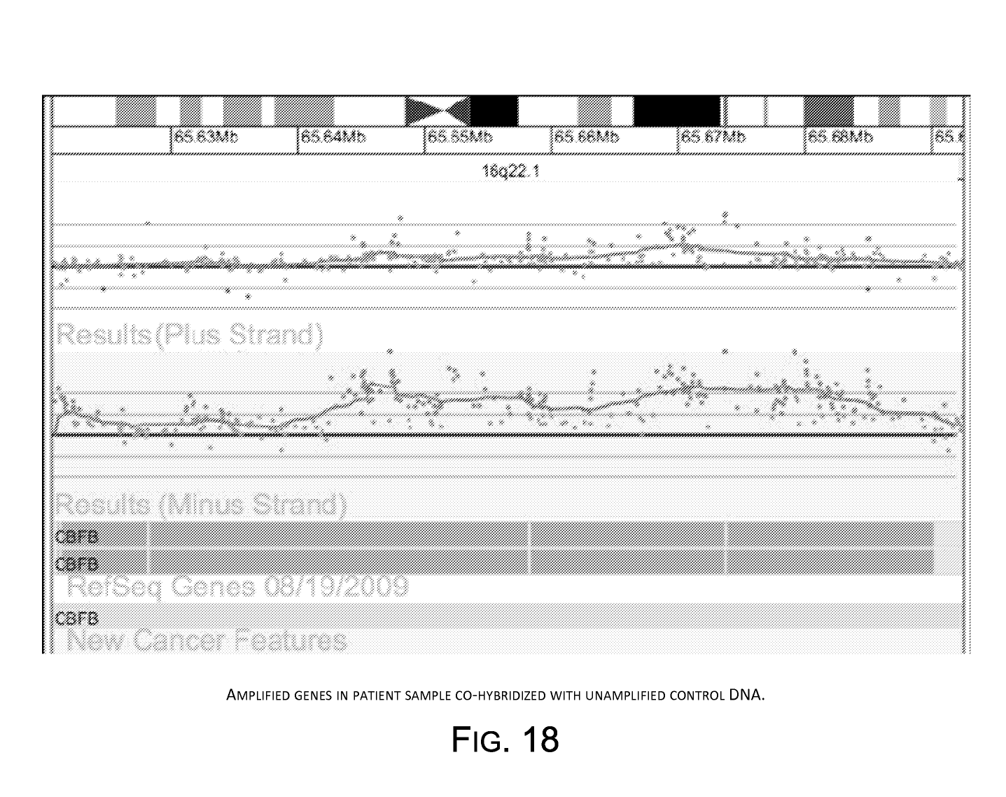

FIG. 19 is another screenshot diagram of amplified genes in a patient sample co-hybridized with unamplified control DNA.

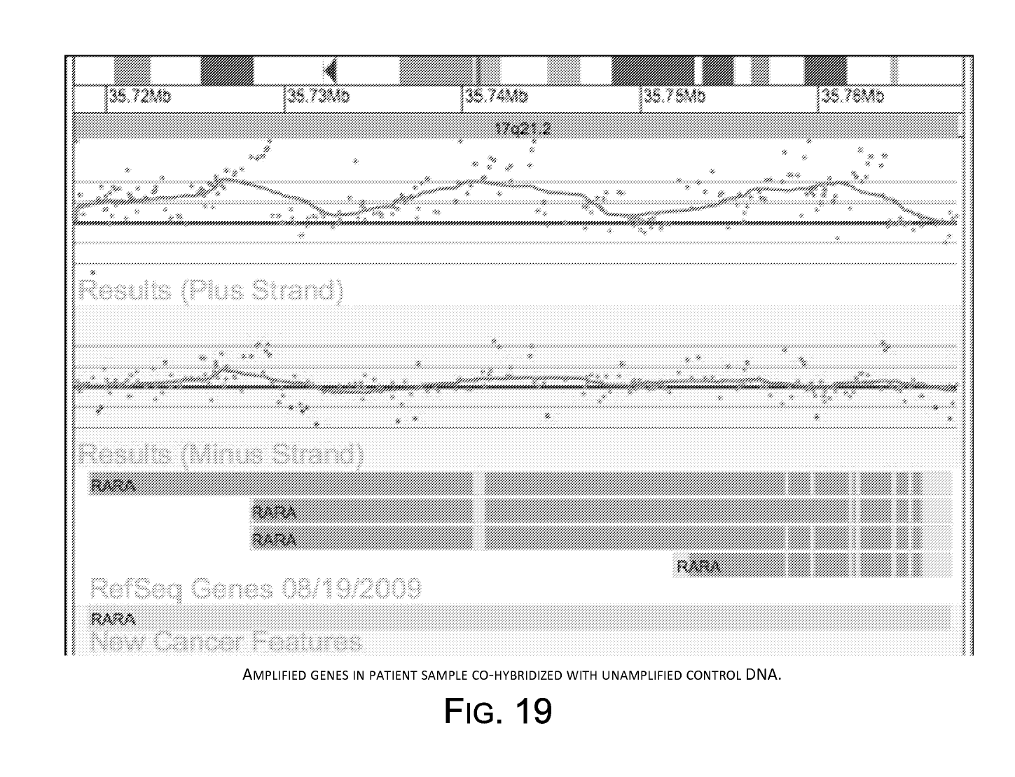

FIG. 20 is a block diagram of an exemplary non-CGH system for detecting balanced chromosomal translocations and other genetic aberrations.

FIG. 21 is a flow diagram of an exemplary process performed by the example system of FIG. 20.

FIG. 22 is a block diagram of an exemplary (+/−) stranded system for detecting balanced chromosomal translocations and other genetic aberrations.

FIG. 23 is a diagram of an exemplary (+/−) stranded non-CGH hybridization array or platform.

FIG. 24 is a diagram of exemplary hardware environment for performing non-CGH detection of genetic aberrations.

FIG. 25 is a diagram of exemplary hybridization results shown in a dual view that includes a plus (+) strand visual track and a corresponding minus (−) strand visual track.

FIG. 26 is a flow diagram of an exemplary method of detecting balanced chromosomal translocations on a non-CGH platform.

### BRIEF DESCRIPTION OF SEQUENCE IDENTIFIERS

SEQ ID NOs: 1-888 represent exemplary primer sequences useful in the methods of the invention, e.g., in the detection of balanced chromosomal translocations and other chromosomal abnormalities. Additional information relating to these primer sequences is also set forth in Tables 1 and 2.

### DETAILED DESCRIPTION OF THE INVENTION

The practice of the present invention will employ, unless otherwise indicated, conventional techniques of molecular biology, recombinant DNA, and chemistry, which are within the skill of the art. Such techniques are explained fully in the literature. See, e.g., Molecular Cloning A Laboratory Manual, 2nd Ed., Sambrook et al., ed., Cold Spring Harbor Laboratory Press: (1989); DNA Cloning, Volumes I and II (D. N. Glover ed., 1985); Oligonucleotide Synthesis (M. J. Gait ed., 1984); Mullis et al., U.S. Pat. No. 4,683,195; Nucleic Acid Hybridization (B. D. Hames & S. J. Higgins eds. 1984); B. Perbal, A Practical Guide To Molecular Cloning (1984); the treatise, Methods In Enzymology (Academic Press, Inc., N.Y.); and in Ausubel et al., Current Protocols in Molecular Biology, John Wiley and Sons, Baltimore, Md. (1989).

### DEFINITIONS

The following terms have the following meanings unless expressly stated to the contrary. It is to be noted that the term “a” or “an” entity refers to one or more of that entity; for example, “a nucleic acid,” is understood to represent one or more nucleic acids. As such, the terms “a” (or “an”), “one or more,” and “at least one” can be used interchangeably herein.

The terms “chromosomal rearrangement” or “chromosomal abnormality” refer generally to the aberrant joining of segments of chromosomal material in a manner not found in a wild-type or normal cell. Examples of chromosomal rearrangements include deletions, amplifications, inversions, translocations, and the like. Chromosomal rearrangements can arise after spontaneous breaks occur in a chromosome. If the break or breaks result in the loss of a piece of chromosome, a deletion has occurred. An inversion results when a segment of chromosome breaks off, is reversed (inverted), and is reinserted into its original location. When a piece of one chromosome is exchanged with a piece from another chromosome a translocation has occurred. Amplification results in multiple copies of particular regions of a chromosome. Chromosomal rearrangements may also encompass combinations of the above.

The term “translocation” or “chromosomal translocation” refers generally to an exchange of chromosomal material between the same or different chromosomes in equal or unequal amounts. Frequently, the exchange occurs between nonhomologous chromosomes. A “balanced” translocation refers generally to an exchange of chromosomal material in which there is no net loss or gain of genetic material. An “unbalanced” translocation refers generally to an unequal exchange of chromosomal material resulting in extra or missing chromosomal material.

A “nucleic acid array” or “nucleic acid microarray” is a plurality of nucleic acid elements, each comprising one or more target nucleic acid molecules immobilized on a solid surface to which probe nucleic acids are hybridized. Nucleic acids molecules that can be immobilized on such solid support include, without limitation, oligonucleotides, cDNAs, and genomic DNA. In the context of the present invention, arrays and microarrays containing sequences corresponding to different segments of genomic nucleic acids are used. The genomic elements of the arrays can represent the entire genome of an organism or can represent defined regions of a genome, e.g., particular chromosomes or contiguous segments thereof. Genome tiling microarrays comprise overlapping oligonucleotides designed to provide complete or nearly complete representation of an entire genomic region of interest. Arrays used according to the present invention can include, for example, planar arrays (e.g., a microarray), particle arrays (e.g., a fixed particle array, such as a bead chip) and random or three dimensional particle arrays (e.g., a population of beads in solution).

Comparative genomic hybridization (CGH) refers generally to molecular-cytogenetic methods for the analysis of copy number changes (gains/losses) in the DNA content of a given subject's DNA and often in tumor cells. In the context of cancer, for example, the method is based on the hybridization of labeled tumor DNA (frequently with a fluorescent label) and normal DNA (frequently with a second, different fluororescent label) to normal human metaphase preparations. Using epifluorescence microscopy and quantitative image analysis, regional differences in the fluorescence ratio of gains/losses vs. control DNA can be detected and used for identifying abnormal regions in the genome. CGH will generally detect only unbalanced chromosomes changes. Structural chromosome aberrations such as balanced reciprocal translocations or inversions cannot be detected, as they do not change the copy number. See, e.g., Kallioniemi et al., Science 258: 818-821 (1992).

In a variation of CGH, termed “Chromosomal Microarray Analysis (CMA)” or “ArrayCGH”, DNA from subject tissue and from normal control tissue (a reference) is differentially labeled (e.g., with different fluorescent labels). After mixing subject and reference DNA along with unlabeled human cot 1 DNA to suppress repetitive DNA sequences, the mixture is hybridized to a slide containing a plurality of defined DNA probes, generally from a normal reference cell. See, e.g., U.S. Pat. Nos. 5,830,645; 6,562,565. When oligonucleotides are used as elements on microarrays, a resolution typically of 20-80 base pairs can be obtained, as compared to the use of BAC arrays which allow a resolution of 100 kb. The (fluorescence) color ratio along elements of the array is used to evaluate regions of DNA gain or loss in the subject sample.

“Amplification” or an “amplification reaction” refers to any chemical reaction, including an enzymatic reaction, which results in increased copies of a template nucleic acid sequence. Amplification reactions include, by way of illustration, polymerase chain reaction (PCR) and ligase chain reaction (LCR) {see U.S. Pat. Nos. 4,683,195 and 4,683,202; PCR Protocols: A Guide to Methods and Applications (Innis et al, eds, 1990)), strand displacement amplification (SDA) (Walker, et al. Nucleic Acids Res. 20(7):1691 (1992); Walker PCR Methods Appl 3(1):1 (1993)), transcription-mediated amplification (Phyffer, et al, J. Clin. Microbiol. 34:834 (1996); Vuorinen, et al., J. Clin. Microbiol. 33:1856 (1995)), nucleic acid sequence-based amplification (NASBA) (Compton, Nature 350(6313):91 (1991), rolling circle amplification (RCA) (Lisby, Mol. Biotechnol. 12(1):75 (1999)); Hatch et al, Genet. Anal. 15(2):35 (1999)) and branched DNA signal amplification (bDNA) {see, e.g., Iqbal et al, Mol Cell Probes 13(4):315 (1999)).

Linear amplification refers to an amplification reaction which does not result in the exponential amplification of DNA. Examples of linear amplification of DNA include the amplification of DNA by PCR methods when only a single primer is used, as described herein. See, also, Liu, C. L., S. L. Schreiber, et al., BMC Genomics, 4: Art. No. 19, May 9, 2003. Other examples include isothermic amplification reactions such as strand displacement amplification (SDA) (Walker, et al. Nucleic Acids Res. 20(7): 1691 (1992); Walker PCR Methods Appl 3(1): 1 (1993), among others.

The reagents used in an amplification reaction can include, e.g., oligonucleotide primers; borate, phosphate, carbonate, barbital, Tris, etc. based buffers {see, U.S. Pat. No. 5,508,178); salts such as potassium or sodium chloride; magnesium; deoxynucleotide triphosphates (dNTPs); a nucleic acid polymerase such as Taq DNA polymerase; as well as DMSO; and stabilizing agents such as gelatin, bovine serum albumin, and non-ionic detergents (e.g. Tween-20).

A “probe” refers generally to a nucleic acid that is complementary to a specific nucleic acid sequence of interest.

The term “primer” refers to a nucleic acid sequence that primes the synthesis of a polynucleotide in an amplification reaction. Typically a primer comprises fewer than about 100 nucleotides and preferably comprises fewer than about 30 nucleotides. Exemplary primers range from about 5 to about 25 nucleotides.

A “target” or “target sequence” refers to a single or double stranded polynucleotide sequence sought to be amplified in an amplification reaction and/or sought to be targeted by a complementary nucleic acid, e.g., probe or primer.

The phrase “nucleic acid” or “polynucleotide” refers to deoxyribonucleotides or ribonucleotides and polymers thereof in either single- or double-stranded form. The term encompasses nucleic acids containing known nucleotide analogs or modified backbone residues or linkages, which are synthetic, naturally occurring, and non-naturally occurring, which have similar binding properties as the reference nucleic acid, and which are metabolized in a manner similar to the reference nucleotides. Examples of such analogs include, without limitation, phosphorothioates, phosphoramidates, methyl phosphonates, chiral-methyl phosphonates, 2-O-methyl ribonucleotides, peptide-nucleic acids (PNAs).

Two nucleic acid sequences or polypeptides are said to be “identical” if the sequence of nucleotides or amino acid residues, respectively, in the two sequences is the same when aligned for maximum correspondence as described below. The term “complementary to” is used herein to mean all or substantially all of a first sequence is complementary to at least a portion of a reference polynucleotide sequence.

The phrase “selectively (or specifically) hybridizes to” refers to the binding, duplexing, or hybridizing of a molecule only to a particular nucleotide sequence under stringent hybridization conditions when that sequence is present in a complex mixture.

The phrase “stringent hybridization conditions” refers to conditions under which a probe will hybridize to its target subsequence, typically in a complex mixture of nucleic acid, but does not substantially hybridize to other sequences. Stringent conditions are sequence-dependent and will be different in different circumstances. Longer sequences hybridize specifically at higher temperatures. An extensive guide to the hybridization of nucleic acids is found in Tijssen, Techniques in Biochemistry and Molecular Biology—Hybridization with Nucleic Probes, “Overview of principles of hybridization and the strategy of nucleic acid assays” (1993). Generally, stringent conditions are selected to be about 5-10° C. lower than the thermal melting point (Tm) for the specific sequence at a defined ionic strength pH. The Tm is the temperature (under defined ionic strength, pH, and nucleic concentration) at which 50% of the probes complementary to the target hybridize to the target sequence at equilibrium (as the target sequences are present in excess, at Tm, 50% of the probes are occupied at equilibrium). Stringent conditions will be those in which the salt concentration is less than about 1.0 M sodium ion, typically about 0.01 to 1.0 M sodium ion concentration (or other salts) at pH 7.0 to 8.3 and the temperature is at least about 30° C. for short probes (e.g., 10 to 50 nucleotides) and at least about 60° C. for long probes (e.g., greater than 50 nucleotides). Stringent conditions may also be achieved with the addition of destabilizing agents such as formamide. For high stringency hybridization, a positive signal is at least two times background, preferably 10 times background hybridization. Those of ordinary skill will readily recognize that alternative hybridization and wash conditions can be utilized to provide conditions of similar stringency.

For PCR, a temperature of about 36° C. is typical for low stringency amplification, although annealing temperatures may vary between about 32° C. and 48° C. depending on primer length. For high stringency PCR amplification, a temperature of about 62° C. is typical, although high stringency annealing temperatures can range from about 50° C. to about 65° C., depending on the primer length and specificity. Typical cycle conditions for both high and low stringency amplifications include a denaturation phase of 90° C.-95° C. for 30 sec -2 min., an annealing phase lasting 30 sec.-2 min., and an extension phase of about 72° C. for 1-2 min.

The term “cancer” refers to human cancers and carcinomas, leukemias, sarcomas, adenocarcinomas, lymphomas, solid and lymphoid cancers, etc. Examples of different types of cancer include, but are not limited to, monocytic leukemia, myelogenous leukemia, acute lymphocytic leukemia, and acute myelocytic leukemia, chronic myelocytic leukemia, promyelocytic leukemia, breast cancer, gastric cancer, bladder cancer, ovarian cancer, thyroid cancer, lung cancer, prostate cancer, uterine cancer, testicular cancer, neuroblastoma, squamous cell carcinoma of the head, neck, cervix and vagina, multiple myeloma, soft tissue and osteogenic sarcoma, colorectal cancer, liver cancer (i.e., hepatocarcinoma), renal cancer (i.e., renal cell carcinoma), pleural cancer, pancreatic cancer, cervical cancer, anal cancer, bile duct cancer, gastrointestinal carcinoid tumors, esophageal cancer, gall bladder cancer, small intestine cancer, cancer of the central nervous system, skin cancer, choriocarcinoma; osteogenic sarcoma, fibrosarcoma, glioma, melanoma, B-cell lymphoma, non-Hodgkin's lymphoma, Burkitt's lymphoma, Small Cell lymphoma, Large Cell lymphoma, and the like.

### (+/−) Stranded Array CGH

The present invention provides, in certain aspects, methods of carrying out (+/−) stranded array comparative genomic hybridization (aCGH), related multiplex (+/−) stranded arrays, as well as related methods that are, in some embodiments, implemented in hardware/software combinations.

In general terms, aCHG platforms label patient DNA with a first colored fluorescent dye and the reference or control DNA sample with a different, second colored fluorescent dye and then co-hybridize these two samples to probes anchored on an array. Each probe on the array is a sequence-specific oligonucleotide (“oligo”) carefully selected to detect the presence of a particular genomic locus or region of diagnostic significance. The corresponding patient and control instances of the genomic locus, when both present, compete or co-hybridize to the probe, which has a complementary base sequence to the targets. When the patient DNA sequence for a given locus matches the control DNA sequence, the dye colors are present at that probe or “array feature” in equal concentration, as observed by fluorescence microscopy. When the target patient DNA has an aberration over the target control DNA at the particular genomic locus, then the above equal-concentration color norm at that array probe is altered: when the patient DNA has a copy number gain, the patient's dye color predominates at array probes that test for that genomic locus; and when the patient DNA has a copy number loss, the control dye color predominates at array probes that test for that genomic locus.

The terms “(+/−) stranded array CGH” and “(+/−) stranded CGH array” or “(+/−) CGH” mean that primers used to amplify DNA for a (+/−) stranded array CGH test generate both plus (+) strand DNA and complementary minus (−) strand DNA to represent each chromosomal region being amplified. The (+/−) stranded CGH array, in turn, includes both plus (+) strand oligos and minus (−) strand oligos to provide hybridization targets for both the plus (+) strand and minus (−) strand DNA species in the patient and control samples. The systems, techniques, and arrays can be used for detecting genomic rearrangements related to cancer and other diseases, thereby providing important diagnostic and/or prognostic information.

As introduced above, conventional CGH arrays use genomic DNA that is numbered according to the upper strand of DNA when starting at the top or short arm of a chromosome, that is, they use plus (+) strand DNA probes. Molecular biology in general usually describes genes and DNA sequences in terms of the plus (+) strand, by convention, for example in the Human Genome Project. This numbering and polarity scheme, however, has no relationship to the strand off which a gene is actually transcribed. Approximately half of the genes in the genome are transcribed as the minus (−) strand of the genomic DNA. For example, genes commonly associated with cancer are transcribed off both plus (+) and minus (−) strands of the genomic DNA, e.g., CPS2 is transcribed off the minus (−) strand, while CDX1 is transcribed off the plus (+) strand. Conventional array CGH, adapted by Greisman (cited above) to detect a limited number of translocations, still remains a half-blind technique. The conventional amplification primers reproduce only plus (+) strands of a patient DNA sample, so chromosomal rearrangements on the minus (−) strand generally go undetected. Conventionally, the plus (+) strands, when labeled for CGH, become minus (−) strand complements of the plus (+) strands and hybridize to the conventional CGH array, which uses plus (+) strand oligos as probes on the array. Meanwhile, the minus (−) strands, when labeled for CGH, become plus (+) strand complements of the minus (−) strands and are washed off the CGH array undetected, because the plus (+) strand complements do not hybridize to the plus (+) strand-based CGH array.

The (+/−) stranded array CGH described herein address, in part, the limitations of these prior methods.

An illustrative multiplex (+/−) array for CGH detection of balanced translocations and other genetic rearrangements generally includes discrete plus (+) strand and minus (−) strand DNA (e.g., oligo) probes, complementary to each other but separable on the CGH array. Patient and control DNA samples are prepared, for example, by linear amplification, using a comprehensive set of primers that creates both plus (+) strand and reciprocal minus (−) strand representations of selected regions of selected chromosomes on which genetic rearrangements (e.g., breakpoints) relevant to cancer or other diseases may occur.

The methods of the invention may be used to detect a wide and comprehensive variety of chromosomal rearrangements and abnormalities associated with cancer and other diseases and identify breakpoints wherever they may occur within a relatively large collection of candidate chromosomes. This is in contrast to conventional aCGH methods, in which balanced translocations cannot normally be detected, and in contrast to the Greisman method, introduced above, in which only a limited number of translocations can be detected and can only be detected when the translocation occurs at predetermined loci preprogrammed into the conventional method. In other words, conventional techniques require foreknowledge of a relatively specific location where the translocation will occur, and are not amenable to unpredictable chromosomal rearrangements that cancer patients often present. Consequently, many translocations indicative of disease are missed by the conventional techniques.

To further illustrate this conventional deficiency, the Greisman method uses one to a few primers (e.g., twelve for IgH) for the amplification reaction to identify a translocation breakpoint. While this may be sufficient for coverage in the smallest genes it is not sufficient coverage for large genes and so requires foreknowledge of the translocation breakpoint to demonstrate a translocation. Genes such as BCR (137 Kb) and RUNX1 (261 Kb) require substantially more coverage to allow detection of even the known translocation breakpoints.

In contrast, in certain embodiments of the present invention, the primers and arrays herein provide substantially complete coverage for a large number of genes of interest, e.g., genes that are most frequently translocated and also the most prognostic in nature. For example, a microarray as used in the Greisman method has approximately 15,000 probes and targets approximately 26 genes, while in one exemplary embodiment of the present invention, a (+/−) stranded CGH microarray described herein (e.g., providing coverage for genes listed in Table 3) includes approximately 720,000 probes and targets approximately 1900 genes relevant to cancer. Thus, in a specific embodiment, a single multiplex (+/−) stranded CGH array can provide, for example, (i) complete coverage for up to about twenty or more genes, the translocation of which provides the most diagnostic, prognostic and therapeutic information about cancer of other disease of interest; (ii) coverage of over 300 translocation partner genes; (iii) high coverage of over 1900 genes relevant to cancer, and (iv) complete genome coverage at a resolution of one probe for each span of approximately 25 kilobases. In addition, the coverage of a gene of interest typically includes the entire gene, allowing not only the detection of known translocation breakpoints but also allowing for the identification of new breakpoints.

Therefore, according to one aspect of the present invention, there are provided methods for detecting any of a variety of chromosomal abnormalities in a test sample. In a specific embodiment, the chromosomal abnormality is a chromosomal rearrangement. In a more specific embodiment, the chromosomal abnormality is a balanced translocation. In certain other embodiments, multiple varieties of chromosomal abnormalities are detected simultaneously, or sequentially, using the methods described herein.

Generally, a test sample used in the methods of the present invention is obtained from a patient. The test sample can contain cells, tissues and/or fluid obtained from a patient suspected of having a pathology or condition associated with a chromosomal or genetic abnormality. For the purposes of diagnosis or prognosis, the pathology or condition is generally associated with genetic defects, e.g., with genomic nucleic acid base substitutions, amplifications, deletions and/or translocations. For example, in a specific embodiment, the test sample may be suspected of containing cancerous cells or nuclei from such cells. Samples may also include, but are not limited to, amniotic fluid, biopsies, blood, blood cells, bone marrow, cerebrospinal fluid, fecal samples, fine needle biopsy samples, peritoneal fluid, plasma, pleural fluid, saliva, semen, serum, sputum, tears, tissue or tissue homogenates, tissue culture media, urine, and the like. Samples may also be processed, such as sectioning of tissues, fractionation, purification, or cellular organelle separation.

Methods of isolating cell, tissue, or fluid samples are well known to those of skill in the art and include, but are not limited to, aspirations, tissue sections, drawing of blood or other fluids, surgical or needle biopsies, and the like. Samples derived from a patient may include frozen sections or paraffin sections taken for histological purposes. The sample can also be derived from supernatants (of cell cultures), lysates of cells, cells from tissue culture in which it may be desirable to detect levels of mosaicisms, including chromosomal abnormalities, and copy numbers.

Samples can be obtained from patients using well-known techniques such as venipuncture, lumbar puncture, fluid sample such as saliva or urine, tissue or needle biopsy, and the like. In a patient suspected of having a tumor containing cancerous cells, a sample may include a biopsy or surgical specimen of the tumor, including for example, a tumor biopsy, a fine needle aspirate, or a section from a resected tumor. A lavage specimen may be prepared from any region of interest with a saline wash, for example, cervix, bronchi, bladder, etc. A patient sample may also include exhaled air samples as taken with a breathalyzer or from a cough or sneeze. A biological sample may also be obtained from a cell or blood bank where tissue and/or blood are stored, or from an in vitro source, such as a culture of cells. Techniques for establishing a culture of cells for use as a sample source are well known to those of skill in the art.

In other aspects, the present invention provides methods for predicting, diagnosing and/or providing prognoses of diseases that are caused by chromosomal rearrangements, particularly chromosomal translocations, by detecting the presence of a chromosomal translocation having diagnostic significance and, optionally, determining the identity of the translocation partner(s). For example, if a diagnosis of Burkitt's lymphoma is desired, a primer for linear amplification of an appropriate immunoglobulin regulatory locus can be used to generate a probe for hybridization to a human array. Using the methods of the invention, a diagnosis of Burkitt's lymphoma would be indicated if the translocation partner for the immunoglobulin locus is identified as the gene for MYC.

In certain embodiments, the methods of the invention are particularly well suited for the diagnosis or prognosis of a cancer associated with a balanced chromosomal translocation.

In another embodiment, the methods of the invention can be used to detect a chromosomal or genetic abnormality in a fetus. For example, prenatal diagnosis of a fetus may be indicated for women at increased risk of carrying a fetus with chromosomal or genetic abnormalities. Risk factors are well known in the art, and include, for example, advanced maternal age, abnormal maternal serum markers in prenatal screening, chromosomal abnormalities in a previous child, a previous child with physical anomalies and unknown chromosomal status, parental chromosomal abnormality, and recurrent spontaneous abortions.

The methods of the invention can also be used to perform prenatal diagnosis using any type of embryonic or fetal cell. Fetal cells can be obtained through the pregnant female, or from a sample of an embryo. Thus, fetal cells are present in amniotic fluid obtained by amniocentesis, chorionic villi aspirated by syringe, percutaneous umbilical blood, a fetal skin biopsy, a blastomere from a four-cell to eight-cell stage embryo (pre-implantation), or a trophectoderm sample from a blastocyst (pre-implantation or by uterine lavage). Body fluids with sufficient amounts of genomic nucleic acid also may be used.

In other embodiments, the methods of the invention involve the detection and mapping of breakpoints in both partner genes involved in a chromosomal translocation using the methods described herein.

In still other embodiments, the present invention provides methods of analysis which comprise multiplex linear amplification for the detection of chromosomal rearrangements at more than one locus simultaneously. In one embodiment, the multiplex amplification is performed using a mixture of linear amplification primers.

In other embodiments, the methods provided by the present invention comprise the detection of a chromosomal rearrangement that is a balanced translocation. In still other embodiments, the methods provided by the present invention comprise the detection of a chromosomal rearrangement other than a balanced translocation. In certain embodiments, this chromosomal rearrangement detected is a deletion, a duplication, an amplification, an inversion, or an unbalanced translocation.

In further embodiments, the present invention may comprise the simultaneous detection of both balanced rearrangements and imbalanced chromosomal abnormalities. In certain other embodiments, the methods of the invention allow for simultaneous detection when the breakpoint for the imbalance is coincident with that of the balanced rearrangement.

The present invention further provides, in other embodiments, a method of diagnosing and/or providing a prognosis for a disease in an individual by detecting a chromosomal rearrangement known to be associated with the disease.

In other embodiments, the present invention provides a high density (+/−) stranded array for the detection of a balanced translocation in one or more target genes of interest. In certain embodiments, the high density arrays of the present invention are useful for the diagnosis, for providing a prognosis and/or for genotyping a disease, such as cancer. In a particular embodiment, for example, the invention provides a (+/−) stranded array effective for detecting genes represented in Tables 1 and 2. In another specific embodiment, the invention provides a (+/−) stranded array effective for detecting the genes represented in Table 3.

In yet another embodiment, the present invention provides primer mixtures that are useful for the detection of balanced translocations associated with a disease, such as cancer. In certain embodiments, the primer mixtures are useful for the linear amplification of genomic loci that are commonly involved in balanced translocations in individuals suffering from a disease. In some embodiments, the primer mixtures of the invention are useful for multiplex linear amplification and multiplex (+/−) aCGH analysis. In a particular embodiment, the primer mixture comprises a plurality of primers as set forth in Tables 1 and 2.

According to yet another aspect of the invention, there is provided an apparatus, comprising: a planar substrate material; DNA hybridization targets printed on the planar substrate material to make a comparative genomic hybridization (CGH) array; plus (+) strand DNA probes in a first subset of the DNA hybridization targets, wherein each plus (+) strand DNA probe represents at least part of a chromosomal region of diagnostic significance; minus (−) strand DNA probes in a second subset of the DNA hybridization targets, wherein each minus (−) strand DNA probe is complementary to a plus (+) strand DNA probe in the first subset of the DNA hybridization targets, and wherein each minus (−) strand DNA probe correspondingly represents, in reverse, the same chromosomal region of diagnostic significance represented by the complementary plus (+) strand DNA probe.

According to yet another aspect of the invention, there is provided an apparatus, comprising: a particle array substrate material (e.g., comprising a population of beads in solution); DNA hybridization targets printed on the substrate material to make a comparative genomic hybridization (CGH) array; plus (+) strand DNA probes in a first subset of the DNA hybridization targets, wherein each plus (+) strand DNA probe represents at least part of a chromosomal region (e.g., of diagnostic significance); minus (−) strand DNA probes in a second subset of the DNA hybridization targets, wherein each minus (−) strand DNA probe is complementary to a plus (+) strand DNA probe in the first subset of the DNA hybridization targets, and wherein each minus (−) strand DNA probe correspondingly represents, in reverse, the same chromosomal region of diagnostic significance represented by the complementary plus (+) strand DNA probe.

In one exemplary embodiment, the methods (and arrays) of the invention herein provide comprehensive or substantially complete coverage of chromosomal regions comprising one or more of the genes selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB. In a more specific embodiment, the methods (and arrays) provide comprehensive or substantially complete coverage of chromosomal regions comprising at least 2, at least 3, at least 4, at least 5, at least 10, at least 15, or all of the genes selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB

In yet another embodiment, the array comprises hybridization targets that enable detection of translocation breakpoints. For example, in another embodiment, a plurality of the plus (+) strand DNA probes and the minus (−) strand DNA probes can be used to simultaneously test for at least about 100, 200 or 300, or more, balanced translocation partner genes.

In another specific embodiment, the array comprises DNA hybridization targets sufficient to probe at least approximately 500, 1000, 1500 or 1900 genes associated with the detection and/or a prognosis of a cancer or other disease.

In still another embodiment, the apparatus comprises an arrangement of the hybridization targets for high resolution coverage of the human genome, wherein the CGH array includes a backbone genome coverage including, for example, at least about one DNA hybridization target for each span of approximately every 25 kilobases of the entire human genome.

In a further embodiment, the apparatus further comprises hybridization targets for one or more microRNAs of interest, e.g., for diagnosing a cancer.

In a related embodiment, the present invention further provides a method of constructing a comparative genomic hybridization array, comprising: selecting chromosomal loci for diagnosing clinically significant genetic alterations; representing at least some of the chromosomal loci with both plus (+) strand DNA probes and minus (−) strand DNA probes; and printing the plus (+) strand DNA probes and the minus (−) strand DNA probes on an array substrate.

The present invention also provides, in another embodiment, a comparative genomic hybridization (CGH) array, comprising: a substrate; plus (+) strand DNA probes affixed to the substrate for detecting a first set of balanced chromosomal translocations; and minus (−) strand DNA probes affixed to the substrate for detecting a second set of balanced chromosomal translocations. In a related embodiment, the first set of balanced chromosomal translocations and the second set of balanced chromosomal translocations intersect.

In another embodiment, the probes affixed to the substrate include probes for identifying a chromosomal translocation gene partner for a given balanced chromosomal translocation.

In another specific embodiment, the array preferably comprises probes for high resolution coverage of the human genome including at least a probe for each span of approximately every 25 kilobases of the human genome.

According to another aspect of the present invention, there are provided methods for visualizing (+/−) aCGH results, comprising: receiving a patient DNA sample extracted from a tissue; analyzing the patient DNA sample for chromosomal rearrangements using plus (+) strand DNA probes and minus (−) strand DNA probes on a comparative genomic hybridization array; and visualizing hybridization results of the plus (+) strand DNA probes and hybridization results of the minus (−) strand DNA probes as separate analyses of the patient DNA sample.

Such methods preferably include detecting a chromosomal translocation in the patient DNA sample using one of a first visualization of hybridization results at the plus (+) strand DNA probes or a second visualization of hybridization results at the minus (−) strand DNA probes. In a related embodiment, the methods include detecting a single chromosomal translocation by analyzing both the first visualization and the second visualization, wherein the single chromosomal translocation is detectable by only one of the plus (+) strand DNA probes or the minus (−) strand DNA probes.

The first and second visualizations can comprise full or substantially full genome profiles displayed in respective visual tracks for hybridization results of the plus (+) strand DNA probes and hybridization results of the minus (−) strand DNA probes. The full genome profiles may be scaled for visual comparison of corresponding points of the first and second visualizations.

In another embodiment, the first visualization and the second visualization provide simultaneous separate analyses of translocation and copy number variations visualized according to plus (+) strand DNA probes and minus (−) strand DNA probes.

In yet another embodiment, the methods may further comprise determining a partner gene associated with a chromosomal translocation by analyzing both the first visualization and the second visualization, wherein the partner gene is detectable by only one of the plus (+) strand DNA probes or the minus (−) strand DNA probes.

The methods of the invention may, in another embodiment, further comprise displaying average probe intensities across each chromosome or chromosomal region in the patient DNA sample, the average probe intensities partitioned into plus (+) strand DNA probe intensities and minus (−) strand DNA probe intensities.

In a related aspect of the invention, there is provided an analytical system, comprising: an array scanner for obtaining comparative genomic hybridization (CGH) results from an array, the array including plus (+) strand DNA probes and minus (−) strand DNA probes; a plus (+) strand hybridization analyzer to determine hybridization results from a set of plus (+) strand DNA probes; a minus (−) strand hybridization analyzer to determine hybridization results from a set of minus (−) strand DNA probes; and a display engine to show hybridization results of the plus (+) strand DNA probes and hybridization results on the minus (−) strand DNA probes as separate visualizations. The separate visualizations generally comprise a plus (+) strand DNA probe visual track and a minus (−) strand DNA probe visual track.

In one embodiment, the system further comprises a translocations detector/analyzer to determine a chromosomal translocation in a DNA sample using one of the plus (+) strand DNA probes or the minus (−) strand DNA probes; wherein the hybridization results of the plus (+) strand DNA probes and the minus (−) strand DNA probes are differentially displayed.

In another embodiment, the system further comprises a copy number variation detector/analyzer to determine a duplication and/or a deletion in a DNA sample using one of the plus (+) strand DNA probes or the minus (−) strand DNA probes; wherein the hybridization results of the plus (+) strand DNA probes and the minus (−) strand DNA probes are differentially displayed.

In yet another embodiment, the system further comprises a translocation partner gene detector/analyzer to determine a partner gene associated with a chromosomal translocation using one of the plus (+) strand DNA probes or the minus (−) strand DNA probes; wherein the hybridization results of the plus (+) strand DNA probes and the minus (−) strand DNA probes are differentially displayed.

According to another aspect of the invention, the methods herein may further provide an output that differentiates the plus (+) strands and minus (−) strands into separate visual displays so that a cytogeneticist can view the two results of the plus (+) and minus (−) strands in juxtaposition—with one strand polarity typically showing the amplified balanced translocation exchange and the other strand (of the other polarity) automatically reflecting copy number gains and losses (or else reflecting normal DNA) in the same region. Therefore, according to this aspect of the present invention, there is provided a method for displaying CGH results, comprising: displaying comparative genomic hybridization results of plus (+) stranded DNA array targets in a first visual track; and displaying comparative genomic hybridization results of minus (−) stranded DNA array targets in a second visual track.

In a more specific embodiment, the method displays a hybridization result indicating detection of a chromosomal translocation in the first visual track when the chromosomal translocation is detected by the plus (+) stranded DNA array targets; and displaying a hybridization result indicating detection of a chromosomal translocation in the second visual track when the chromosomal translocation is detected by the minus (−) stranded DNA array targets.

In another specific embodiment, the method displays a hybridization result indicating detection of a chromosomal aberration in the first visual track when the chromosomal aberration is detected by the plus (+) stranded DNA array targets; and displaying a hybridization result indicating detection of a chromosomal aberration in the second visual track when the chromosomal aberration is detected by the minus (−) stranded DNA array targets.

In still another specific embodiment, the method displays color-coded genomic hybridization results of plus (+) stranded DNA array targets in a first color; and color-coded genomic hybridization results of minus (−) stranded DNA array targets in a second color.

In another embodiment, the method may further comprise displaying a magnitude of a genomic hybridization result of the plus (+) stranded DNA array targets by displaying an intensity or a shade of the first color that indicates the relative magnitude; and color-coding a magnitude of a genomic hybridization result of the minus (−) stranded DNA array targets by displaying an intensity or a shade of the second color that indicates the relative magnitude.

In another embodiment, the method may further comprise displaying the first visual track and the second visual track in close visual proximity for visual comparison of corresponding parts of the first visual track and the second visual track.

In still other embodiments of the invention, there are provided method for evaluating and confirming that the amplified DNA probes used in a method herein meet a quality standard that has, until now, not before been needed for aCGH technology. Therefore, according to another aspect, there are provided quality control methods comprising: amplifying and labeling chromosomal regions of diagnostic significance in a patient DNA sample, including amplifying a plus (+) strand patient DNA probe for each chromosomal region of diagnostic significance; amplifying a minus (−) strand patient DNA probe for each chromosomal region of diagnostic significance; annealing the plus (+) strand patient DNA probes and the minus (−) strand patient DNA probes to a first fluorescent label; and verifying concentrations of the plus (+) strand patient DNA probes and the minus (−) strand patient DNA probes before chromosomal testing of the chromosomal regions amplified from the patient DNA sample. Of course, it will be understood that the method may be used to monitor concentrations across multiple amplification runs.

The step of verifying concentrations can be carried out using standard methodologies, such as measuring a fluorescence signal associated with a chromosomal region of diagnostic significance. Typically, it is desired to verify an equal or substantially equal concentration of plus (+) strand patient DNA probes and minus (−) strand patient DNA probes for a given chromosomal region amplified from the patient DNA sample.

In certain embodiments, the method may further comprise: amplifying and labeling chromosomal regions of diagnostic significance in a control DNA sample, including amplifying a plus (+) strand control DNA probe annealed to a second fluorescent label for each chromosomal region of diagnostic significance; and amplifying a minus (−) strand control DNA probe annealed to the second fluorescent label for each chromosomal region of diagnostic significance; verifying concentrations of the plus (+) strand control DNA probes and the minus (−) strand control DNA probes before chromosomal testing of the chromosomal regions amplified from the patient DNA sample.

In certain other embodiments, the method may further comprise hybridizing the plus (+) strand patient DNA probes, the minus (−) strand patient DNA probes, the plus (+) strand control DNA probes, and the minus (−) strand control DNA probes to a comparative genomic hybridization (CGH) array; and measuring a fluorescence signal associated with a hybridization target for a given chromosomal region to verify the concentrations of the plus (+) strand patient DNA probes, the minus (−) strand patient DNA probes, the plus (+) strand control DNA probes, and the minus (−) strand control DNA probes for the chromosomal region.

The present invention, in a related aspect, provides a system, comprising: an apparatus for amplifying and labeling chromosomal regions of diagnostic significance in a patient DNA sample, where the apparatus is capable of amplifying a plus (+) strand patient DNA probe for each chromosomal region of diagnostic significance; and capable of amplifying a minus (−) strand patient DNA probe for each chromosomal region of diagnostic significance; and a quality control engine for verifying concentrations of the plus (+) strand patient DNA probes and the minus (−) strand patient DNA probes.

The quality control engine may verify concentrations of the plus (+) strand patient DNA probes and the minus (−) strand patient DNA probes using any suitable technique, e.g., by measuring raw fluorescence signals or any other suitable method. The system may also further comprise a chromosomal region tracker, wherein the quality control engine verifies concentrations of the plus (+) strand patient DNA probes and the minus (−) strand patient DNA probes associated with each chromosomal region designated by the chromosomal region tracker. The quality control engine preferably also verifies a substantially equal concentration of plus (+) strand patient DNA probes and minus (−) strand patient DNA probes for a given chromosomal region designated by the chromosomal region tracker.

In another embodiment, the system may further comprise a channel manager to track concentrations of the plus (+) strand patient DNA probes, the minus (−) strand patient DNA probes, plus (+) strand control DNA probes, and minus (−) strand control DNA probes for a given chromosomal region of diagnostic significance.

In another embodiment, the system may further comprise a long term reliability monitor, to track a repeatability of concentrations of the plus (+) strand patient DNA probes, the minus (−) strand patient DNA probes, plus (+) strand control DNA probes, and minus (−) strand control DNA probes for chromosomal regions of diagnostic significance over multiple amplification runs.

In still another embodiment, the system may further comprise an alert module, to indicate when one of the concentrations value falls outside a predetermined range of concentration values.

According to yet another aspect of the invention, there is provided a computer-readable storage medium tangibly containing instructions, which when executed, cause the computer to perform a process, comprising: amplifying and labeling chromosomal regions of diagnostic significance in a patient DNA sample, including amplifying a plus (+) strand patient DNA probe for each chromosomal region of diagnostic significance; amplifying a minus (−) strand patient DNA probe for each chromosomal region of diagnostic significance; annealing the plus (+) strand patient DNA probes and the minus (−) strand patient DNA probes to a first fluorescent label; and verifying concentrations of the plus (+) strand patient DNA probes and the minus (−) strand patient DNA probes. The computer-readable storage medium may further comprise, in certain embodiments, instructions for verifying concentrations using, e.g., a spectrophotometric method; a fluorescence measurement method; or a comparative genomic hybridization method using plus (+) strand control DNA probes and minus (−) strand control DNA probes.

According to another aspect, the present invention provides a method comprising: scanning a (+/−)-stranded comparative genomic hybridization (CGH) array, which can include a planar array, particle array (e.g., bead chip) or the like, for signals indicative of genetic alterations, including genetic alterations revealed by plus (+) strand or sense strand DNA probes and for genetic alterations revealed by minus (−) strand or anti-sense strand DNA probes; and producing a report to separately indicate the genetic alterations revealed by the plus (+) strand DNA probes and the genetic alterations revealed by the minus (−) strand DNA probes.

For example, the report may show or describe a differential between the genetic alterations revealed by the plus (+) strand DNA probes and the genetic alterations revealed by the minus (−) strand DNA probes. In a related embodiment, the report may show or describe or identify at least an aspect of a genetic alteration revealed by both a plus (+) strand DNA probe and a minus (−) strand DNA probe, such as a chromosomal translocation, a presence or an identity of a translocation partner gene, or a copy number change.

The report may further provide information concerning the identification of a balanced translocation, and optionally whether a balanced chromosomal translocation was detected by a plus (+) strand DNA probe or a minus (−) strand DNA probe. A filter or algorithm may be applied to prioritize genetic alterations indicated in the report. Such a filter or algorithm may filter out minor DNA copy number changes from the report or from a prioritized report. Alternatively, or in addition, the report may filter out genomic rearrangements in non-diagnostic parts of the genome from the report or from a prioritized report. The report may further comprise, for example, a prioritized list of genes indicative of a disease or disease condition and/or may include an identification of the gene region or regions to be reviewed by a practitioner. Of course, any other type of useful information may also be incorporated or otherwise contained within the report as needed or desired.

According to yet another aspect, the present invention provides a machine-readable storage medium containing instructions, which when executed by the machine, cause the machine to perform a process, including: analyzing fluorescence signals at plus (+) strand DNA probes and minus (−) strand DNA probes in a first set of hybridization targets on a (+/−) stranded CGH array for one or more genomic translocations in an amplified patient DNA sample; separately analyzing fluorescence signals from a second set of hybridization targets on the (+/−) stranded CGH array for DNA copy number changes across the human genome; and generating a report to separately indicate the genomic translocations revealed by the plus (+) strand DNA probes and the genomic translocations revealed by the minus (−) strand DNA probes.

In certain embodiments, the machine-readable storage medium may further comprise instructions for generating the report to additionally indicate copy number changes across the human genome and/or to contain a prioritized list of genes with potential disease based on the analyzing of the fluorescence signals from the first and second subsets of hybridization targets. The report may further comprise, for example, instructions for detecting translocation partner genes using the first set of hybridization targets, and/or any other information of interest.

In another related aspect, the present invention provides a method, comprising: selecting a threshold number of DNA copy number changes associated with a genomic locus; selecting a maximum amount of overall chromosomal change tolerated at a genomic locus; analyzing genes represented in a patient DNA sample on a (+/−) stranded CGH array for DNA copy number changes characteristic of a cancer; analyzing hybridization targets on the (+/−) stranded CGH array for DNA copy number changes across the human genome; and generating a report of genes in the patient DNA sample having changes characteristic of a cancer, genes that have exceeded the threshold number of DNA copy number changes, and/or genes that have exceeded the maximum amount of overall chromosomal change.

According to another aspect of the invention, there are provided methods of detecting genetic anomalies using plus strand and minus strand DNA probes on a comparative genomic hybridization (CGH) array, comprising: for each arm of each chromosome in a set of patient chromosomes in a patient DNA sample, measuring probe intensities of plus (+) strand DNA hybridization targets and minus (−) strand DNA hybridization targets associated with each arm of the individual chromosome; deriving an average probe intensity of each arm of each chromosome in the set of patient chromosomes from the measured probe intensities of the plus (+) strand DNA hybridization targets and the minus (−) strand DNA hybridization targets; mapping the plus (+) strand DNA average probe intensities and the minus (−) strand DNA average probe intensities per arm of each chromosome to respective representations of the patient chromosome set; and displaying the plus (+) strand DNA average probe intensity of each arm of each patient chromosome and the minus (−) strand average probe intensity of each arm of each patient chromosome.

In one embodiment, the method may further comprise combining the plus (+) strand DNA average probe intensities and the minus (−) strand DNA average probe intensities; and displaying the combined average probe intensities of each arm of each patient chromosome.

In another embodiment, the method may further comprise generating a report of the plus (+) strand DNA average probe intensity of each arm of each patient chromosome and the minus (−) strand average probe intensity of each arm of each patient chromosome, wherein the report comprises a graphic, including one of a bar graph, a histogram, or a pictorial chromosome diagram.

In another embodiment, the method may further comprise estimating a presence or an absence of aneuploidy in the patient DNA sample based on the average probe intensities associated with each arm of each chromosome. In yet another embodiment, the method may further comprise estimating a level of mosaicism in the patient DNA sample based on the average probe intensities associated with each arm of each chromosome.

In still another embodiment, the method may further comprise generating a report of the plus (+) strand and minus (−) strand DNA average probe intensities of each arm of each patient chromosome, the report estimating a presence or an absence of aneuploidy and a level of mosaicism for the patient DNA sample.

In a further embodiment, the method may further comprise providing a cancer diagnosis or prognosis based on the level of mosaicism. In a related aspect of the present invention, there is provided a computer-readable storage medium containing instructions, which when executed, cause a computing device to perform a method, comprising: for each arm of each chromosome in a set of patient chromosomes in a patient DNA sample, measuring probe intensities of plus (+) strand DNA hybridization targets and minus (−) strand DNA hybridization targets associated with each arm of an individual chromosome, the hybridization targets on a comparative genomic hybridization (CGH) array; deriving an average probe intensity of each arm of each chromosome from the measured probe intensities of the plus (+) strand DNA hybridization targets and the minus (−) strand DNA hybridization targets; mapping the plus (+) strand DNA average probe intensities and the minus (−) strand DNA average probe intensities per arm of each chromosome to respective representations of the patient chromosome set; and displaying the plus (+) strand DNA average probe intensity of each arm of each patient chromosome and the minus (−) strand average probe intensity of each arm of each patient chromosome.

In one embodiment, the computer-readable storage medium may further comprise instructions for: combining the plus (+) strand DNA average probe intensities and the minus (−) strand DNA average probe intensities; and displaying the combined average probe intensities of each arm of each patient chromosome.

In another embodiment, the computer-readable storage medium may further comprise instructions for generating a report of the plus (+) strand DNA average probe intensity of each arm of each patient chromosome and the minus (−) strand average probe intensity of each arm of each patient chromosome, wherein the report comprises a graphic, including one of a bar graph, a histogram, or a pictorial chromosome diagram.

In yet another embodiment, the computer-readable storage medium may further comprise instructions for estimating a presence or an absence of aneuploidy in the patient DNA sample based on the average probe intensities associated with each arm of each chromosome.

In still another embodiment, the computer-readable storage medium may further comprise instructions for estimating a level of mosaicism in the patient DNA sample based on the average probe intensities associated with each arm of each chromosome.

In another embodiment, the computer-readable storage medium may further comprise instructions for generating a report of the plus (+) strand and minus (−) strand DNA average probe intensities of each arm of each patient chromosome, the report estimating a presence or an absence of aneuploidy and a level of mosaicism for the patient DNA sample.

In another embodiment, the computer-readable storage medium may further comprise instructions for deriving a cancer prognosis based on the level of mosaicism.

In a related aspect of the invention, there is provided a system, comprising: an array scanner for reading hybridization results from a comparative genomic hybridization (CGH) array; an intensity compiler for determining probe intensities of plus (+) strand DNA hybridization targets and minus (−) strand DNA hybridization targets on a (+/−) stranded CGH array, the probe intensities associated with individual arms of each chromosome in a set of patient chromosomes in a patient DNA sample; the intensity compiler to derive an average probe intensity of each arm of each chromosome from the measured probe intensities of the plus (+) strand DNA hybridization targets and the minus (−) strand DNA hybridization targets; a mapper to associate the plus (+) strand DNA average probe intensities and the minus (−) strand DNA average probe intensities per arm of each chromosome to respective representations of the patient chromosome set; and a display engine to show the plus (+) strand DNA average probe intensity of each arm of each patient chromosome and the minus (−) strand average probe intensity of each arm of each patient chromosome.

In one embodiment, the intensity compiler combines the plus (+) strand DNA average probe intensities and the minus (−) strand DNA average probe intensities; and the display engine shows the combined average probe intensities of each arm of each patient chromosome.

In another embodiment, the system further comprises a reporting engine to generate a report of the plus (+) strand DNA average probe intensity of each arm of each patient chromosome and the minus (−) strand average probe intensity of each arm of each patient chromosome, wherein the report comprises a graphic, including one of a bar graph, a histogram, or a pictorial chromosome diagram.

In another embodiment, the system further comprises a diagnostic suggestion engine to estimate a presence or an absence of aneuploidy in the patient DNA sample based on the average probe intensities associated with each arm of each chromosome.

In another embodiment, the system further comprises a mosaicism estimator to determine a level of mosaicism in the patient DNA sample based on the average probe intensities associated with each arm of each chromosome.

In another embodiment, the system further comprises a reporting engine to generate a report of the plus (+) strand and minus (−) strand DNA average probe intensities of each arm of each patient chromosome; wherein the report shows an estimation of a presence or an absence of aneuploidy and a level of mosaicism for the patient DNA sample; and wherein the report suggests a cancer or other disease diagnosis or prognosis based on the level of mosaicism.

According to another aspect of the invention, there is provided a method comprising: creating plus (+) strand DNA probes and minus (−) strand DNA probes to test for chromosomal alterations in DNA samples; detecting a chromosomal alteration in a DNA sample using either a plus (+) strand DNA probe or a minus (−) strand DNA probe; and compiling a genomic signature characterizing a cancer or other disease, based on the chromosomal alteration.

In one embodiment, the step of detecting a chromosomal alteration comprises detecting a chromosomal translocation using a plus (+) strand DNA probe or detecting a chromosomal translocation using a minus (−) strand DNA probe; and wherein compiling a genomic signature characterizing a cancer or other disease is based on the chromosomal translocation.

In another embodiment, the step of detecting a chromosomal alteration comprises detecting a copy number variation using a plus (+) strand DNA probe or a minus (−) strand DNA probe; and wherein compiling a genomic signature characterizing a cancer or other disease is based on the copy number variation.

In another embodiment, the step of detecting a chromosomal alteration comprises detecting a translocation partner gene using a plus (+) strand DNA probe or a minus (−) strand DNA probe; and wherein compiling a genomic signature characterizing a cancer or other disease is based on the translocation partner gene.

In yet another embodiment, the step of detecting a chromosomal alteration in a DNA sample via either a plus (+) strand DNA probe or a minus (−) strand DNA probe utilizes a comparative genomic hybridization (CGH) array, e.g., a planar array, particle array (e.g., bead chip) or the like.

In still another embodiment, the step of compiling a genomic signature characterizing a cancer or other disease is based on two or more chromosomal alterations that occur together in a DNA sample. In a related embodiment, the two or more chromosomal alterations that occur together include two or more chromosomal alterations from the group of chromosomal alterations consisting of chromosomal translocations, partner genes associated with the one or more chromosomal translocations, and/or copy number variations.

Of course, it will be understood that the method may also comprise cataloguing the genomic signatures of a plurality of cancers, cancer conditions, and other diseases into a genomic signature library. In a related embodiment, the method may further comprise characterizing a cancer, cancer condition, or disease by comparing a detected chromosomal translocation, a translocation gene partner, and/or DNA copy number variations with genomic signatures in the genomic signature library.

According to another aspect of the present invention, there is provided a computer-readable storage medium tangibly containing instructions, which when executed, cause a computing device to perform a process, comprising: creating plus (+) strand DNA probes and minus (−) strand DNA probes to test for chromosomal alterations in DNA samples; detecting a chromosomal alteration in a DNA sample using either a plus (+) strand DNA probe or a minus (−) strand DNA probe; and compiling a genomic signature characterizing a cancer or other disease, based on the chromosomal alteration.

The computer-readable storage medium, in one embodiment, may further comprise instructions for detecting a chromosomal alteration in a DNA sample via plus (+) strand DNA probes and minus (−) strand DNA probes hybridized to a comparative genomic hybridization (CGH) array, which can include, for example, a planar array, a particle array (e.g., bead chip) or the like.

In another embodiment, the computer-readable storage medium may further comprise instructions for detecting a chromosomal translocation using a plus (+) strand DNA probe or detecting a chromosomal translocation using a minus (−) strand DNA probe; and compiling a genomic signature characterizing a cancer or other disease based on the chromosomal translocation.

In another embodiment, the computer-readable storage medium may further comprise instructions for detecting a copy number variation using a plus (+) strand DNA probe or a minus (−) strand DNA probe; and compiling a genomic signature characterizing a cancer or other disease based on the copy number variation.

In another embodiment, the computer-readable storage medium may further comprise instructions for detecting a translocation partner gene using a plus (+) strand DNA probe or a minus (−) strand DNA probe; and compiling a genomic signature characterizing a cancer or other disease based on the translocation partner gene.

In another embodiment, the computer-readable storage medium may further comprise instructions for compiling a genomic signature based on two or more chromosomal alterations that occur together; and wherein the two or more chromosomal alterations are from the group of chromosomal alterations consisting of chromosomal translocations, partner genes associated with the one or more chromosomal translocations, and/or copy number variations.

In another embodiment, the computer-readable storage medium may further comprise instructions for cataloguing the genomic signatures of a plurality of cancers, cancer conditions, or diseases into a genomic signature library.

In yet another embodiment, the computer-readable storage medium may further comprise instructions for characterizing a cancer, cancer condition, or disease by comparing a detected chromosomal translocation, a translocation gene partner, and/or DNA copy number variations with genomic signatures in the genomic signature library.

According to another aspect of the present invention, there is provided a machine-readable storage medium tangibly containing machine-executable instructions, which when executed by the machine, cause the machine to perform a process, including: detecting a balanced chromosomal translocation using either the plus (+) strand or the minus (−) strand DNA hybridization targets on a (+/−) stranded comparative genomic hybridization (CGH) array; detecting a translocation partner gene represented on the array; detecting relevant DNA copy number variations, when present, using DNA hybridization targets on the array; and associating a known cancer or disease with the genomic signature comprising the particular balanced translocation, the associated translocation partner gene, and relevant DNA copy number variations.

In one embodiment, for example, the machine-readable storage medium may further comprise instructions for: receiving a patient DNA sample; subjecting the patent DNA sample to a (+/−) stranded CGH test on a (+/−) stranded CGH array, including: detecting a particular balanced chromosomal translocation using either the plus (+) strand or the minus (−) strand DNA hybridization targets on a (+/−) stranded comparative genomic hybridization (CGH) array; detecting a translocation partner gene, if any, represented on the array; detecting relevant DNA copy number variations, when present, using DNA hybridization targets on the array; and characterizing a cancer, cancer condition, or disease by comparing the particular balanced chromosomal translocation, the translocation gene partner, and the relevant DNA copy number variations with genomic signatures in the genomic signature library.

For the detection of genetic rearrangements, such as translocations, any method that results in the linear amplification of a DNA that spans a potential site of translocation may be used. Examples of linear amplification methods that may be used in the practice of the invention include PCR amplification using a single primer. See, e.g., Liu, C. L., S. L. Schreiber, et al, BMC Genomics, 4: Art. No. 19, May 9, 2003. An exemplary set of conditions for linear amplification include reactions in a 50 μl volume containing 1 pg genomic DNA, 200 mM dNTPs, and 150 nM linear amplification primer. The amplification can be performed using the Advantage 2 PCR Enzyme System (Clontech) as follows: denaturation at 95° C. for 5 min followed by 12 cycles of (95° C./15 sec, 60° C./15 sec, and 68° C./6 min).

Probes may be labeled during the course of linear amplification or after amplification has occurred. In certain exemplary embodiments, labels are incorporated in a separate step after the linear amplification by oligonucleotide (random hexamers) mediated primer extension with a DNA polymerase. With this protocol, both the original genomic DNA samples and the linear amplification products will give rise to labeled probes that generate signals. After hybridization, the resulting data will yield information on both chromosomal aberrations from differential genomic DNA signals as seen with normal aCGH, but also reveal chromosomal rearrangements coming from differential signals arising from the linear amplification products. If labels are incorporated simply in the linear amplification products, as would happen if the labeled dNTPs were included in the linear amplification step, then only translocations would be revealed and not chromosomal abnormalities like amplifications and deletions. Useful labels include, e.g., fluorescent dyes (e.g., Cy5, Cy3, FITC, rhodamine, lanthamide phosphors, Texas red), ³²P, ³⁵S, ³H, ¹⁴C, ¹²⁵1, ¹³¹I, electron-dense reagents (e.g., gold), enzymes, e.g., as commonly used in an ELISA (e.g., horseradish peroxidase, beta-galactosidase, luciferase, alkaline phosphatase), colorimetric labels (e.g., colloidal gold), magnetic labels (e.g., Dynabeads), biotin, dioxigenin, or haptens and proteins for which antisera or monoclonal antibodies are available. The label can be directly incorporated into the nucleic acid to be detected, or it can be attached to a probe (e.g., an oligonucleotide) or antibody that hybridizes or binds to the nucleic acid to be detected. The detectable label can be incorporated into, associated with or conjugated to a nucleic acid. The association between the nucleic acid and the detectable label can be covalent or non-covalent. Label can be attached by spacer arms of various lengths to reduce potential steric hindrance or impact on other useful or desired properties.

Any known arrays and/or methods of making and using arrays can be used in the practice of the present invention. These may include, for example, those described in U.S. Pat. Nos. 6,277,628; 6,277,489; 6,261 ,776; 6,258,606; 6,054,270; 6,048,695; 6,045,996; 6,022,963; 6,013,440; 5,965,452; 5,959,098; 5,856,174; 5,830,645; 5,770,456; 5,632,957; 5,556,752; 5,143,854; 5,807,522; 5,800,992; 5,744,305; 5,700,637; 5,556,752; 5,434,049; see also, e.g., WO 99/51773; WO 99/09217; WO 97/46313; WO 96/17958; see also, e.g., Johnston, Curr. Biol. 8:R171-R174, 1998; Schummer, Biotechniques 23:1087-1092, 1997; Kern, Biotechniques 23:120-124, 1997; Solinas-Toldo, Genes, Chromosomes & Cancer 20:399-407, 1997; Bowtell, Nature Genetics Supp. 21:25-32, 1999. See also published U.S. patent applications Ser. Nos. 20010018642; 20010019827; 20010016322; 20010014449; 20010014448; 20010012537; 20010008765.

Arrays used according to the present invention can include, for example, planar arrays (e.g., a microarray), particle arrays (e.g., a fixed particle array, such as a bead chip) and random or three dimensional particle arrays (e.g., a population of beads in solution).

It will be understood that the target elements of an array may be on separate supports, such as a plurality of beads (e.g., a three dimensional array), or an array of target elements may be on a single solid surface, such as a glass microscope slide (e.g., a planar array). The nucleic acid sequences of the target nucleic acids in a target element are those for which comparative copy number information is desired. For example, the sequence of an element may originate from a chromosomal location known to be associated with disease, may be selected to be representative of a chromosomal region whose association with disease is to be tested, or may correspond to genes whose transcription is to be assayed.

A solid or semi-solid substrate for attachment of target sequence probes can be any of various materials such as glass; plastic, such as polypropylene, polystyrene, nylon; paper; silicon; nitrocellulose; or any other material to which a nucleic acid can be attached for use in an assay. The substrate can be in any of various forms or shapes, including planar, such as silicon chips and glass plates; and three-dimensional, such as particles, beads, microtiter plates, microtiter wells, pins, fibers and the like.

In certain embodiments, a substrate to which a target sequence is attached is encoded. Encoded substrates are distinguishable from each other based on a characteristic illustratively including an optical property such as color, reflective index and/or an imprinted or otherwise optically detectable pattern. For example, the substrates can be encoded using optical, chemical, physical, or electronic tags.

In a specific embodiment, a solid substrate to which a target sequence is attached is a particle, such as a polymeric bead.

Particles to which a target is attached can be any solid or semi-solid particles which are stable and insoluble in use, such as under hybridization and label detection conditions. The particles can be of any shape, such as cylindrical, spherical, and so forth; size, such as microparticles and nanoparticles; composition; and have various physiochemical characteristics. The particle size or composition can be chosen so that the particle can be separated from fluid, e.g., on a filter with a particular pore size or by some other physical property, e.g., a magnetic property.

Exemplary microparticles, such as microbeads, typically have a diameter of less than one millimeter, for example, a size ranging from about 0.1 to about 1,000 micrometers in diameter, inclusive, such as about 3-25 microns in diameter, inclusive, or about 5-10 microns in diameter, inclusive. Nanoparticles, such as nanobeads used can have a diameter from about 1 nanometer (nm) to about 100,000 nm in diameter, inclusive, for example, a size ranging from about 10-1,000 nm, inclusive, or for example, a size ranging from 200-500 nm, inclusive. In certain embodiments, particles used are beads, particularly microbeads and nanobeads.

Particles are illustratively organic or inorganic particles, such as glass or metal and can be particles of a synthetic or naturally occurring polymer, such as polystyrene, polycarbonate, silicon, nylon, cellulose, agarose, dextran, and polyacrylamide. Particles are latex beads in particular embodiments.

Exemplary particles may include functional groups for attaching target sequences or other molecules, in particular embodiments. For example, particles can include carboxyl, amine, amino, carboxylate, halide, ester, alcohol, carbamide, aldehyde, chloromethyl, sulfur oxide, nitrogen oxide, epoxy and/or tosyl functional groups. Functional groups of particles, modification thereof and binding of a chemical moiety, such as a nucleic acid, thereto are known in the art, for example as described in Fitch, R. M., Polymer Colloids: A Comprehensive Introduction, Academic Press, 1997. U.S. Pat. No. 6,048,695 describes an exemplary method for attaching nucleic acid probes to a substrate, such as particles. In a further particular example, 1-Ethyl-3-[3-dimethylaminopropyl]carbodiimide hydrochloride, EDC or EDAC chemistry, can be used to attach nucleic acid probes to particles.

Particles to which a target sequence is attached are, in certain embodiments, encoded particles. Encoded particles are distinguishable from each other based on a characteristic illustratively including an optical property such as color, reflective index and/or an imprinted or otherwise optically detectable pattern. For example, the particles can be encoded using optical, chemical, physical, or electronic tags. Encoded particles can contain or be attached to, one or more fluorophores which are distinguishable, for instance, by excitation and/or emission wavelength, emission intensity, excited state lifetime or a combination of these or other optical characteristics. Optical bar codes can be used to encode particles. The code can be embedded within the interior of the particle, or otherwise attached to the particle in a manner that is stable through hybridization and analysis.

In particular embodiments, the code is embedded, for example, within the interior of the particle, or otherwise attached to the particle in a manner that is stable through hybridization and analysis. The code can be provided by any detectable means, such as by holographic encoding, by a fluorescence property, color, shape, size, light emission, quantum dot emission and the like to identify particle and thus the target sequence immobilized thereto. In some embodiments, the code is other than one provided by a nucleic acid.

One exemplary encoded particle platform utilizes mixtures of fluorescent dyes impregnated into polymer particles as the means to identify each member of a particle set to which a specific target sequence has been immobilized. Another exemplary platform uses holographic barcodes to identify cylindrical glass particles. For example, Chandler et al. (U.S. Pat. No. 5,981,180) describes a particle-based system in which different particle types are encoded by mixtures of various proportions of two or more fluorescent dyes impregnated into polymer particles. Soini (U.S. Pat. No. 5,028,545) describes a particle-based multiplexed assay system that employs time-resolved fluorescence for particle identification. Fulwyler (U.S. Pat. No. 4,499,052) describes an exemplary method for using particles distinguished by color and/or size. U.S. Patent Application Publications 20040179267, 20040132205, 20040130786, 20040130761, 20040126875, 20040125424, and 20040075907 describe exemplary particles encoded by holographic barcodes. U.S. Pat. No. 6,916,661 describes polymeric microparticles that are associated with nanoparticles that have dyes that provide a code for the particles.

Other types of encoded particle assay platforms may also be used, such as the VeraCode beads and BeadXpress system (Illumina Inc., San Diego Calif.), xMAP 3D (Luminex) and the like. Magnetic Luminex beads can be used which allow wash steps to be performed with plate magnets and pipetting rather than with filter plates and a vacuum manifold. Each of these platforms are typically provided as carboxyl beads but may also be configured to include a different coupling chemistry, such as amino-silane.

Particles are typically evaluated individually to detect encoding. For example, the particles can be passed through a flow cytometer. Exemplary flow cytometers include the Coulter Elite-ESP flow cytometer, or FACScan.™ flow cytometer available from Beckman Coulter, Inc. (Fullerton Calif.) and the MOFLO.™ flow cytometer available from Cytomation, Inc., Fort Collins, Colo. In addition to flow cytometry, a centrifuge may be used as the instrument to separate and classify the particles. A suitable system is that described in U.S. Pat. No. 5,926,387. In addition to flow cytometry and centrifugation, a free-flow electrophoresis apparatus may be used as the instrument to separate and classify the particles. A suitable system is that described in U.S. Pat. No. 4,310,408. The particles may also be placed on a surface and scanned or imaged.

The resolution of array-based CGH is primarily dependent upon the number, size and map positions of the nucleic acid elements within the array, which are capable of spanning the entire genome. In one embodiment of the present invention, oligonucleotide nucleic acid elements are used to form microarrays at tiling density. See, e.g., Mockler, T. C. and J. R. Ecker, Genomics 85: 1 (2005); Bertone, P., M. Gerstein, et al, Chromosome Research, 13: 259 (2005).

Any of a number of previously described methods for carrying out comparative genomic hybridization may be used in the practice of the present invention, such as those described in U.S. Pat. Nos. 6,197,501; 6,159,685; 5,976,790; 5,965,362; 5,856,097; 5,830,645; 5,721,098; 5,665,549; 5,635,351; Diago, Am. J. Pathol. 158:1623-1631, 2001; Theillet, Bull. Cancer 88:261-268, 2001; Werner, Pharmacogenomics 2:25-36, 2001; Jain, Pharmacogenomics 1:289-307, 2000, the contents of which are incorporated herein by reference.

In some cases, prior to the hybridization of a specific probe of interest, it is desirable to block repetitive sequences. A number of methods for removing and/or blocking hybridization to repetitive sequences are known {see, e.g., WO 93/18186). As an example, it may be desirable to block hybridization to highly repeated sequences such as Alu sequences. One method to accomplish this exploits the fact that hybridization rate of complementary sequences increases as their concentration increases. Thus, repetitive sequences, which are generally present at high concentration, will become double stranded more rapidly than others following denaturation and incubation under hybridization conditions. The double stranded nucleic acids are then removed and the remainder used in hybridizations. Methods of separating single from double stranded sequences include using hydroxyapatite or immobilized complementary nucleic acids attached to a solid support, and the like.

Alternatively, the partially hybridized mixture can be used and the double stranded sequences will be unable to hybridize to the target.

Also, unlabeled sequences which are complementary to the sequences sought to be blocked can be added to the hybridization mixture. This method can be used to inhibit hybridization of repetitive sequences as well as other sequences. For example, Cot-1 DNA can be used to selectively inhibit hybridization of repetitive sequences in a sample. To prepare Cot-1 DNA, DNA is extracted, sheared, denatured and renatured. Because highly repetitive sequences reanneal more quickly, the resulting hybrids are highly enriched for these sequences. The remaining single stranded DNA (i.e., single copy sequences) is digested with SI nuclease and the double stranded Cot-1 DNA is purified and used to block hybridization of repetitive sequences in a sample. Although Cot-1 DNA can be prepared as described above, it is also commercially available (BRL).

Hybridization conditions for nucleic acids in the methods of the present invention are well known in the art. Hybridization conditions may be high, moderate or low stringency conditions. Ideally, nucleic acids will hybridize only to complementary nucleic acids and will not hybridize to other non-complementary nucleic acids in the sample. The hybridization conditions can be varied to alter the degree of stringency in the hybridization and reduce background signals as is known in the art. For example, if the hybridization conditions are high stringency conditions, a nucleic acid will bind only to nucleic acid target sequences with a very high degree of complementarity. Low stringency hybridization conditions will allow for hybridization of sequences with some degree of sequence divergence. The hybridization conditions will vary depending on the biological sample, and the type and sequence of nucleic acids. One skilled in the art will know how to optimize the hybridization conditions to practice the methods of the present invention.

An exemplary hybridization conditions is as follows. High stringency generally refers to conditions that permit hybridization of only those nucleic acid sequences that form stable hybrids in 0.018M NaCl at 65° C. High stringency conditions can be provided, for example, by hybridization in 50% formamide, 5×Denhardt's solution, 5×SSC (saline sodium citrate) 0.2% SDS (sodium dodecyl sulphate) at 42° C., followed by washing in 0.1×SSC, and 0.1% SDS at 65° C. Moderate stringency refers to conditions equivalent to hybridization in 50% formamide, 5×Denhardt's solution, 5×SSC, 0.2% SDS at 42° C., followed by washing in 0.2×SSC, 0.2% SDS, at 65° C. Low stringency refers to conditions equivalent to hybridization in 10% formamide, 5×Denhardt's solution, 6×SSC, 0.2% SDS, followed by washing in 1×SSC, 0.2% SDS, at 50° C.

The identification of translocation partners of known genetic loci and the determination of translocation breakpoints is based on a determination of the pattern and intensity of hybridization of labeled probes to one or more nucleic acid elements of the array. Typically, the position of a hybridization signal on an array, the hybridization signal intensity, and the ratio of intensities, produced by detectable labels associated with a sample or test probe and a reference probe is determined. The determination of an element that hybridizes to the sample or test probe, but not to the reference probe, identifies the sequence contained within that element as a translocation partner of the known genetic locus. Identical hybridization patterns between the test probe and the reference probe indicate that the tested sample does not contain a translocation at the known genetic locus. When tiling density arrays are used, the translocation breakpoints can be determined by ascertaining where in a series of array elements representing contiguous genomic segments, hybridization commences or ends. Thus, in the case of a balanced translocation, hybridization will begin at a particular DNA sequence within a gene distinct from the known genomic locus. The sequence embodied by the first element in a contiguous sequence of the distinct gene identifies that sequence as representing the breakpoint within the second gene. Conversely, with respect to the known genomic locus, the element within a contiguous sequence where hybridization ends marks that element as representing the translocation breakpoint within the known genomic locus.

Moreover, typically, the greater the ratio of the signal intensities on a target nucleic acid segment, the greater the copy number ratio of sequences in the two samples that bind to that element. Thus comparison of the signal intensity ratios among target nucleic acid segments permits comparison of copy number ratios of different sequences in the genomic nucleic acids of the two samples.

In general, any apparatus or method that can be used to detect measurable labels associated with nucleic acids that bind to an array-immobilized nucleic acid segment may be used in the practice of the invention. Devices and methods for the detection of multiple fluorophores are well known in the art, see, e.g., U.S. Pat. Nos. 5,539,517; 6,049,380; 6,054,279; 6,055,325; and 6,294,331. Any known device or method, or variation thereof, can be used or adapted to practice the methods of the invention, including array reading or “scanning” devices, such as scanning and analyzing multicolor fluorescence images; see, e.g., U.S. Pat. Nos. 6,294,331; 6,261,776; 6,252,664; 6,191,425; 6,143,495; 6,140,044; 6,066,459; 5,943,129; 5,922,617; 5,880,473; 5,846,708; 5,790,727; and, the patents cited in the discussion of arrays, herein. See also published U.S. Patent Application Ser. Nos. 20010018514; 20010007747; and published international patent applications Nos. WO0146467 A; WO9960163 A; WO0009650 A; WO0026412 A; WO0042222 A; WO0047600 A; and WOOIOI 144 A.

The present invention also provides kits to facilitate and/or standardize the methods provided herein. Materials and reagents for executing the various methods of the invention can be provided in kits to facilitate these methods. As used herein, the term “kit” refers to a combination of articles that facilitate a process, assay, analysis, diagnosis, prognosis, or manipulation.

In one embodiment, the kits provided by the present invention may comprise one or a plurality of nucleic acid primers for the linear amplification of a genomic locus implicated in balanced translocation. In certain embodiments, the kits may comprise a primer mix for the multiplex linear amplification of multiple genomic loci. In other embodiments, the kits of the invention may comprise an array for use in (+/−) analysis of balanced chromosomal translocations as described herein. In certain embodiments, the present invention provides kits useful for the diagnosis, or prognosis of a disease characterized by a balanced translocation.

In a particular embodiment, the present invention provides a kit comprising a high density tiling array for the detection of a balanced translocation associated with a disease, such as cancer. A kit of the invention may further comprise a primer mix for the multiplex linear amplification of genomic loci involved in balanced translocations associated with a disease, such as cancer.

In a specific embodiment, a multiplex (+/−) CGH array of the invention combines multiple varieties of high resolution and comprehensive diagnostics on a single array. The multiplex (+/−) stranded array CGH platform can detect known conditions, suspected conditions, and in some instances, conditions yet to be discovered.

The illustrative (+/−) stranded array CGH techniques described herein present several advantages. After labeling and verifying equilibration of plus (+) and minus (−) DNA species using illustrative quality control techniques, the occurrence of a balanced translocation and the breakpoint locations of the translocated chromosomes may be detected via CGH on a multiplex (+/−) stranded array by DNA probes of one polarity, as introduced above. Translocation partners and DNA copy number deletions and duplications associated with the translocation region are detected by corresponding DNA probes of the complementary polarity. The combined information obtained by detecting the translocations and rearrangements of a genomic locus using both plus (+) and minus (−) strands enables a practitioner, the facility director, or a computer technique to profile comprehensive signatures for many cancers and other diseases.

### Non-CGH Applications

It will be understood, in light of the present disclosure, that any of a number of (+/−) stranded non-CGH arrays and/or methodologies can also be employed in accordance with the present invention to detect chromosomal rearrangements, such as balanced translocations.

In one embodiment, for example, a method amplifies selected chromosomal regions of a patient's DNA sample with primers that target DNA sequences representative of the regions. The target DNA sequences may span breakpoints of balanced translocations, when present, and into a translocated partner gene. Chromosomal regions may be selected for amplification, for example, based on the likelihood that balanced transactions diagnostic of diseases occur there. The patient DNA sample is assayed on a non-CGH array and the results compared with a genomic database to determine breakpoints of a balanced translocation indicative of disease, when present.

In one exemplary embodiment, the method provides comprehensive or substantially complete coverage of chromosomal regions comprising one or more of the genes selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB. In a more specific embodiment, the method provides comprehensive or substantially complete coverage of chromosomal regions comprising at least 2, at least 3, at least 4, at least 5, at least 10, at least 15, or all of the genes selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB. In a more specific embodiment, exemplary primers in this respect are set forth in Tables 1 and 2. In addition, other disease-associated genes that may be targeted using the methods herein can be found in Table 3.

In other embodiments, the primers are selected to generate plus (+) strand DNA targets and minus (−) strand DNA targets for each of the chromosomal regions of diagnostic significance. A (+/−) stranded non-CGH array, e.g., a genome-wide SNP array with complementary plus (+) strand and minus (−) strand probes included, probes the plus (+) and minus (−) strand targets and the system then compares assay results with a database of plus (+) and minus (−) strand genomic knowledge to identify balanced translocations and partner genes in the patient DNA sample.

As discussed hereinabove, certain methods of the invention comprise detecting balanced chromosomal translocations using aCGH platforms. The aCGH platforms compare a patient's DNA to reference DNA by comparing presence or absence of DNA segments in a patient sample through co-hybridization with reference DNA. Described below, in contrast, are systems and methods for detecting a comprehensive set of balanced chromosomal translocations using non-CGH platforms. The balanced chromosomal translocations thus detected typically have diagnostic significance for identifying cancers and other diseases.

It is illustrative to contrast assay platforms that determine the make-up of the patient's DNA. Array-CHG platforms label patient DNA with a first colored fluorescent dye and the reference or control DNA sample with a different, second colored fluorescent dye and then co-hybridize these two samples to probes anchored on an array. Each probe on the array is a sequence-specific oligonucleotide (“oligo”) carefully selected to detect the presence of a particular genomic locus or region of diagnostic significance. The corresponding patient and control instances of the genomic locus, when both present, compete or co-hybridize to the probe, which has a complementary base sequence to the targets. When the patient DNA sequence for a given locus matches the control DNA sequence, the dye colors are present at that probe or “array feature” in equal concentration, as observed by fluorescence microscopy. When the target patient DNA has an aberration over the target control DNA at the particular genomic locus, then the above equal-concentration color norm at that array probe is altered: when the patient DNA has a copy number gain, the patient's dye color predominates at array probes that test for that genomic locus; and when the patient DNA has a copy number loss, the control dye color predominates at array probes that test for that genomic locus.

Bead-based and other platforms (or arrays) for cytogenetic studies that are not CGH-based, may not use the same comparative scheme as aCGH. Array-CGH relies on co-hybridization with a control DNA that serves as a baseline reference of normality, that is, which has genomic control DNA present as a reference against which alterations in patient DNA are observable by comparison. Instead, micro-beads (e.g., silica; polystyrene) are constituted of different bead populations. Each bead population is differentiated by surface-bound oligos that probe for a specific target DNA sequence that comprises a genomic locus or chromosomal region of interest. In contrast to CGH, an assay of the DNA sequences in the patient's chromosomes is compared with a library of past results or with genomic databases that serve as the reference or control representing the genetic norm.

Arrays used according to the present invention can include, for example, planar arrays (e.g., a microarray), particle arrays (e.g., a fixed particle array, such as a bead chip) and random or three dimensional particle arrays (e.g., a population of beads in solution).

An array or bead-based assay employed in the non-CGH methods herein can comprise essentially any array or bead system, including those described herein and/or those known and available in the art. In a specific embodiment, for example, the solid substrate (e.g., beads or other particles) to which a target sequence is attached comprises encoded particles, as discussed elsewhere herein, which are distinguishable from each other based on a characteristic illustratively including an optical property such as color, reflective index and/or an imprinted or otherwise optically detectable pattern.

For some bead-based or other non-CGH platforms, the assay or survey of the patient's DNA can be genome-wide. For example, allele specific oligos (ASOs) may be used on the bead-based platform to map SNPs in the patient's genome. In addition, SNP arrays provide a useful tool to study the whole genome. SNP maps and high density SNP arrays enable SNPs to be used as indicators for understanding complex diseases. Whole-genome genetic linkage analysis via SNP detection shows significant linkage for many cancer and non-cancer diseases. SNP arrays can also generate a virtual karyotype by determining the copy number of each SNP on an array and aligning the SNPs in chromosomal order.

Further, SNP arrays can survey Loss Of Heterozygosity (LOH), introduced above. LOH is an allelic imbalance that occurs when an allele is lost or when the copy number of one allele increases relative to the other. In contrast to conventional aCGH arrays, SNP arrays can also detect copy number neutral LOH that results from uniparental disomy (UPD), when one allele or entire chromosome from one parent is missing, causing reduplication of the other parental allele. A high density SNP array detects LOH and can identify patterns of allelic imbalance with prognostic and diagnostic advantages. For example, LOH is a ubiquitous feature of many human cancers. Tumors and hematologic malignancies (e.g., ALL, MDS, CML) possess a high rate of LOH due to genomic deletions, UPD, and genomic gains.

Thus, exemplary systems and methods described herein may be used to detect a comprehensive set of balanced chromosomal translocations and partner genes using non-CGH platforms, such as wide-genome SNP array platforms. The combination of an SNP array with an ability to identify a comprehensive set of balanced translocations provides a powerful tool for diagnosing and predicting cancers, and also other diseases such as pre- and post-natal genetic aberrations.

In another embodiment, an illustrative non-CGH system combines plus (+) strand and minus (−) strand technology for detecting balanced chromosomal translocations on a platform with wide-genome SNP array technology. An exemplary array described herein may include allele specific oligos for mapping SNPs while also including plus (+) strand and minus (−) strand oligos representing segments of chromosomal regions of diagnostic significance for detecting balanced chromosomal translocations relevant to cancer and other diseases. Thus, an exemplary array for detection of balanced translocations on a non-CGH platform may (or may not) include discrete plus (+) strand and minus (−) strand DNA (e.g., oligo) probes, complementary to each other but separable on the array or platform.

Patient and control DNA samples may be prepared, for example, by linear amplification, using a comprehensive set of primers that creates both plus (+) strand and reciprocal minus (−) strand representations of selected regions on selected chromosomes on which breakpoints relevant to cancer (or other disease) may occur. The exemplary array may also have probes that provide comprehensive coverage of gains and losses in cancer-causing genes as well as the allele specific oligos for mapping SNPs for high resolution SNP coverage of the complete genome.

Therefore, in accordance with a further aspect of the present invention, there is provided a method for detecting chromosomal abnormalities, comprising: selecting chromosomal regions of the human genome in which balanced translocations occur that are diagnostic of a disease; amplifying the chromosomal regions from a patient DNA sample; assaying the patient DNA sample including the amplified chromosomal regions on a non-CGH platform; and comparing assay results with a genomic database to determine breakpoints of a balanced translocation indicative of the disease.

In one illustrative embodiment, the step of amplifying the chromosomal regions includes performing a linear amplification using primers to construct a target DNA sequence that spans over a breakpoint of a balanced translocation and into a partner gene of the balanced translocation.

In yet another embodiment, the method may further comprise comparing assay results with a genomic database to determine a partner gene associated with the balanced translocation and/or to determine copy number changes.

In still another embodiment, the step of assaying the patient DNA sample and the amplified chromosomal regions on a non-CGH platform comprises performing a genome-wide survey for genetic aberration. In a more specific embodiment, the genome-wide survey for genetic aberration comprises mapping single nucleotide polymorphisms (SNPs).

In another specific embodiment, the step of assaying the patient DNA sample and the amplified chromosomal regions on a non-CGH platform comprises using a bead-based non-CGH array, such as an ILLUMINA HUMANCYTOSNP-12 BEADCHIP to determine a breakpoint of a balanced translocation.

In a further embodiment, the step of assaying the patient DNA sample and the amplified chromosomal regions may further comprise: digesting the patient DNA sample with restriction enzymes; annealing primers to the ends of the digested patient DNA products; amplifying the digested patient DNA products in a polymerase chain reaction (PCR) reaction; fragmenting the amplified DNA; end-labeling the fragmented DNA; and hybridizing the end-labeled DNA to an array. In a related specific embodiment, the step of hybridizing the end-labeled DNA to an array comprises hybridizing the end-labeled DNA to an AFFYMETRIX GENOME-WIDE HUMAN SNP ARRAY 6.0.

In another embodiment, the step of amplifying the chromosomal regions from a patient DNA sample comprises amplifying with a set of primers that generates plus (+) strand DNA sequences and complementary minus (−) strand DNA sequences of the same chromosomal region as targets of distinct polarity for detecting genetic aberrations using plus (+) strand DNA probes and minus (−) strand DNA probes on an array.

In yet another embodiment, the method may further comprise comparing assay results with a genomic database further includes separately comparing plus (+) strand assay results and minus (−) strand assay results with respect to at least one of detecting a balanced translocation, detecting a partner gene, or detecting a copy number change.

In a related aspect of the present invention, there is provided a system, comprising: a means for amplifying chromosomal regions of a patient DNA sample to create target DNA strands, each target DNA strand capable of representing translocated genes on either side of a breakpoint of a balanced chromosomal translocation; means for labeling amplified and unamplified components of the patient DNA sample; means for assaying the patient DNA sample by hybridizing the labeled components on a non-CGH array possessing probes to test for parts of the target DNA strands; and means for comparing assay results with a genomic database to determine the breakpoint and to determine the identities of the translocated genes.

In one embodiment, the non-CGH array comprises one of an ILLUMINA HUMANCYTOSNP-12 BEADCHIP or an AFFYMETRIX GENOME-WIDE HUMAN SNP ARRAY 6.0.

In another embodiment, the system may further comprise primers to generate plus (+) target DNA strands and (−) target DNA strands of the same chromosomal region; and a non-CGH array possessing plus (+) strand oligo probes and minus (−) strand oligo probes for providing plus (+) strand detection of balanced translocations and minus (−) strand detection of balanced translocations.

According to another related aspect, the present invention provides a computer-readable storage medium, tangibly containing computer-executable instructions, which when executed, perform a process that includes: receiving assay results from hybridization of a patient DNA sample to a non-CGH array; compiling from the assay results a DNA sequence for each of multiple chromosomal regions of diagnostic significance amplified from the patient DNA sample; comparing each DNA sequence of each chromosomal region with a database of genomic knowledge to determine a balanced translocation in the patient DNA sample.

In a related embodiment, the computer-readable storage medium may further comprise instructions for compiling a plus (+) strand DNA sequence and a minus (−) strand DNA sequence for each of the multiple chromosomal regions of diagnostic significance; and comparing each plus (+) strand and minus (−) strand DNA sequence of each chromosomal region with a database of plus (+) strand and minus (−) strand genomic knowledge to determine a balanced translocation in the patient DNA sample.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims. The following examples are provided by way of illustration only and not by way of limitation. Those of skill in the art will readily recognize a variety of noncritical parameters that could be changed or modified to yield essentially similar results.

### EXAMPLES

### Example 1

### Exemplary (+/−) CGH Method

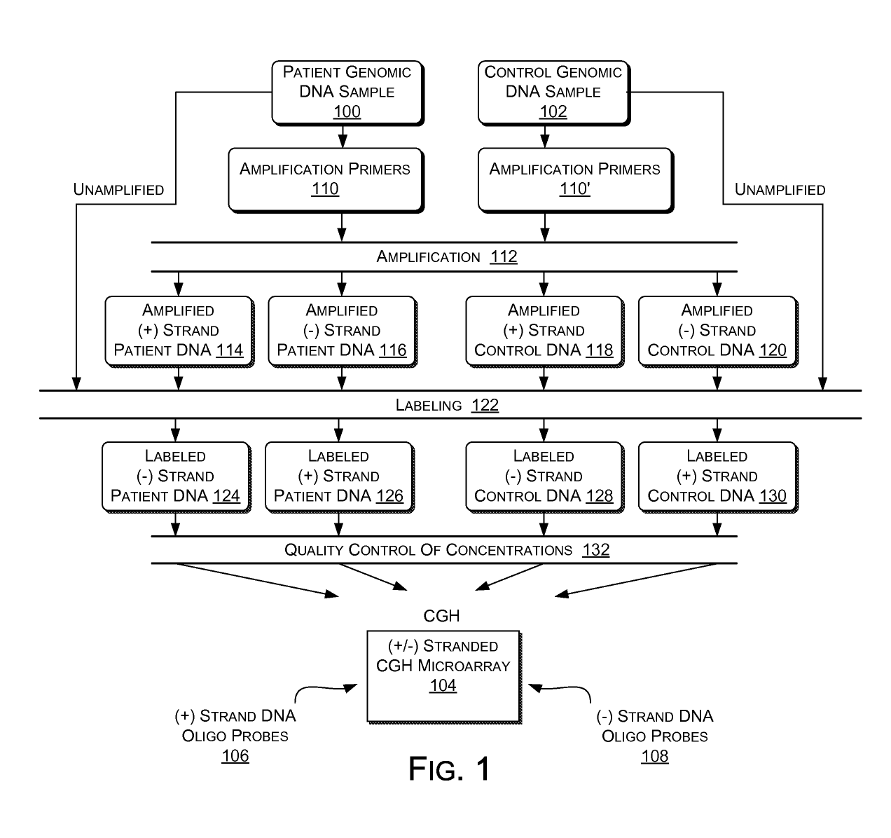

FIG. 1 shows an overview of a (+/−) stranded array CGH procedure. CGH procedures compare a patient genomic DNA sample 100 with a control genomic DNA sample 102. The samples compete for hybridization targets (oligos) arrayed, in this case, on a (+/−) stranded CGH microarray 104. The (+/−) stranded CGH microarray 104 includes plus (+) strand oligo probes 106 and minus (−) strand oligo probes 108. Amplification primers 110 and 110′ (e.g., the same primers) are added to the patient genomic DNA sample 100 and the control genomic DNA sample 102 for carefully moderated amplification 112, for example, a linear amplification, to create probes that span regions of interest, that is, regions in which a balanced translocation may occur. The primers extend selected chromosomal regions approximately 10,000 to 20,000 bases each, providing a rich mixture of plus (+) strand and minus (−) strand DNA hybridization probes representing these regions selected because of relevance to various diseases—as when a balanced translocation occurs in one or more of the regions.

The amplification 112 may be a particular type of linear amplification as described in International Patent Application PCT/US2008/083014 to Greisman (WO 2009/062166), entitled, “DNA Microarray Based Identification and Mapping of Balanced Translocation Breakpoints,” which is incorporated herein by reference in its entirety.

The linear amplification described in the Greisman reference provides one way to create probes that span translocation breakpoints and extend at least part ways into a partner gene of a translocated chromosome, thereby enabling detection of balanced translocations using array CGH. Other methods besides linear amplification 112, however, may be used to accomplish the same objective. For example, nonlinear amplifications that provide cycling across the breakpoints may be used. In fact, many methods that can create a probe that spans across a breakpoint may be employed.

The Greisman reference provides details of the linear amplification used therein to create a hybridization probe that begins on one chromosome, spans a translocation breakpoint, and continues into the DNA sequence of a translocation partner gene. The Greisman hybridization results reveal that the patient DNA probe matches the control probe up to the breakpoint in the DNA sequence, at which point the patient signal disappears at points further along the gene sequence that has been translocated. If the microarray in use is comprehensive enough, the patient signal reappears in the translocation partner gene. Hence, the Greisman reference describes a technique of using this particular linear amplification with select primers to detect translocations if they occur at specific genomic loci that are known beforehand.

As described by the Greisman reference, if a balanced translocation is present at a chromosomal region of interest, hybridization of the test probe to a microarray comprising genomic DNA sequences from reference cells will result in a signal associated with elements corresponding to the known genomic locus as well as signals associated with elements of the microarray associated with another genomic locus. The signal associated with the other genomic locus identifies that locus as being a translocation partner of the known genomic locus. In contrast, hybridization of the microarray with the reference probe will result in hybridization exclusively associated with microarray elements corresponding with the known locus, and there will be no hybridization signal associated with another genomic locus as was observed with the test probe.

According to the Greisman reference, when high density tiling microarrays are used, the breakpoints of a translocation can be ascertained by determining where hybridization commences and ends in a series of microarray elements embodying contiguous segments of genomic DNA. Thus, the cessation of hybridization at a specific point along a series of elements corresponding to the known genomic locus using the test probe, with hybridization continuing along the series using the reference probe, identifies the point at which hybridization stops as being the translocation breakpoint for the known genomic locus. Similarly, the point at which hybridization by the test probe commences in a series of elements corresponding to a locus distinct from the known genomic locus, and which is negative for hybridization by the reference probe, indicates that the first element at which hybridization occurs is the breakpoint for the translocation partner of the known genomic locus. However, this is not much help if the translocation partner transcribes off the minus (−) strand.

To render IgH translocations detectable on CGH arrays, the Greisman method applies an enzymatic version of the linear amplification to modify genomic DNA from test and reference samples prior to array hybridization, an amplification reaction that employs a single IgH joining (J_{H}) or switch (Sμ/Sα/Sε) region primer, resulting in specific amplification of any fusion partner sequences that may be inserted (via translocation or other rearrangement) downstream of the IgH primer. Using a single tiling-density oligonucleotide array representing such common IgH partner loci as MYC, BCL2 and CCNDI (cyclin DI), the Greisman CGH technique, dubbed tCGH, identifies and maps to ˜100 bp resolution an assortment of known IgH fusion breakpoints in various cell lines and primary lymphomas, including J_{H}-CCND1 breakpoints in MO2058 and Granta 519 cell lines (mantle cell lymphoma), a cytogenetically cryptic Sα-CCNDI fusion in U266 (myeloma), J_{H}-MYC and S μ-MYC breakpoints in MC 116 and Raji (Burkitt lymphoma), and J_{H}-BCL2 breakpoints in DHLI 6 (large cell lymphoma; minor cluster region) and in an archival case of follicular lymphoma (major breakpoint region). According to the Greisman reference, the Greisman method can be adapted to identify and map other balanced translocations (or more complex genomic fusions) that involve non-IgH loci, provided that one of the fusion partners is known.

The linear amplification described by the Greisman reference does not result in the exponential amplification of DNA. Relevant examples of linear amplification of DNA include the amplification of DNA by PCR methods when only a single primer is used. See, Liu, C. L., S. L. Schreiber, et al., BMC Genomics, 4: Art. No. 19, May 9, 2003. Other examples include isothermic amplification reactions such as strand displacement amplification (SDA) (Walker, et al. Nucleic Acids Res. 20(7): 1691 (1992); Walker PCR Methods Appl 3(1): 1 (1993), among others.

The reagents used in an example amplification reaction can include, e.g., oligonucleotide primers; borate, phosphate, carbonate, barbital, Tris, etc. based buffers {see, U.S. Pat. No. 5,508,178); salts such as potassium or sodium chloride; magnesium; deoxynucleotide triphosphates (dNTPs); a nucleic acid polymerase such as Taq DNA polymerase; as well as DMSO; and stabilizing agents such as gelatin, bovine serum albumin, and non-ionic detergents (e.g. Tween-20).

An exemplary set of conditions provided by the Greisman reference for an example linear amplification include reactions in a 50 μl volume containing 1 pg genomic DNA, 200 mM dNTPs, and 150 nM linear amplification primer. The amplification can be performed using the Advantage 2 PCR Enzyme System (Clontech) as follows: denaturation at 95° C. for 5 min followed by 12 cycles of (95° C./15 sec, 60° C./15 sec, and 68° C./6 min).

The Greisman reference describes only plus (+) strand CGH on plus (+) strand CGH arrays, and is limited to detecting translocations in the IgH gene and a few other genes. In the Greisman method, the extent and pattern of hybridization can reveal the location of some elementary translocation breakpoints, and can also be leveraged to identify a few elementary translocation partner genes. Although the Greisman reference describes detecting the breakpoint on both ends of the exchange, the Greisman DNA grid, however, does not actually accomplish this objective with regard to the breakpoint in the IGH gene, an important partner in translocation exchanges that are relevant to cancer. As mentioned, the Greisman techniques do not work when translocated genes transcribe off a minus (−) strand of the patient's genomic DNA. Nonetheless, the Greisman reference shows how to perform an example (linear) amplification 112 that provides an important step enabling basic detection of balanced translocations with array CGH.

In the (+/−) stranded array CGH shown in FIG. 1, a set of amplification primers 110, such as a set of forward and reverse primers (see for example, Tables 1 and 2) is used so that the amplification 112 creates different plus (+) strand and minus (−) strand hybridization probes for DNA sequences in each selected chromosomal region. In FIG. 1, this is represented as amplified plus (+) strand patient DNA 114, amplified minus (−) strand patient DNA 116, amplified plus (+) strand control DNA 118, and amplified minus (−) strand control DNA 120, in substantially equal concentrations. The original stands of the patient genomic DNA sample 100 and the control genomic DNA sample 102 remain too, unamplified. After amplification 112, the next step is labeling 122 of the amplified plus (+) and minus (−) DNA polarity species and the unamplified DNA (100 and 102). The labeling 122 may use two conventional labels, one for the amplified and unamplified patient DNA (100, 114 and 116) and one for the amplified and unamplified control DNA (102, 118 and 120). The labeling 122 generates corresponding labeled strands of the amplified DNA, each labeled strand being the reciprocal or complement of its corresponding unlabeled strand. This generates labeled minus (−) strand patient DNA 124, labeled plus (+) strand patient DNA 126, labeled minus (−) strand control DNA 128, and labeled plus (+) strand control DNA 130.

Probes may be labeled during the course of amplification 112 or after amplification has occurred. For example, labels may be incorporated in a separate step after the amplification 112 by oligonucleotide (random hexamers) mediated primer extension with a DNA polymerase. With this protocol, both the original genomic DNA samples and the linear amplification products will give rise to labeled probes that generate fluorescence signals. After hybridization, the resulting data will yield information on both chromosomal aberrations from differential genomic DNA signals as seen with normal aCGH, and also reveal chromosomal rearrangements coming from differential signals arising from the amplification products. If labels are incorporated only in the amplification products, as happens when the labeled dNTPs are included in the amplification step, then the amplification products enable only balanced translocations to be revealed and not other chromosomal abnormalities such as duplications and deletions.

Useful labels include, e.g., fluorescent dyes (e.g., Cy5, Cy3, FITC, rhodamine, lanthamide phosphors, Texas red), ³²P, ³⁵S, ³H, ¹⁴C, ¹²⁵1, ¹³¹I, electron-dense reagents (e.g., gold), enzymes, e.g., as commonly used in an ELISA (e.g., horseradish peroxidase, beta-galactosidase, luciferase, alkaline phosphatase), colorimetric labels (e.g., colloidal gold), magnetic labels (e.g., Dynabeads), biotin, dioxigenin, quantum dots, or haptens and proteins for which antisera or monoclonal antibodies are available. The label may be directly incorporated into the nucleic acid to be detected, or it can be attached to a probe (e.g., an oligonucleotide) or antibody that hybridizes or binds to the nucleic acid to be detected. The detectable label can be incorporated into, associated with or conjugated to a nucleic acid. The association between the nucleic acid and the detectable label can be covalent or non-covalent. Labels can be attached by spacer arms of various lengths to reduce potential steric hindrance or impact on other useful or desired properties.

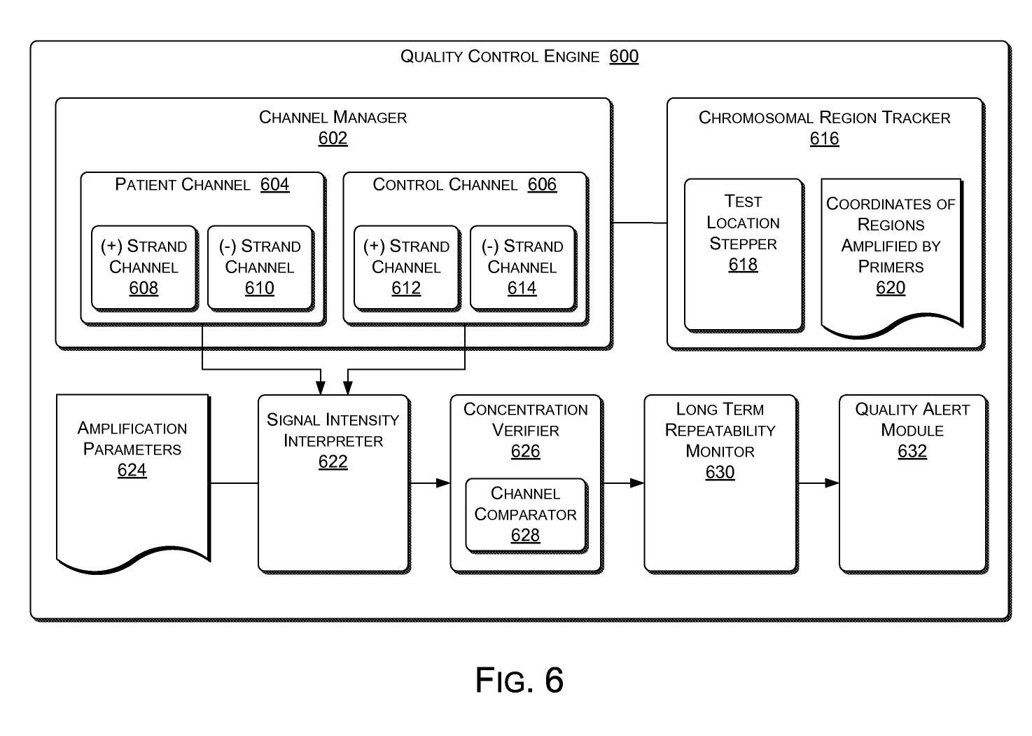

Quality control 132 can be applied to evaluate the magnitude of amplification of each labeled plus (+) strand and minus (−) strand DNA species by reading a raw fluorescence signal or by evaluating comparative probe intensities at each chromosomal region amplified by a primer. This is described in greater detail below, with respect to FIG. 6.

When the labeled and amplified plus (+) strand and minus (−) strand DNA derived from the patient genomic DNA sample 100 and the control genomic DNA sample 102 pass quality control 132, i.e., when each amplified chromosomal region has an equal (or expected) concentration within a selected tolerance, then the labeled and amplified plus (+) strand and minus (−) strand species are ready to hybridize to the (+/−) stranded CGH microarray 104.

Prior to the hybridization of a specific probe of interest it may be desirable to block repetitive sequences. A number of methods for removing and/or blocking hybridization to repetitive sequences are known (see, e.g., WO 93/18186). As an example, it may be desirable to block hybridization to highly repeated sequences such as Alu sequences. Unlabeled sequences which are complementary to the sequences sought to be blocked can be added to the hybridization mixture. This method can be used to inhibit hybridization of repetitive sequences as well as other sequences. For example, Cot-1 DNA can be used to selectively inhibit hybridization of repetitive sequences in a sample.

Tables 1 and 2 show illustrative primers that can produce plus (+) strand and minus (−) strand DNA targets representing certain chromosomal regions of diagnostic interest for detecting balanced translocations, partner genes, and other genomic rearrangements of interest in the diagnosis or study of cancers and other diseases.

### Example 2

### Exemplary (+/−) CHG Microarray

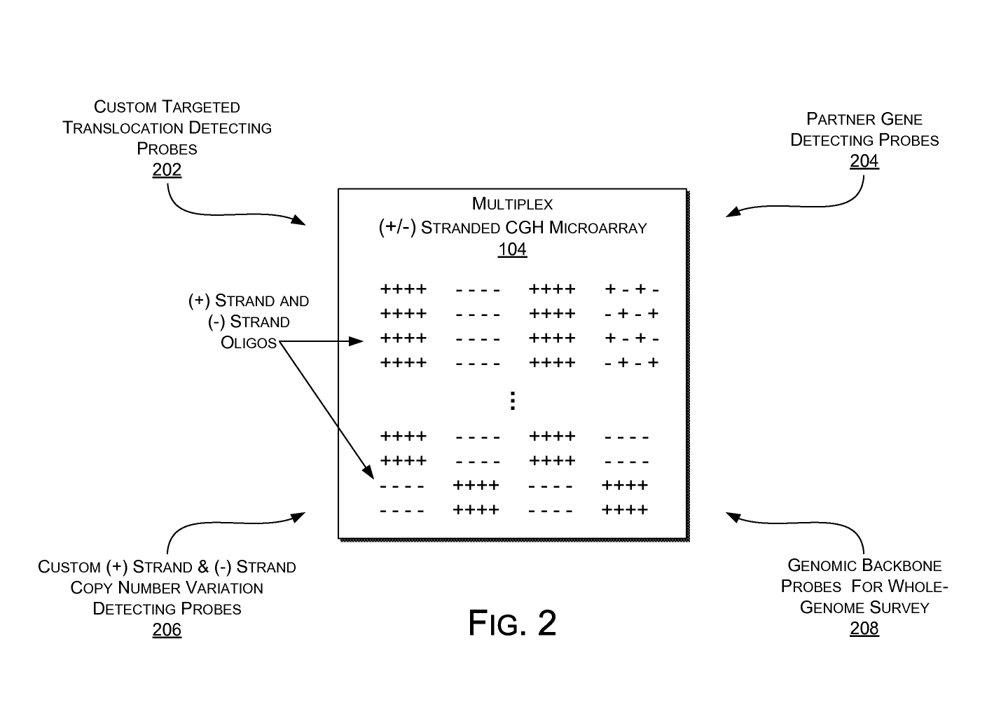

FIG. 2 shows schematically the multiplex (+/−) stranded CGH microarray 104 of FIG. 1, in greater detail. The plus (+) strand and minus (−) strand oligos constituting the hybridization targets on the array can be arranged in any suitable order or pattern. See for example, U.S. patent application Ser. No. 11/057,088 to Shaffer at al., entitled, “Methods and Apparatuses For Achieving Precision Diagnoses,” incorporated herein by reference. The (+/−) stranded CGH microarray 104 may be a tiling density DNA microarray. Each (+/−) stranded CGH microarray 104 is typically both a whole-genome array and a custom targeted array. As a whole-genome array, the (+/−) stranded CGH microarray 104 can detect DNA copy number variations that may occur across the complete genome. As a custom targeted array, the (+/−) stranded CGH microarray 104 specifically targets loci in numerous regions of diagnostic interest. The (+/−) stranded CGH microarray 104 can be designed with both uniform and mixed-density probe spacing.

An exemplary (+/−) stranded CGH microarray 104 has approximately 720,000 oligos (probes), half of these comprising plus (+) strand DNA and half comprising minus (−) strand DNA, not counting control probes: i.e., a backbone probe at every span of approximately 25 kilobases. The exemplary (+/−) stranded CGH microarray 104 is a single array that has coverage for approximately 700 genes known to be deleted or amplified in cancers, coverage for approximately 315 genes involved in balanced translocations, coverage for genes with expression changes and genes implied or suggested to be relevant to cancer. The exemplary (+/−) stranded CGH microarray 104 may also have up to approximately 72 or more microRNAs specifically targeted; only recently described as important to diagnosing cancers. By comparison, a microarray used in the Greisman reference has only approximately 15,000 probes and targets only approximately 26 genes, while an example (+/−) stranded CGH microarray 104 has approximately 720,000 probes and targets approximately 1925 genes.

In one implementation, the (+/−) stranded CGH microarray 104 includes subsets of probes. The partitioning of oligos into subsets on the array, and particularly plus (+) strand oligos 106 and minus (−) strand oligos 108, may be physical, as when oligos with a common functionality or purpose are sequestered to a limited part of the array, or the subsets may be logical, as when the oligos are physically arranged at random or according to some other scheme, yet tracked so that the scanning results can be logically recompiled.

In one implementation, the multiplex (+/−) stranded CGH microarray 104 may include plus (+) strand and minus (−) strand translocation detecting probes 202, partner gene detecting probes 204, copy number variation detecting probes 206, and a host of genomic backbone probes 208 that provide coverage of the entire genome at intervals. The (+/−) stranded CGH microarray 104 may also target microRNAs for diagnosing cancers.

Table 3 shows an example list of genes advantageously probed by a (+/−) stranded cancer-targeted microarray 104.

### Example 3

### Exemplary Hardware Environment for Implementing (+/−) CGH

Most of the steps in the example procedure shown in FIG. 1 are performed either directly or indirectly in a computing environment. That is, amplification 112, labeling 122, and quality control 132 are generally computer-controlled, computer-assisted, or computer-monitored. Scanning, analysis, display, and reporting of results in array CGH are also mediated by a computing device.

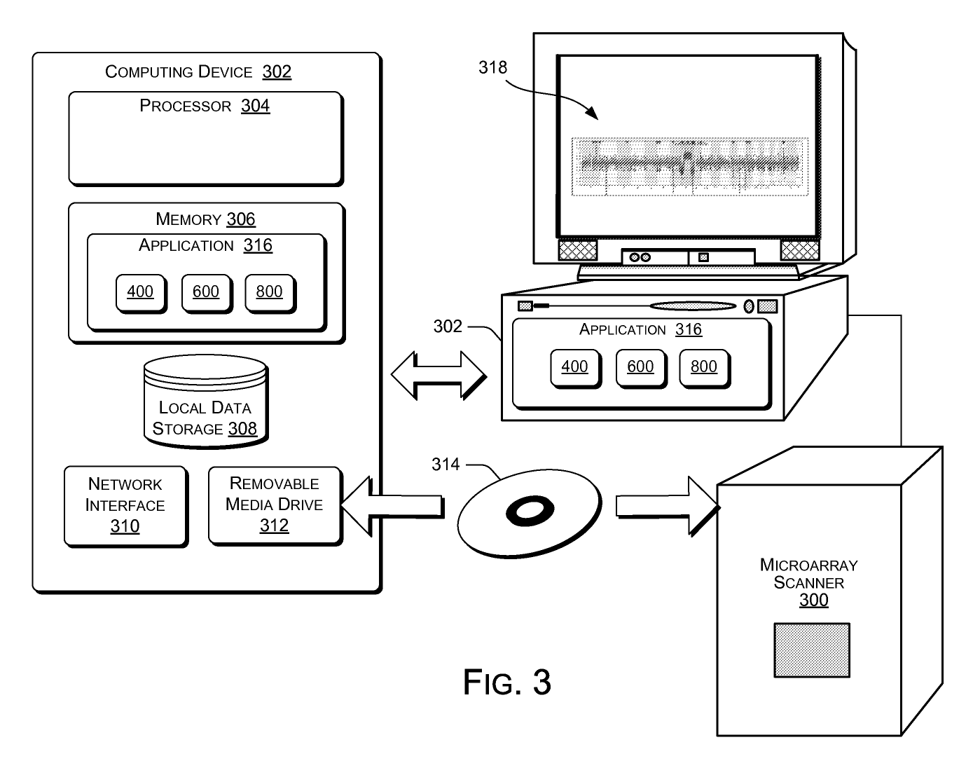

FIG. 3 shows an example computing environment and components of a (+/−) stranded array CGH system. An example hardware component, a microarray scanner 300, is representative as a placeholder in FIG. 3 of molecular diagnostics equipment in general. The microarray scanner 300 may contain a computing device and/or may be communicatively coupled with a computing device 302. The illustrated layout is relatively elementary compared to the layout of equipment in an actual clinical diagnostics laboratory, but shows some example relationships between laboratory hardware, i.e., as represented by the example microarray scanner 300, and computer hardware and software. Other possible computer-controlled equipment may include polymerase chain reaction (PCR) thermocyclers (not shown) for amplification processes 112 and microarray spotters/printers (not shown) for creating (+/−) stranded CGH microarrays 104.

The computing device 302 typically includes a processor 304, memory 306, local data storage 308, a network interface 310, and a media drive 312 for a removable storage medium 314. The removable storage medium 314 is a machine-readable storage entity that contains machine-executable instructions, which when executed by a machine, causes the machine to perform illustrative methods to be described herein. Such a removable storage medium 314 may be read directly by the microarray scanner 300, for example, when the microarray scanner 300 includes a computing device and a media drive, and/or may be read by the communicatively coupled computing device 302, which then signals the microarray scanner 300 (or other lab hardware) to function in a certain manner.

The microarray scanner 300 (or other lab hardware) may include an application 316, such as a scanner software application, either loaded as machine-executable instructions from a removable storage medium 314 or built into the hardware fabric of the machine. For example, the application 316 may be implemented as an application specific integrated circuit (ASIC). Alternatively, the coupled computing device 302 may include the application 316, e.g., loaded as instructions in memory 306. The application 316 may include modules or engines for performing programs relevant to the amplification 112 using the primers 110 or relevant to analyzing results from hybridization of the (+/−) stranded array CGH, including for example, a (+/−) stranded CGH array hybridization results analyzer (“array hybridization analyzer”) 400, a quality control engine 600, and/or an aneuploidy/mosaicism analyzer 800. The application 316 or the modules and engines 400, 600, and 800 may generate visual results displayable on a user interface 318.

### Example 4

### Exemplary Array Hybridization Analyzer

As FIG. 1 illustrates the process of making plus (+) strand and minus (−) strand DNA samples suitable for the (+/−) stranded array CGH process, the description now turns to analyzing results obtained by scanning a (+/−) stranded CGH array 104.

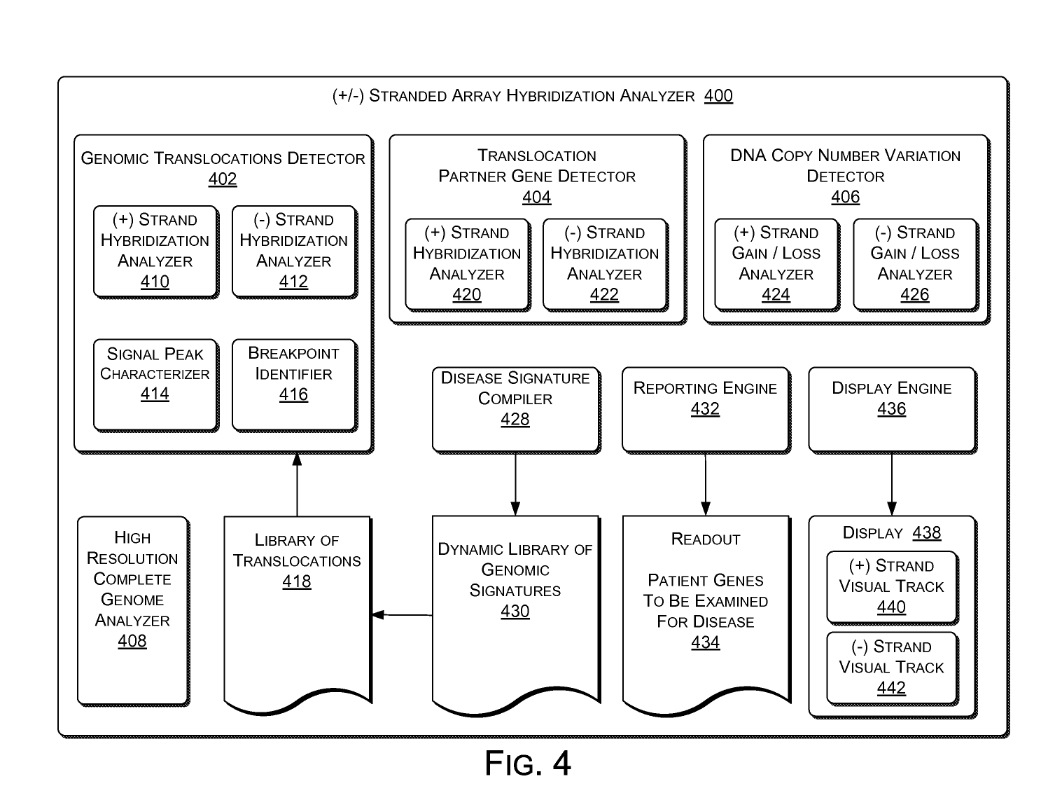

FIG. 4 shows the example array hybridization analyzer 400 introduced in FIG. 3, in greater detail. The array hybridization analyzer 400 includes multiple components useful for genotyping a wide range of chromosomal abnormalities. The illustrated implementation is only one example configuration to introduce some features and components of an engine that performs analysis of a multiplex (+/−) stranded CGH array 104. Many other arrangements and components of the array hybridization analyzer 400 are possible within the scope of the subject matter described herein. The illustrated array hybridization analyzer 400 can be implemented in hardware, or in combinations of hardware and software, and comprises logic for analyzing and processing physical test results, i.e., fluorescence signals, obtained from scanning a microarray 104.

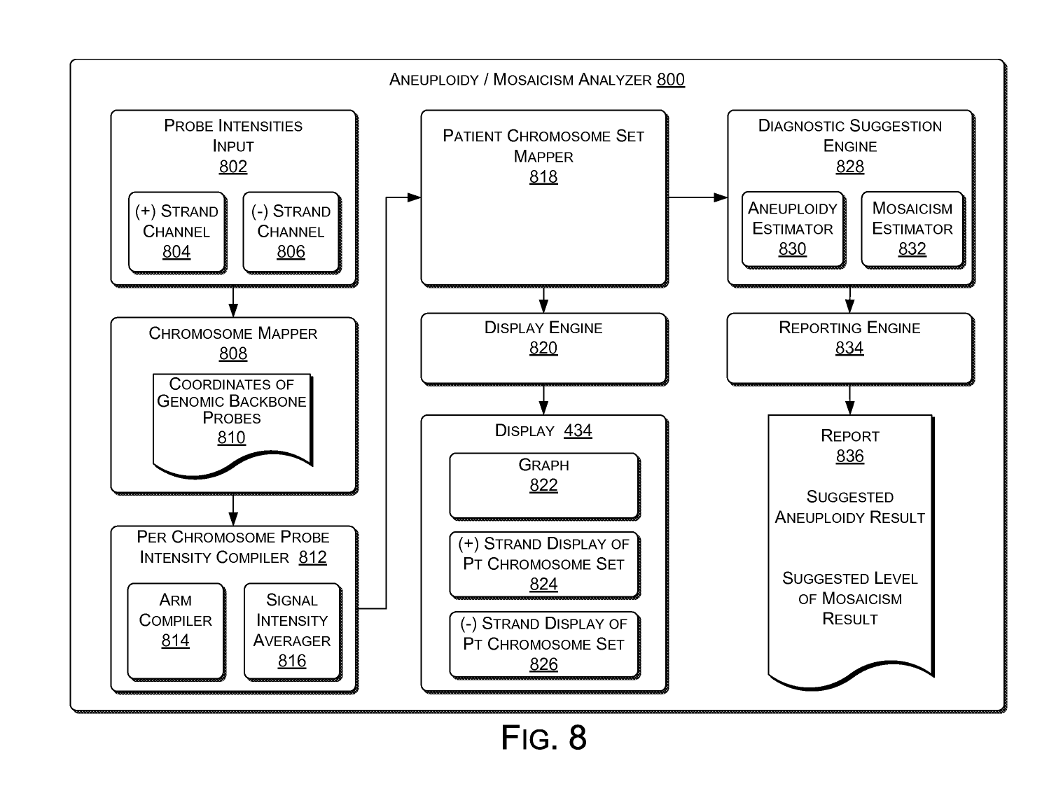

A list of components for the example illustrated array hybridization analyzer 400 follows. Four main analytic modules include a genomic translocations detector 402, a translocation partner gene detector 404, a DNA copy number variation detector 406, and a high resolution complete genome analyzer 408 that detects alterations such as copy number duplications and deletions via backbone probes spanning the entire genome. The four main analytic modules just listed can operate on hybridization results obtained from a single multiplex (+/−) stranded CGH microarray 104. Each analytic module or subcomponent has knowledge of which oligos on the (+/−) stranded CGH array 104 are dedicated to the objective of that analytic module. In other words, each analytic module is tuned to the fluorescence results of the oligos on the microarray 104 that the particular module is analyzing. Or again, the fluorescence results from scanning the microarray 104 are logically processed so that results relevant to an individual analytic module are accessible by that module. Other classes of genomic rearrangement or anomaly may deserve their own analytic modules (not shown, except for example, in FIG. 8 below). The genomic translocations detector 402 includes a plus (+) strand hybridization analyzer 410, a minus (−) strand hybridization analyzer 412, a signal peak characterizer 414, and a breakpoint identifier 416. The genomic translocations detector 402 may access a library of translocations 418 to assist identification of a given detected translocation.

The translocation partner gene detector 404 includes a plus (+) strand hybridization analyzer 420 and a minus (−) strand hybridization analyzer 422, thereby using hybridization results of either polarity to identify a translocation partner for a given translocation detected by the genomic translocations detector 402.

The DNA copy number variation detector 406 can detect copy number duplications, deletions, and so forth, i.e., gains and losses, at genomic loci of clinical interest. The DNA copy number variation detector 406 may include a plus (+) strand gain/loss analyzer 424 and a minus (−) strand gain/loss analyzer 426. These may analyze the strand that has a polarity complementary to the polarity of the strand on which a balanced transaction is detected. Thus, for example, when a balanced transaction is detected by the plus (+) strand hybridization analyzer 410 of the genomic translocations detector 402, then the minus (−) strand gain/loss analyzer 426 may detect copy number changes on the complementary minus (−) strand, e.g., of the unamplified patient DNA 100 or, the minus (−) strand gain/loss analyzer 426 may determine that the complementary minus (−) strand of the unamplified patient DNA 100 reveals normal patient DNA. A disease signature compiler 428 derives characteristic genomic rearrangements of a disease and catalogues the disease and its characteristics in a dynamic library of genomic signatures 430. This example library of genomic signatures 430 can update the library of translocations 418 accessed by the genomic translocations detector 402.

A reporting engine 432 may apply a filter or algorithm to prioritize a readout 434 or list of patient genes to be examined for disease by a practitioner. For example, the reporting engine 432 may filter out minor DNA copy number changes, or genomic rearrangements in non-diagnostic parts of the genome.

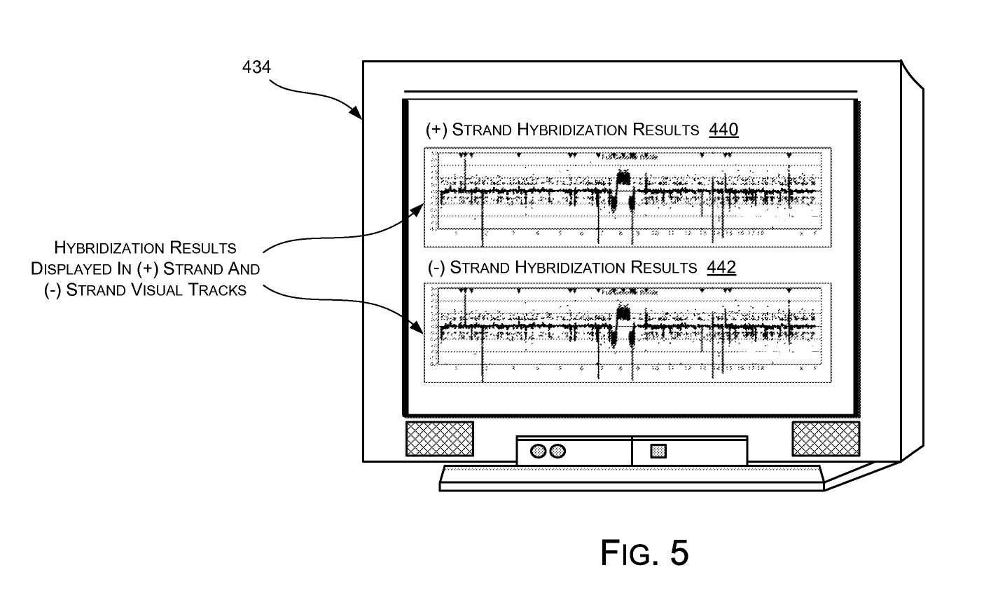

A display engine 436 controls a display 438 to present plus (+) and minus (−) strand hybridization results visualized from the standpoint of the plus (+) strand probes and the minus (−) strand probes. For example, the display may show a plus (+) strand visual track 440 and a corresponding minus (−) strand visual track 442 of hybridization results of the same region or locus. FIG. 5 shows an example display 438 presenting hybridization results from the dual viewpoint of the plus (+) strand visual track 440 and the corresponding minus (−) strand visual track 442. For example, the (+) strand visual track 440 may reveal a balanced translocation in a chromosomal region from the plus (+) strand amplified patient DNA 114, while the (−) strand visual track 442 shows copy number changes in the same region from (−) strands of the unamplified patient DNA 100.

### Example 5

### Exemplary Quality Control Engine

FIG. 6 shows the example quality control engine 600 introduced in FIG. 3, in greater detail. The illustrated implementation is only one example configuration to introduce some features and components of an engine that performs quality control during (+/−) stranded array CGH. Many other arrangements and components for a quality control engine 600 are possible within the scope of the subject matter described herein. The illustrated quality control engine 600 can be implemented in hardware, or in combinations of hardware and software, and in one implementation comprises logic for verifying the equilibration of patient and control samples after amplification 112 and for monitoring long term reliability and repeatability of amplification 112, test procedures, hardware settings, hardware performance, and control samples 102, e.g., across numerous patient tests.

The following list of components of the example illustrated quality control engine 600 is only one example list. The illustrated quality control engine 600 includes a channel manager 602 for administering input from a patient channel 604 and a control channel 606. The patient channel may be further partitioned into a plus (+) strand channel 608 and a minus (−) strand channel 610. The control channel 606 may also be partitioned into a respective plus (+) strand channel 612 and minus (−) strand channel 614. The channel manager 602 receives probe intensity input from a scanner 300 and keeps track of channels assigned to each one of the amplified species. Thus, in one implementation, the channel manager 602 tracks four species, obtained from amplifying plus (+) and minus (−) strands of patient DNA and from amplifying plus (+) and minus (−) strands of control DNA. In one illustrative quality control example, each of the four species may be hybridized to a corresponding microarray for that species and scanned. The quality control engine 600 then compares hybridization results (fluorescence intensities) between the four species to make sure concentrations are equal. In another implementation, the quality control engine 600 compares concentrations of the various plus (+) and minus (−) species spectrophotometrically, without hybridizing each species to a microarray.

In one implementation the quality control engine 600 carries out the comparison of concentrations of the four species for each region amplified by primers, which may be hundreds or even a few thousand different chromosomal regions. Therefore, in one scenario, the quality control engine 600 compares fluorescence results from hybridization of four species, e.g., from four microarrays, or from spectrophotometric analysis of the amplified samples, across the several hundred or several thousand chromosomal regions that have been amplified by primers. In another implementation, the quality control engine 600 tests only a sample of the regions that have been amplified by primers, to check for equilibration of the concentrations across the selected sample regions.

To test quality of amplification across numerous amplified regions, a chromosomal region tracker 616 includes a test location stepper 618 that uses a database of coordinates 620 of chromosomal regions that have been amplified by primers in order to test fluorescence signal intensity in each of the regions.

The channel manager 602 passes signal intensities per channel to a signal intensity interpreter 622, which may normalize signals and assign a concentration or a magnitude of amplification to the signal input received from each channel.

The quality control engine 600 stores amplification parameters 624, such as tolerances for length of amplification 112 and magnitude of amplification. The amplification parameters 624 guide the components that interpret or verify quality control data derived from analog signals and provide criteria for tripping a quality alert. The amplification parameters 624 also include standards and benchmarks for monitoring long-term consistency of operations and repeatable, reliable test output from patient to patient.

In one implementation, the signal intensity interpreter 622 passes per-channel signal magnitude information to a concentration verifier 626, which includes a channel comparator 628. The probe intensities for each channel are compared with each other. The concentration verifier 626 assures that amplification of the patient genomic DNA sample 100 and the control genomic DNA sample 102 have resulted in equal concentrations of the (+/−) species they contain, within predetermined tolerances.

A long term repeatability monitor 630 may examine the probe intensities of each region amplified by a primer, as designated by the test location stepper 618, to make sure that probe intensities for each region remain consistent over numerous patient tests. In one implementation, the test location stepper 618 may designate only a sampling of regions amplified by primers. In one implementation, the long term repeatability monitor 630 compares current quality control results against a trend of such results over the past “n” tests. In another implementation, the long term repeatability monitor 630 compares the current quality control results against the standards and benchmarks for monitoring long-term consistency, as stored in the recorded amplification parameters 624. A quality alert module 632 sends out information detailing quality control test results. When a quality control test result is out of tolerance, the quality alert module 632 notifies the operator and writes a report describing the abnormality.

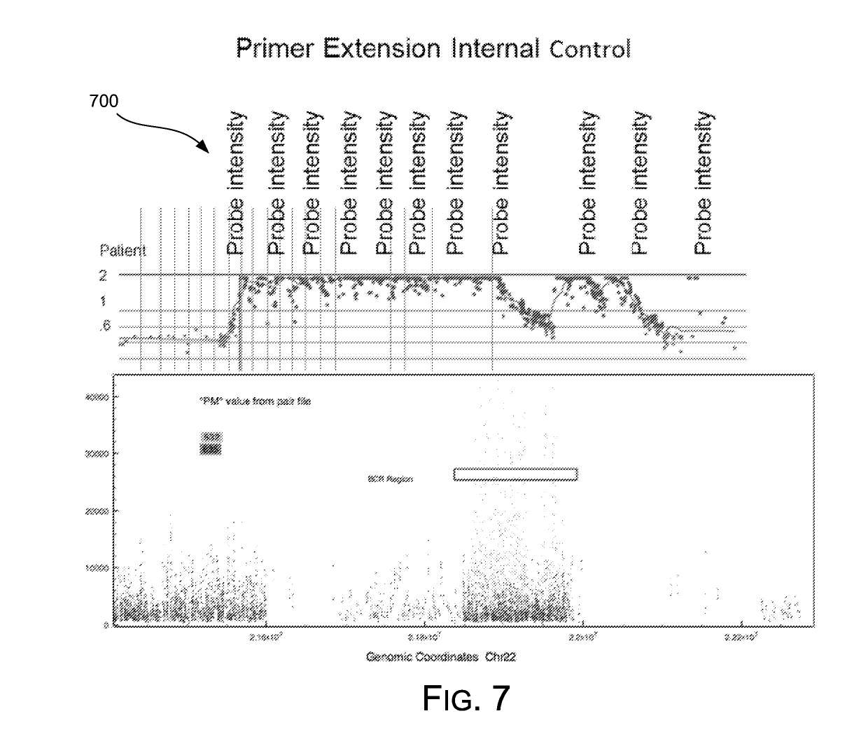

FIG. 7 shows an example hybridization output overlaid with probe intensity zones 700 determined by the test location stepper 618 shown in FIG. 6. In one implementation, the quality control engine 600 performs internal quality control of primer extension during or after amplification 112 by verifying consistency from test to test of the probe intensities in each probe intensity zone 700 (or at a selected point in each probe intensity zone 700).

### Example 6

### Exemplary Aneuploidy/Mosaicism Analyzer

FIG. 8 shows an example aneuploidy/mosaicism analyzer 800 introduced in FIG. 3, in greater detail. The aneuploidy/mosaicism analyzer 800 can be used individually as a separate component, but also represents an additional module that can be added to the array hybridization analyzer 400 shown in FIG. 4. The illustrated implementation is only one example configuration to introduce some features and components of an engine that performs additional chromosomal analyses on a single multiplex (+/−) stranded CGH microarray 104. Many other arrangements and components for an aneuploidy/mosaicism analyzer are possible within the scope of the subject matter described herein. The illustrated aneuploidy/mosaicism analyzer 800 can be implemented in hardware, or in combinations of hardware and software, and in one implementation comprises logic for detecting a whole-chromosome count and additional chromosomal aberrations over those determined by the genomic translocations detector 402, the translocation partner gene detector 404, and the DNA copy number variation detector 406 of the array hybridization analyzer 400 shown in FIG. 4.

The following list of components is only one example list. The illustrated aneuploidy/mosaicism analyzer 800 includes a probe intensities input 802 that may include a plus (+) strand channel input 804 and a minus (−) strand channel input 806 for differentiating plus (+) strand and minus (−) strand probe intensities received from scanning a (+/−) stranded CGH microarray 104. A chromosome mapper 808 uses coordinates of genomic backbone probes 208 (by way of example) 810 to sample probe intensities from each arm of each chromosome in a patient's chromosome set. Other probes that have been amplified from regions throughout a patient's chromosome set may also be used instead of or in addition to generic backbone probes that mark the entire genome at regular intervals.

A per chromosome probe intensity compiler 812 includes an arm compiler 814 and a signal intensity averager 816. The per chromosome intensity compiler 812 collects the probe intensity information associated with each chromosome (or each arm of each chromosome) and the signal intensity averager 816 computes a signal intensity value for the chromosome (or arm of a chromosome).

A patient chromosome set mapper 818 generates an image, graph, or description of each chromosome as represented by the probe intensities from the probe intensity compiler 812. Thus, if the patient is missing part of a chromosome, that part will not show on the mapped image or graph. In one implementation, a (+/−) stranded CGH microarray 104 includes probes to test for extra chromosomes that a patient might possess, and that do not appear in the control genomic DNA sample 102. Thus, the patient chromosome set mapper 818 can map extra chromosomes as well as missing chromosomes and parts.

A display engine 820 controls visual reporting output. The output may be a graph 822, a histogram, bar chart, etc., or an image of the patient's chromosome set. In one implementation, the display 438 shows a plus (+) strand display 824 of the patient chromosome set and a separate minus (−) strand display 826 of the patient chromosome set.

A diagnostic suggestion engine 828 includes an aneuploidy estimator 830 to suggest a variation in normal chromosome count, and a mosaicism estimator 832 to provide a level or rating indicative of whether some cells within the same person have a different genetic constitution than others.

A reporting engine 834 provides information, such as a message 836 containing a suggested aneuploidy result and a suggested level of mosaicism in the patient.

### Example 7

### Exemplary (+/−) CGH Methods

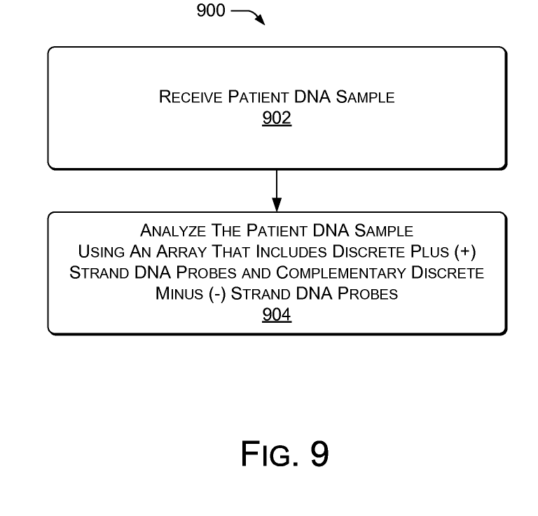

FIG. 9 shows an example method 900 of analyzing patient genomic DNA using an array that includes both plus (+) strand DNA probes and minus (−) strand DNA probes. In the flow diagram, the operations are summarized in individual blocks. The exemplary method 900 may be performed by hardware or by combinations of hardware and software, for example, by components of the example system shown in FIG. 3.

At block 902, a patient DNA sample is received. The DNA sample is typically extracted from tissue such as blood or bone marrow.

At block 904, the patient DNA sample is analyzed after amplification for chromosomal rearrangements at genomic loci using an array that includes both discrete plus (+) strand DNA probes and discrete minus (−) strand DNA probes.

The analysis includes visualizing hybridization to the plus (+) strand DNA probes and the minus (−) strand DNA probes as separate processes. Each plus (+) strand DNA probe and each corresponding minus (−) strand DNA probe are complementary reciprocals of each other and provide hybridization targets for at least part of a DNA sequence of each respective genomic locus.

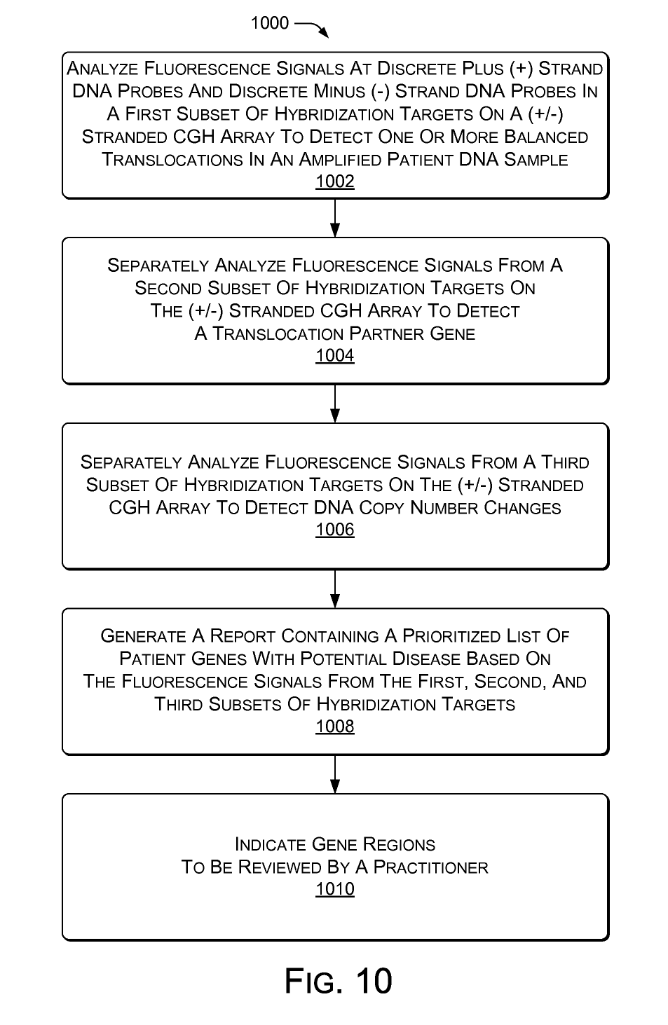

FIG. 10 shows an exemplary method 1000 of analyzing multiple hybridization results generated from a multiplex (+/−) stranded CGH array. In the flow diagram, the operations are summarized in individual blocks. The exemplary method 1000 may be performed by hardware or by combinations of hardware and software, for example, by components of the example array hybridization analyzer 400 shown in FIG. 4.

At block 1002, fluorescence signals are analyzed from discrete plus (+) strand DNA probes and discrete minus (−) strand DNA probes in a first subset of hybridization targets on a (+/−) stranded CGH array to detect one or more balanced translocations in an amplified patient DNA sample.

At block 1004, fluorescence signals from a second subset of hybridization targets on the (+/−) stranded CGH array are separately analyzed to identify a translocation partner gene.

At block 1006, a third subset of hybridization targets on the (+/−) stranded CGH array are separately analyzed to detect DNA copy number changes in the same region as the balanced translocation, or across the complete human genome.

At block 1008, a report is generated containing a prioritized list of genes indicative of disease, based on the analysis of the signals from the first, second, and third subsets of hybridization targets.

At block 1010, gene regions to be reviewed by a practitioner are indicated on the report.

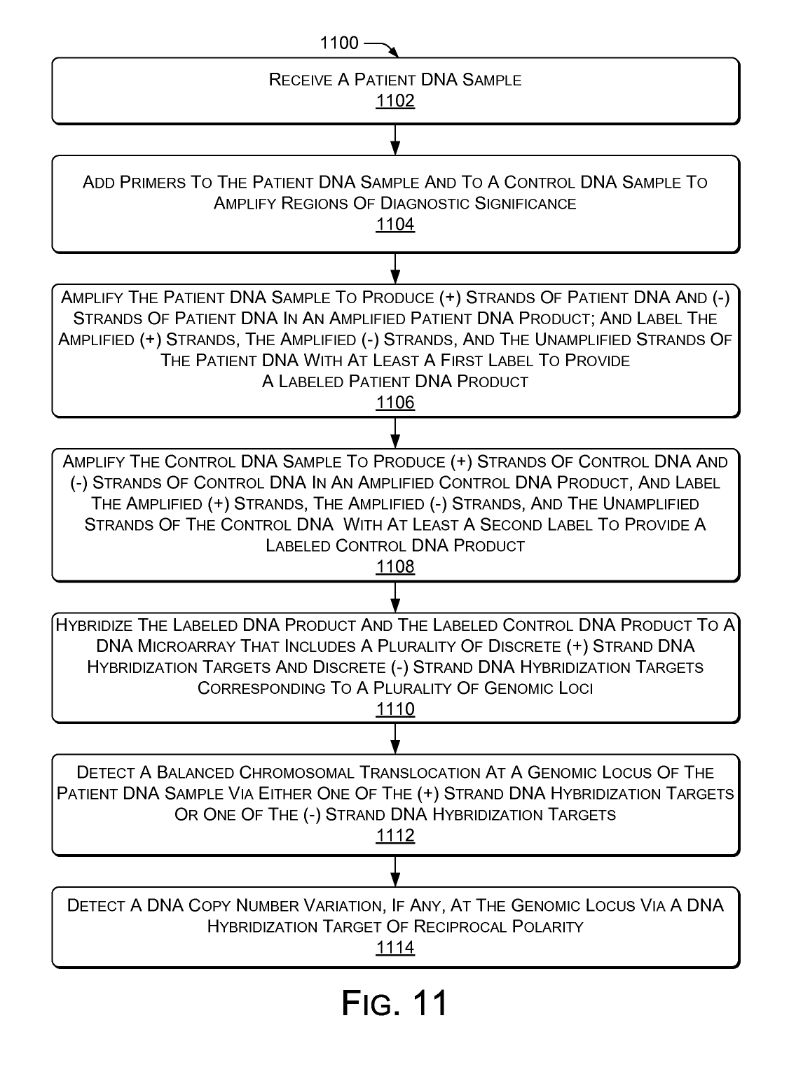

FIG. 11 shows an exemplary method 1100 of performing (+/−) stranded array CGH. In the flow diagram, the operations are summarized in individual blocks. The exemplary method 1100 may be performed by hardware or by combinations of hardware and software, for example, by components of the example system shown in FIG. 3.

At block 1102, a patient genomic DNA sample is received. The DNA sample is typically extracted from tissue such as blood or bone marrow.

At block 1104, primers are added to the patient genomic DNA sample and to a control genomic DNA sample to amplify chromosomal regions of diagnostic significance. The regions of diagnostic significance may be, for example, frequently translocated genes indicative of various diseases, including ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB.

At block 1106, the patient DNA sample undergoes amplification to produce plus (+) strands of patient DNA and minus (−) strands of patient DNA for an amplified patient DNA product; and the amplified plus (+) strands, the amplified minus (−) strands, and the unamplified strands of patient DNA undergo labeling with at least a first label to provide a labeled patient DNA product.

At block 1108, the control DNA sample undergoes amplification to produce plus (+) strands of control DNA and minus (−) strands of control DNA for an amplified control DNA product; and the amplified plus (+) strands, the amplified minus (−) strands, and the unamplified strands of control DNA undergo labeling with at least a second label to provide a labeled control DNA product.

At block 1110, the labeled patient DNA product and the labeled control DNA product are hybridized to a DNA microarray that includes a plurality of discrete plus (+) strand DNA hybridization targets and discrete minus (−) strand DNA hybridization targets corresponding to a plurality of genomic loci.

At block 1112, a balanced chromosomal translocation is detected at a genomic locus of the patient DNA via either at least one of the plus (+) strand DNA hybridization targets or at least one of the minus (−) strand DNA hybridization targets.

At block 1114, a DNA copy number variation, if any, is detected at the genomic locus via a DNA hybridization target of reciprocal polarity.

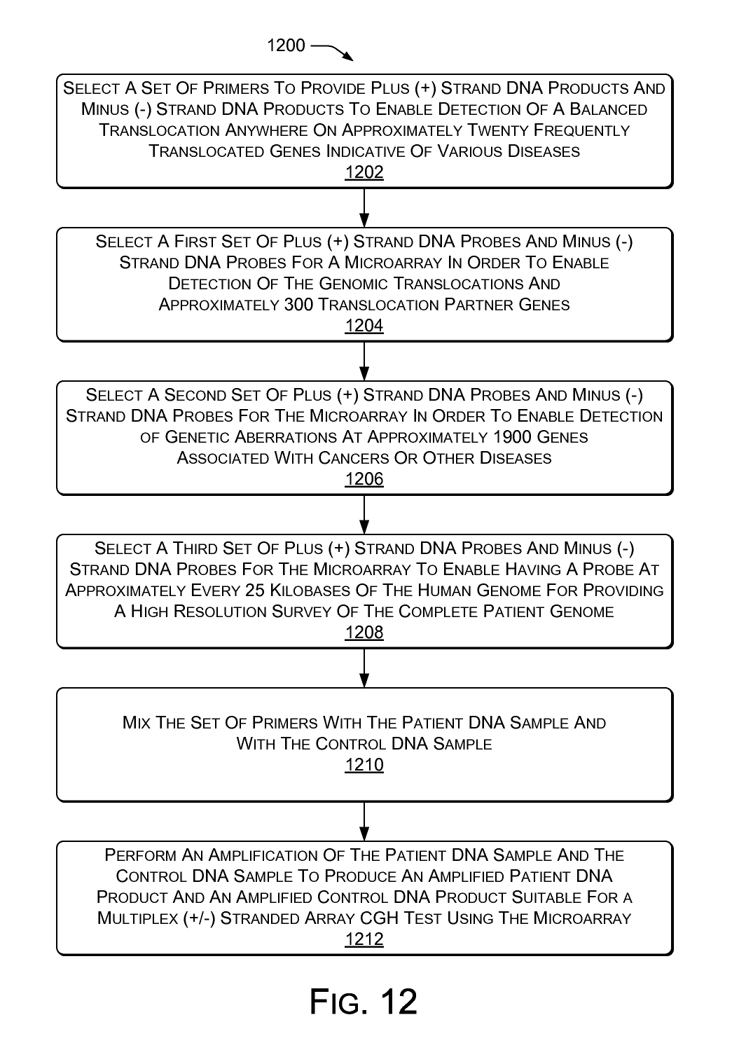

FIG. 12 shows an exemplary method 1200 of performing (+/−) stranded array CGH including amplifying with primers to produce plus (+) strand and minus (−) strand DNA products representing chromosomal regions of diagnostic significance in patient and control genomic DNA samples and including selecting plus (+) strand probes and minus (−) strand probes for a microarray to test the regions of diagnostic significance. In the flow diagram, the operations are summarized in individual blocks.

At block 1202, a set of primers is selected to provide plus (+) strand DNA products and minus (−) strand DNA products that enable detection of a balanced translocation anywhere on approximately twenty frequently translocated genes indicative of various diseases. In one implementation, the twenty frequently translocated genes indicative of various diseases include ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB.

At block 1204, a first set of plus (+) strand DNA probes and minus (−) strand DNA probes are selected for the microarray to enable detection of the balanced translocations and approximately 300 translocation partner genes.

At block 1206, a second set of plus (+) strand DNA probes and minus (−) strand DNA probes are selected for the microarray to enable detection of genetic aberrations at approximately 1900 genes associated with cancers.

At block 1208, a third set of probes is selected for the microarray to enable having a probe at approximately every 25 kilobases of the human genome for providing a high resolution survey of the complete patient genome.

At block 1210, the set of primers is mixed with a patient DNA sample and a control DNA sample.

At block 1212, an amplification is performed on the patient genomic DNA sample mixed with the primers and on the control genomic DNA sample mixed with the primers to produce an amplified patient DNA product and an amplified control DNA product suitable for a multiplex (+/−) array CGH test using the microarray.

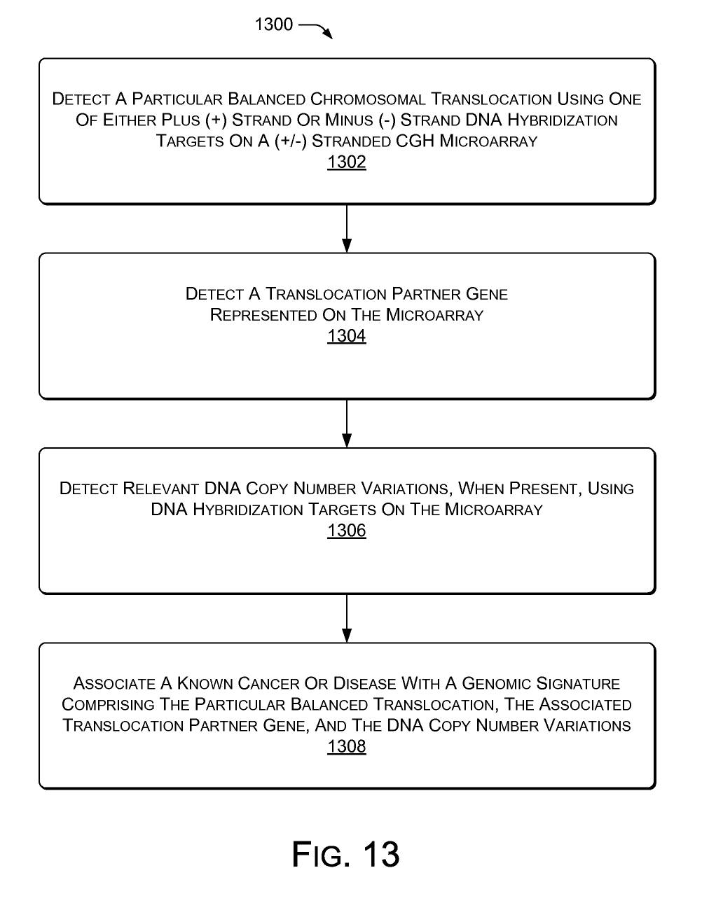

FIG. 13 shows an exemplary method 1300 of compiling a genomic signature characterizing a cancer or other disease. In the flow diagram, the operations are summarized in individual blocks. The exemplary method 1300 may be performed by hardware or by combinations of hardware and software, for example, by components of the example (+/−) stranded CGH array hybridization analyzer 400 shown in FIG. 4.

At block 1302, a particular balanced chromosomal translocation is detected using either the plus (+) strand or the minus (−) strand DNA hybridization targets on a (+/−) stranded CGH microarray.

At block 1304, a translocation partner gene represented on the microarray is identified.

At block 1306, relevant DNA copy number variations, when present, are detected using DNA hybridization targets on the microarray.

At block 1308, a known cancer or disease is associated with the genomic signature comprising the particular balanced translocation, the associated translocation partner gene, and the DNA copy number variations.

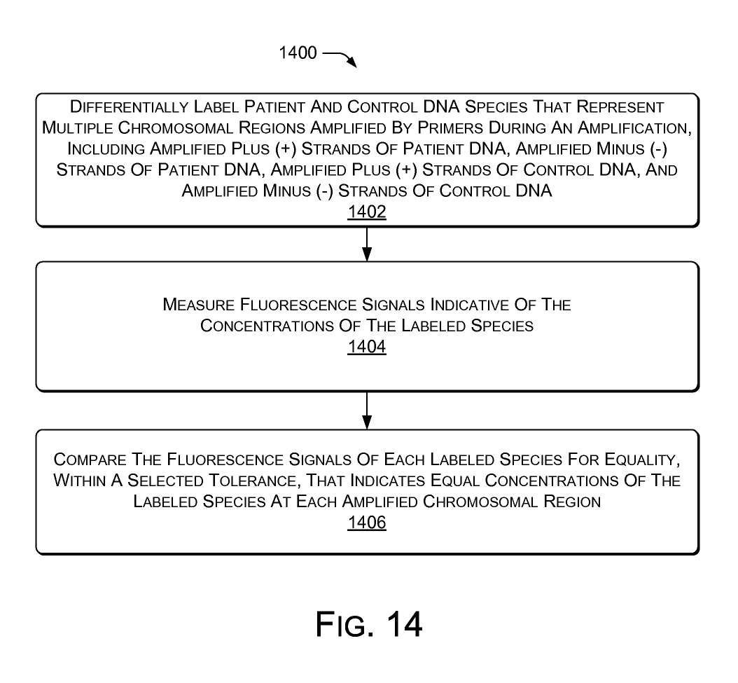

FIG. 14 shows an exemplary method 1400 of performing quality control of amplification used in (+/−) stranded array CGH. In the flow diagram, the operations are summarized in individual blocks. The exemplary method 1400 may be performed by hardware or by combinations of hardware and software, for example, by components of the example quality control engine 600 shown in FIG. 6.

At block 1402, the patient and control DNA species that represent multiple chromosomal regions amplified by primers during an amplification are differentially labeled. This includes the plus (+) strands of patient DNA, the minus (−) strands of patient DNA, the plus (+) strands of control DNA, and the minus (−) strands of control DNA. The amplified patient and control products are usually labeled with two respective labels.

At block 1404, fluorescence signals indicative of the concentration of each labeled species are measured.

At block 1406, the fluorescence signals of each labeled species are compared for equality, within a selected tolerance, that indicates equal concentrations of the labeled species associated with each of the multiple chromosomal regions.

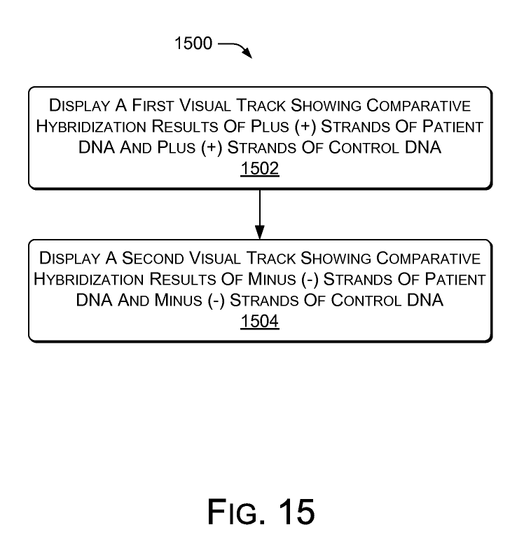

FIG. 15 shows an exemplary method 1500 of displaying hybridization results of (+/−) stranded DNA in at least two visual tracks. In the flow diagram, the operations are summarized in individual blocks. The exemplary method 1500 may be performed by hardware or by combinations of hardware and software, for example, by components of the example array hybridization analyzer 400 shown in FIG. 4.

At block 1502, comparative genomic hybridization results of the plus (+) strands of patient DNA and the plus (+) strands of control DNA are displayed in a first visual track.

At block 1504, comparative genomic hybridization results of the minus (−) strands of patient DNA and the minus (−) strands of control DNA are displayed in a second visual track.

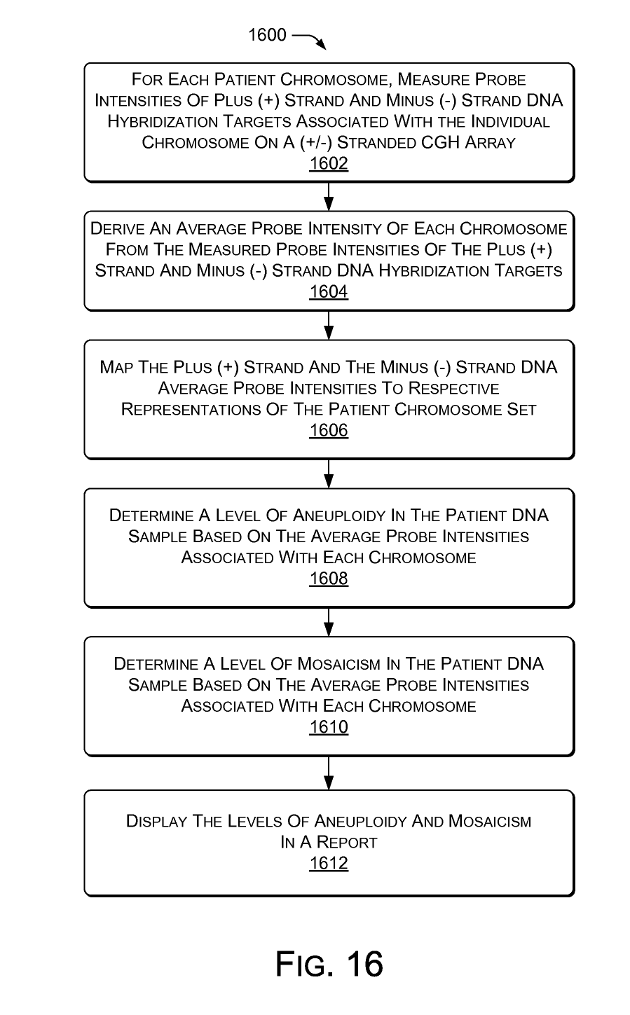

FIG. 16 shows an exemplary method 1600 of analyzing aneuploidy and mosaicism in a patient genomic DNA sample tested on a (+/−) stranded CGH array. In the flow diagram, the operations are summarized in individual blocks. The exemplary method 1600 may be performed by hardware or by combinations of hardware and software, for example, by components of the example aneuploidy/mosaicism analyzer 800 shown in FIG. 8.

At block 1602, for each patient chromosome, respective probe intensities of plus (+) strand and minus (−) strand DNA hybridization targets associated with the individual chromosome on a (+/−) stranded CGH array are measured.

At block 1604, an average probe intensity of each chromosome is derived from the measured probe intensities of the plus (+) strand and the minus (−) strand DNA hybridization targets.

At block 1606, the plus (+) strand and minus (−) strand DNA average probe intensities per chromosome are mapped to respective representations of the patient chromosome set.

At block 1608, a presence or absence of aneuploidy in the patient DNA sample is determined based on the average probe intensities associated with each chromosome.

At block 1610, a level of mosaicism in the patient DNA sample is determined based on the average plus (+) and minus (−) probe intensities of each chromosome.

At block 1612, the determined presence or absence of aneuploidy and the level of mosaicism is displayed in a report.

It would be understood that some elements of this description (detecting alterations in micro RNAs, measurements of raw amplification signals, etc.) can be achieved without regard to plus (+) and minus (−) strand polarity by utilizing a highly robust labeling technology that labels the amplification products irrespective of strand.

### Example 8

### Exemplary (+/−) Non-CGH Method

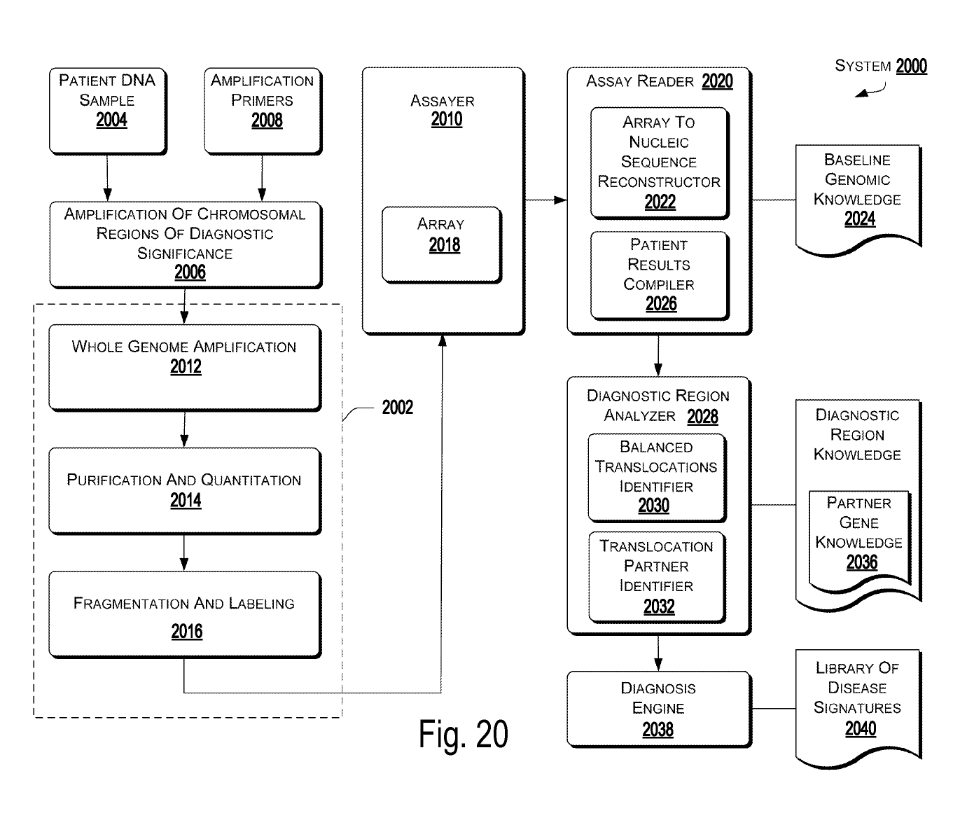

FIG. 20 shows an overview of an illustrative system for detecting balanced chromosomal translocations in a non-CGH context. The illustrated overview includes components and a few process steps 2002 that are shown as implementation detail.

A patient DNA sample 2004, as extracted from tissue such as blood or bone marrow, undergoes an amplification process 2006 with a set of primers 2008.

The amplification 2006 generates copies of chromosomal regions in the patient DNA sample 2004 that have diagnostic significance (the term as used herein also includes prognostic significance). The chromosomal regions selected to be amplified are those in which balanced translocations indicative of disease are likely to happen. An example linear amplification implementation of the amplification 2006 is described below.

In one implementation, the amplified products undergo process steps 2002, in preparation for testing by an assayer 2010. The process steps 2002 may include whole genome amplification 2012 after the amplification 2006 of the select regions. The process steps 2002 may also include purification and quantitation 2014 of the amplified products, and then fragmentation and labeling 2016.

Amplification primers 2008 are added to the patient DNA sample 2004 for carefully moderated amplification 2006, for example, a linear amplification, to create target sequences that span regions of interest, that is, regions in which a balanced translocation may occur. In one implementation, the primers extend selected chromosomal regions approximately 10,000 to 20,000 bases each. In one implementation, the primers 2008 provide a rich mixture of plus (+) strand and minus (−) strand DNA sequences representing the chromosomal regions selected for their relevance to various diseases, i.e., because a balanced translocation is likely to occur in one or more of the regions as opposed to chromosomal regions not selected for amplification. In one implementation, the selected chromosomal regions are those that include one or more of the following genes: ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB.

The amplification 2006 may be a particular type of linear amplification as described in International Patent Application PCT/US2008/083014 to Greisman (WO 2009/062166), entitled, “DNA Microarray Based Identification and Mapping of Balanced Translocation Breakpoints,” which is incorporated herein by reference in its entirety.

The linear amplification described in the Greisman reference provides one way to create probes that span translocation breakpoints and extend at least part ways into a partner gene of a translocated chromosome, thereby enabling detection of balanced translocations using array CGH. Other methods besides linear amplification, however, may be used to accomplish the same objective. For example, nonlinear amplifications that provide cycling across the breakpoints may be used. In fact, many methods that can create a probe that spans across a breakpoint may be employed.

In one implementation of the system shown in FIG. 20, an example set of forward and reverse amplification primers 106 (see for example, Tables 1 and 2) are used so that the amplification 106 creates different plus (+) strand and minus (−) strand target sequences representing each selected region. The original stands of DNA in the patient DNA sample 2004 remain too, unamplified.

After amplification 2006, one of the succeeding steps is labeling 2016 of the patient amplified and unamplified products. The labeling 2022 generates corresponding labeled strands of the amplified DNA, each labeled strand being the reciprocal or complement of its corresponding unlabeled strand. In a (+/−) stranded version of the amplification 2006, this generates labeled minus (−) strand patient DNA, and labeled plus (+) strand patient DNA. The labeling may be carried out as described elsewhere herein.

The assayer 2010 reveals the make-up of the patient's DNA. This is typically accomplished, in one implementation, by hybridizing the amplification products of the patient DNA sample 2004 to an array 2018. The array 2018 may work in a number of different non-CGH ways, depending on platform.

In one implementation, the example array 2018 is an ILLUMINA HUMANCYTOSNP-12 BEADCHIP (Illumina, Inc., San Diego, Calif.). Such an array 118 can includes up to approximately 300,000 or more genetic markers that target abnormalities associated with hundreds of syndromes. In this implementation, the array 2018 includes probes to test 400 genes involved in developmental defects, mental retardation, and other structural changes.

In addition to focused content in relevant regions for cytogenetic research, the HUMANCYTOSNP-12 BEADCHIP array 2018 provides dense, uniform coverage across the entire genome with 6.2 kb median marker spacing. This example array 2018 also includes approximately 200,000 tag SNPs covering different ethnic populations for whole-genome association studies.

Such an ILLUMINA platform is a bead-based array system that has the aforementioned 300K microbeads covered with copies of DNA probes target on the bead surfaces. The patient DNA is hybridized to the beads and is extended from the probe in a sequence-specific manner. If there is a match between the last base of the probe and the DNA sample target the DNA is extended generating a specific fluorescent color based on the identity of the first base incorporated.

The hybridized genomic DNA is removed from the array 2018 and the assay results visualized in an assay reader 2020 by scanning, similar to aCGH. An array-to-nucleic-sequence reconstructor 2022 uses knowledge of the array layout to make sense of signals scanned from the array probes. The assay reader 2020 applies baseline genomic knowledge 2024, from past experiments and/or from genomic databases, to detect aberrations in the patient's DNA. A patient results compiler 2026 summarizes remarkable findings of the assay reader 2020. It should be noted that in some implementations the assayer 2010 and the assay reader 2020 are often integrated into a single seamless platform, however, they are shown as separable components in FIG. 20 for the sake of description.

Using the ILLUMINA implementation of the array 2018, as just described, and amplification primers such as those in Table 1, the system 2000 detects, for example, the presence and location of a BCR/ABL1 translocation in a patient's DNA sample 2004. That is, a diagnostic region analyzer 2028, which includes a balanced translocations identifier 2030 and a translocation partner identifier 2032 draws on a database of diagnostic region knowledge 2034 and partner gene knowledge 2036 to determine the occurrence of the balanced transformation. A diagnosis engine 2038 may suggest a cancer or other disease diagnosis based on the balanced translocation findings and other associated genetic aberrations, e.g., by consulting a library of disease signatures 2040. In one implementation, the diagnosis engine 2038 includes a learning engine that grooms the library of disease signatures 2040 (for example, via an Internet link, where other instances of the system 2000 also improve the library of disease signatures 2040).

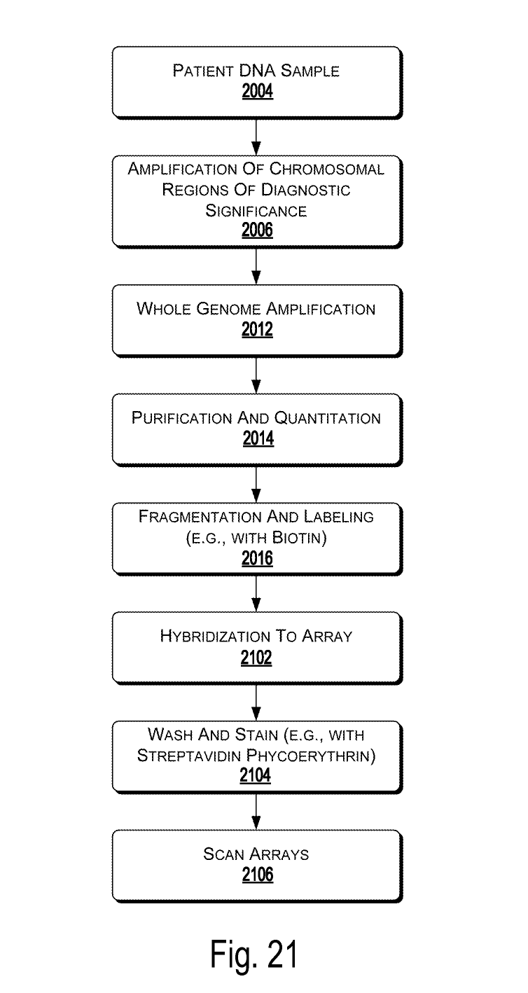

In another implementation, the example array 2018 is an AFFYMETRIX GENOME-WIDE HUMAN SNP ARRAY 6.0 (Affymetrix, Inc., Santa Clara, Calif.). This AFFYMETRIX implementation of the array 2018 has 1.8 million genetic markers, including more than 906,600 probes to survey single nucleotide polymorphisms (SNPs) and more than 946,000 probes for detection of copy number variation. In this implementation, hybridizing the amplified patient DNA products on the array 2018 is preceded by preparation steps shown in FIG. 21. Some of the process steps of FIG. 21 are also shown as process steps 102 in FIG. 20, but FIG. 21 shows a more complete cycle from a received patient DNA sample 104 through array scanning 2106.

An example AFFYMETRIX process with this implementation of the array 2018 includes receiving the patient DNA sample 2004, amplifying chromosomal regions of interest for detecting balanced translocations 2006, whole genome amplification 2012, purification and quantitation 2014, fragmentation and labeling (e.g., with biotin) 2016, hybridization 2102 to the array 2018, washing and staining 2104 (e.g., with streptavidin phycoerythrin), and array scanning 2106. In summary, this implementation using an AFFYMETRIX platform digests the patient DNA sample 2004 with restriction enzymes, anneals primers to the ends of these products, and amplifies them in a typical PCR reaction. The resulting DNA is fragmented, end-labeled and hybridized to the array 2018, without using control DNA as a comparison. Such a system 2000 using the AFFYMETRIX platform identifies the same translocation breakpoints as can be detected by aCGH-based methods herein.

### Example 9

### Exemplary (+/−) Stranded Non-CGH Detection of Balanced Translocations

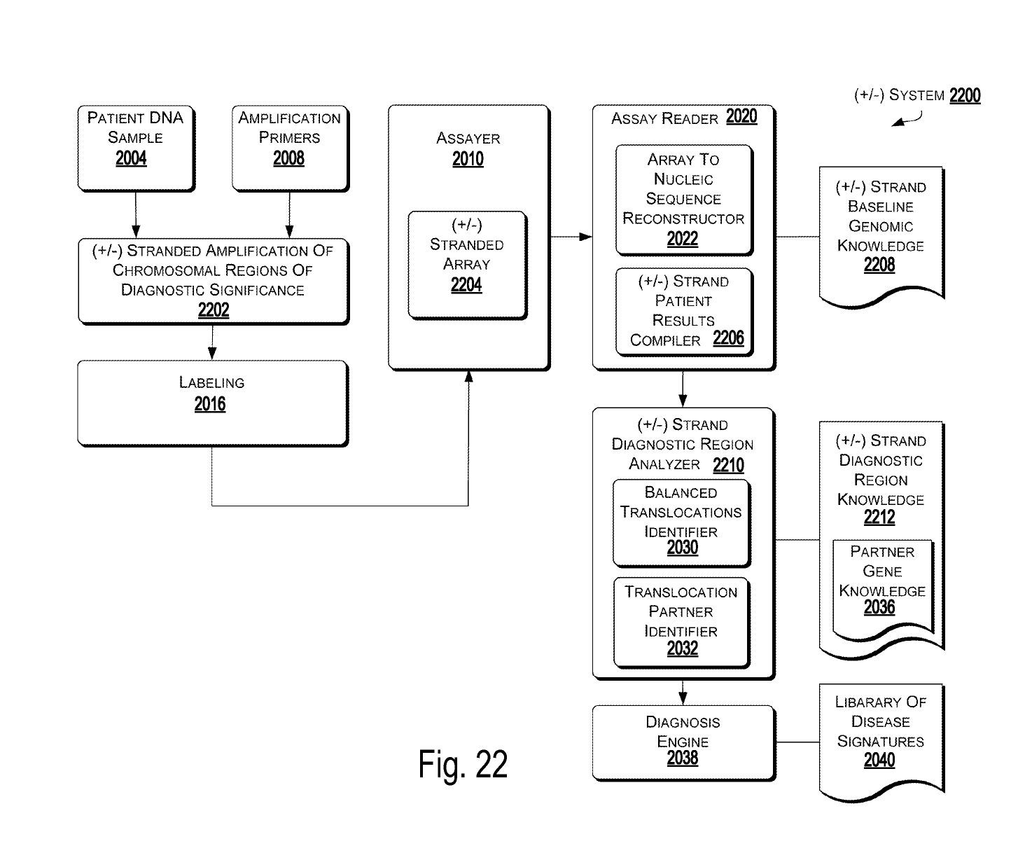

FIG. 22 shows a (+/−) stranded non-CGH system 2200 for detecting balanced translocations without using reference DNA as a control. Many of the components are similar to those shown in FIG. 21. However, amplification primers 2008′, such as a set of primers selected from those shown in Tables 1 and 2, create DNA targets representing chromosomal regions of interest, in both plus (+) strand and minus (−) strand versions. At the assayer 2010, a novel array 2204 includes probes for testing plus (+) strand targets and minus (−) strand targets.

Sometimes the plus (+) orientation is required for detection of a balanced translocation and sometimes the minus (−) orientation is required. Thus the (+/−) array 2204 provides more comprehensive detection of balanced translocations than conventional non-CGH arrays that may not be sensitive to genes that code from the minus (−) strand. A novel array 2204 can be constructed by including complementary minus (−) stranded oligos to an otherwise plus (+) strand-based ILLUMINA SNP array/platform or plus (+) strand-based AFFYMETRIX array/platform.

A (+/−) strand patient results compiler 2206 is aware of (+/−) strand baseline genomic knowledge 2208 for enhanced patient diagnostic results based on both (+) strand views and minus (−) strand views. Likewise, a (+/−) strand diagnostic region analyzer 2210 is aware of (+/−) strand diagnostic region knowledge 2212 to provide better identification of balanced translocations and translocation partner genes than conventional systems that try to rely on DNA targets of only one polarity to find translocations.

### Example 10

### Exemplary Array for Non-CGH Applications

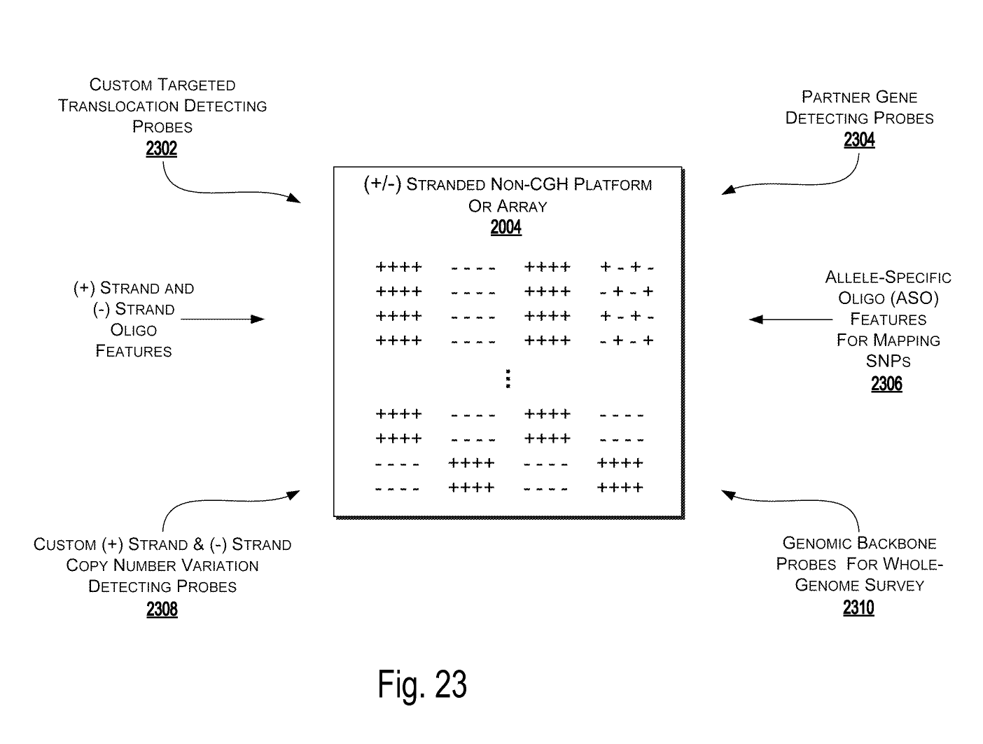

FIG. 23 shows the example non-CGH array 2204 of FIG. 22 in greater schematic detail. The plus (+) strand and minus (−) strand oligos constituting the hybridization probes on the array 2204 can be arranged in any suitable order or pattern. See for example, U.S. patent application Ser. No. 11/057,088 to Shaffer at al., entitled, “Methods and Apparatuses For Achieving Precision Diagnoses,” incorporated herein by reference. The (+/−) stranded array 2204 may be a tiling density DNA microarray. Each (+/−) stranded array 2204 is typically both a whole-genome array and a custom targeted array. As a whole-genome array, the (+/−) stranded array 2204 can detect DNA copy number variations that may occur across the entire genome. As a custom targeted array, the (+/−) stranded array 2204 specifically targets loci in numerous regions of diagnostic interest. The (+/−) stranded array 2204 can be designed with both uniform and mixed-density probe spacing.

An exemplary (+/−) stranded array 2204 includes approximately 720,000 oligos (probes), half of these comprising plus (+) strand DNA and half comprising minus (−) strand DNA, not counting control probes, i.e., a backbone probe at every span of approximately 25 kilobases. A specific exemplary (+/−) stranded array 2204 is a single array that has coverage for approximately 700 genes known to be deleted or amplified in cancers, coverage for approximately 315 genes involved in balanced translocations, coverage for genes with expression changes and approximately 1900 genes implied or suggested to be relevant to cancer (see Table 3 for an illustrative list of such genes). The exemplary (+/−) stranded array 2204 may also have micro RNAs specifically targeted, as these are known as important diagnostic cancer markers.

In one implementation, the (+/−) stranded array 2204 includes subsets of probes. The partitioning of oligos into subsets on the array, and particularly plus (+) strand oligos and minus (−) strand oligos, may be physical, as when oligos with a common functionality or purpose are sequestered to a limited part of the array, or the subsets may be logical, as when the oligos are physically arranged at random or according to some other scheme, yet tracked so that the scanning results can be logically recompiled.

In one implementation, the (+/−) stranded array 2204 may include any mix of: plus (+) strand and minus (−) strand translocation detecting probes 2302, partner gene detecting probes 2304, allele-specific SNP probes 2306, copy number variation detecting probes 2308, and a host of genomic backbone probes 410 that provide coverage of the entire genome at intervals. As above, the (+/−) stranded array 2204 may also target micro RNAs for diagnosing cancers and other diseases.

Table 3 shows an illustrative list of genes to be probed by a (+/−) stranded cancer-targeted array 2204.

### Example 11

### Exemplary Hardware Environment for Non-CGH Applications

The system 2000 performs many functions either directly or indirectly in a computing environment. That is, amplification 2006, labeling, quality control, and so forth are generally computer-controlled, computer-assisted, or computer-monitored. Scanning, analysis, display, and reporting of results are also mediated by a computing device.

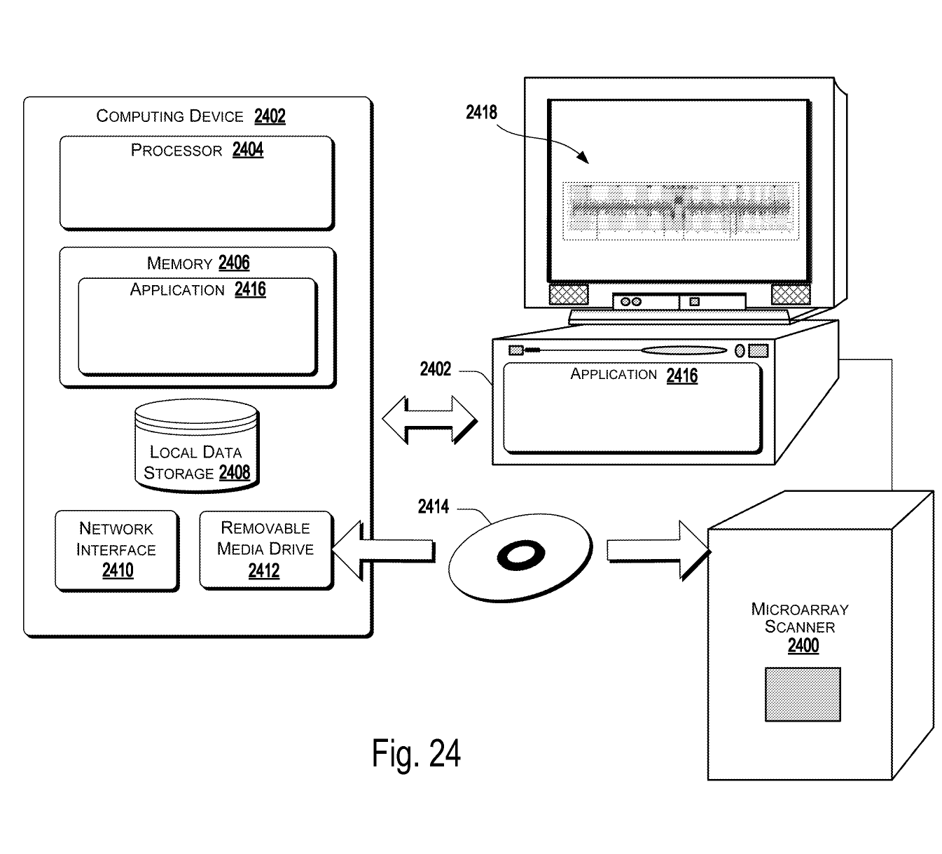

FIG. 24 shows an example computing environment and components of an exemplary (+/−) stranded array system 2200. An example hardware component, a microarray scanner 2400, is representative as a placeholder in FIG. 24 of molecular diagnostics equipment in general. The microarray scanner 2400 may contain a computing device and/or may be communicatively coupled with a computing device 2402. The illustrated layout is relatively elementary compared to the layout of equipment in an actual clinical diagnostics laboratory, but shows some example relationships between laboratory hardware, i.e., as represented by the example microarray scanner 2400, and computer hardware and software. Other possible computer-controlled equipment may include polymerase chain reaction (PCR) thermocyclers (not shown) for amplification processes 2006 and microarray spotters/printers (not shown) for creating (+/−) stranded arrays 2204.

The computing device 2402 typically includes a processor 2404, memory 2406, local data storage 2408, a network interface 2410, and a media drive 2412 for a removable storage medium 2414. The removable storage medium 2414 is a machine-readable storage entity that contains machine-executable instructions, which when executed by a machine, causes the machine to perform illustrative methods to be described herein. Such a removable storage medium 2214 may be read directly by the microarray scanner 2400, for example, when the microarray scanner 2400 includes a computing device and a media drive, and/or may be read by the communicatively coupled computing device 2402, which then signals the microarray scanner 2400 (or other lab hardware) to function in a certain manner.

The microarray scanner 2400 (or other lab hardware) may include an application 2416, such as a scanner software application, either loaded as machine-executable instructions from a removable storage medium 2414 or built into the hardware fabric of the machine. For example, the application 2416 may be implemented as an application specific integrated circuit (ASIC). Alternatively, the coupled computing device 2402 may include the application 2416, e.g., loaded as instructions in memory 2406. The application 2416 may include modules or engines for performing programs relevant to the exemplary amplification 2106 using a novel set of the primers 2008 or relevant to analyzing results from hybridization of the (+/−) stranded array 2204.

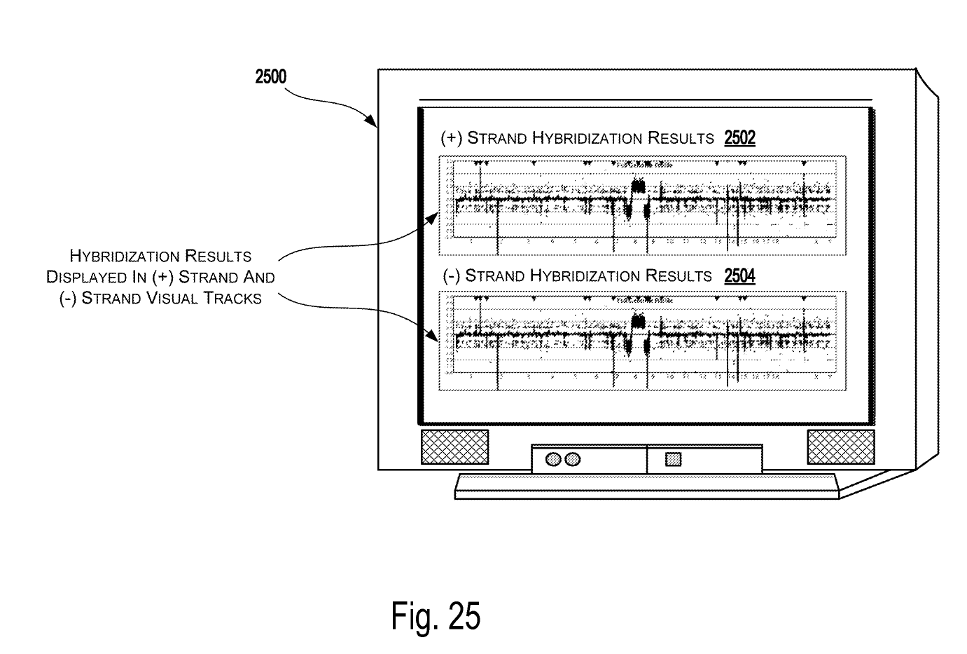

FIG. 25 shows an example display 2500 presenting hybridization results from the dual viewpoint of the plus (+) strand visual track 2502 and the corresponding minus (−) strand visual track 2504. For example, the (+) strand visual track 2502 may reveal a balanced translocation in a chromosomal region from the plus (+) strand amplified patient DNA while the (−) strand visual track 2504 shows copy number changes in the same region from (−) strands of the unamplified patient DNA.

### Example 12

### Exemplary Non-CGH Method

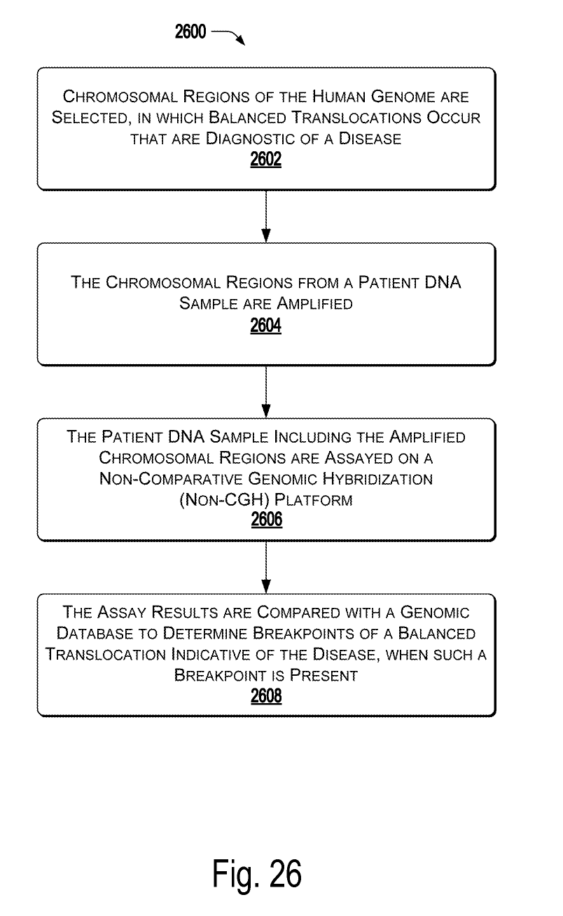

FIG. 26 shows an example method 2600 of detecting balanced chromosomal translocations on a non-CGH platform. In the flow diagram, the operations are summarized in individual blocks. The exemplary method 2600 may be performed by hardware or by combinations of hardware and software, for example, by components of the example systems shown in FIGS. 20 and 22.

At block 2602, chromosomal regions of the human genome are selected, in which balanced translocations occur that are diagnostic of a disease. At block 2604, the chromosomal regions from a patient DNA sample are amplified. In one implementation, the amplification generates plus (+) and minus (−) strands of DNA, each representing a given chromosomal region from a plus (+) view or a complementary minus (−) view.

At block 2606, the patient DNA sample including the amplified chromosomal regions are assayed on a non-comparative genomic hybridization (non-CGH) platform.

At block 2608, the assay results are compared with a genomic database to determine breakpoints of a balanced translocation indicative of the disease, when such a breakpoint is present. When the implementation uses plus (+) and minus (−) strands of DNA, then the comparison of each strand polarity with a genomic database informed with plus (+) strand and minus (−) strand knowledge of genetic aberrations provides two different and complementary tools, as the plus (+) strand view and the minus (−) strand view may reveal different genomic results.

It will be understood that some elements of this description (e.g., detecting alterations in micro RNAs, measurements of raw amplification signals, etc.) can be achieved without regard to plus (+) and minus (−) strand polarity by utilizing a highly robust labeling technology that labels the amplification products irrespective of strand.

### Example 13

### Exemplary Encoded Particle Method

This example describes a procedure for constructing an encoded particle array for detecting chromosomal abnormalities, such as balanced translocations, according to aspects of the methods described herein. In this example, each “probe” DNA is associated with an encoded particle have a unique signature that renders it detectably distinct from other encoded particles (and thus other probes). To prepare an exemplary particle array, a first probe DNA is coupled to a first set of encoded particles, typically using a standard protocol provided by the manufacturer of the particle assay platform, to obtain a first probe-coupled particle set. This step is repeated, separately, for a second probe DNA and a second encoded particle set to obtain a second probe-coupled particle set. The coupling process is repeated for additional probe DNAs n and encoded particles n to make an additional n probe-coupled particles sets. The particle sets can be combined into one or more pools, and a resultant probe-coupled particle mixture(s) can be used in an assay for detecting balanced translocations and other chromosomal abnormalities as is described herein. The number of encoded particle sets possible can range from a few to hundreds using well known commercially available encoded particle assay platforms based on the particular chromosomal abnormalities to be detected.

For use in an assay involving probe-coupled particle mixtures, the DNA to be tested is typically amplified and labeled. The specifics of the labeling reagents for this example have been selected as appropriate for the Luminex xMAP systems, but other labeling can be used. A DNA sample from a subject, and separately, a control DNA sample, is subjected to the specific amplification of chromosomal regions of interest, such as one or more of diagnostic significance. The amplified DNA is labeled with biotin, for example using an exo-Klenow enzyme and anucleotide mix that includes biotinylated nucleotides, such as biotin-dCTP (PerkinElmer, Boston Mass.), Next, the labeled sample is purified, for example using a PureLink PCR purification kit (Invitrogen, Carlsbad Calif.). The purified labeled DNA is then hybridized to the probe-coupled particle mixture(s), typically in a well of a PCR-type 96-well microplate (Bio-Rad Laboratories, Hercules Calif.) in a shaking incubator. After hybridization, the mixture is washed and stained, for example with streptavidin-phy,coerythrin (Prozyme, Hayward Calif.) as a fluorescent reporter, for example in a well of a filter plate (Millipore, Bedford Mass.). After washing, the fluorescence of the particles in the mixture is read on an appropriate reading instrument for the reporter, such as a Luminex L200 or FlexMap 3D in this example. The reporter signals are detected for the subject and control DNA samples, and a comparison of these signals is performed to detect differences between the subject and control chromosomal regions of interest.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

Lengthy table referenced here
US20110086772A1-20110414-T00001
Please refer to the end of the specification for access instructions.

Lengthy table referenced here
US20110086772A1-20110414-T00002
Please refer to the end of the specification for access instructions.

Lengthy table referenced here
US20110086772A1-20110414-T00003
Please refer to the end of the specification for access instructions.

LENGTHY TABLES
The patent application contains a lengthy table section. A copy of the table is available in electronic form from the USPTO web site (http://seqdata.uspto.gov/?pageRequest=docDetail&DocID=US20110086772A1). An electronic copy of the table will also be available from the USPTO upon request and payment of the fee set forth in 37 CFR 1.19(b)(3).

1. A method for detecting chromosomal rearrangements, comprising receiving a DNA sample and analyzing the DNA sample via comparative genomic hybridization for chromosomal rearrangements using an array of plus (+)-stranded DNA probes and minus (−)-stranded DNA probes.

2. The method of claim 1, wherein at least some of the plus (+)-stranded DNA probes each have a corresponding minus (−)-stranded DNA probe, wherein a plus (+)-stranded DNA probe and a corresponding minus (−)-stranded DNA probe are complementary reciprocals of each other.

3. The method of claim 2, wherein a plus (+)-stranded DNA probe and a corresponding minus (−)-stranded DNA probe provide complementary hybridization targets for analyzing a chromosomal rearrangement of at least part of a DNA sequence of a genomic locus.

4. The method of claim 1, further comprising visualizing hybridization results at the plus (+)-stranded DNA probes and the minus (−)-stranded DNA probes as separate analyses defining one or more chromosomal rearrangements at genomic loci.

5. The method of claim 1, wherein analyzing the DNA sample includes performing an array analysis using an array that includes discrete plus (+)-stranded DNA probes and discrete minus (−)-stranded DNA probes as separate hybridization targets.

6. A method for detecting chromosomal rearrangements, comprising:
receiving a subject DNA sample;
receiving a control DNA sample;
adding primers to the subject DNA sample and the control DNA sample for amplifying chromosomal regions;
amplifying the subject DNA sample to produce plus (+) strands of patient DNA and minus (−) strands of subject DNA representing the chromosomal regions, the (+) strands of subject DNA and the minus (−) strands of subject DNA within a subject DNA product that includes amplified subject DNA and unamplified subject DNA;
labeling the plus (+) strands and the minus (−) strands of the subject DNA product with at least a first label to provide a labeled subject DNA product;
amplifying the control DNA sample to produce plus (+) strands of control DNA and minus (−) strands of control DNA representing the chromosomal regions, the (+) strands of control DNA and the minus (−) strands of control DNA within a control DNA product that includes amplified control DNA and unamplified control DNA; and
labeling the plus (+) strands and the minus (−) strands of the control DNA product with at least a second label to provide a labeled control DNA product.

7. The method of claim 6, further comprising attaching plus (+) strand DNA hybridization targets and minus (−) strand DNA hybridization targets to a single comparative genomic hybridization (CGH) array for simultaneously detecting one or more of:
a balanced translocation in the chromosomal regions of diagnostic significance;
a translocation partner gene associated with a detected balanced translocation;
a copy number gain; and
a copy number loss.

8. The method of claim 7, further comprising attaching microRNAs to the CGH array as hybridization targets.

9. The method of claim 7, further comprising analyzing the subject DNA sample, wherein said analyzing comprises hybridizing the labeled subject DNA product and the labeled control DNA product to the CGH microarray, the CGH microarray including the plurality of plus (+) strand DNA hybridization targets and the minus (−) strand DNA hybridization targets corresponding to the plurality of genomic loci.

10. The method of claim 9, further comprising detecting a DNA copy number variation at a genomic locus via at least one of the complementary reciprocal DNA hybridization targets.

11. The method of claim 9, further comprising detecting a disease condition via one of the plus (+) strand DNA hybridization targets or the minus (−) strand DNA hybridization targets.

12. The method of claim 9, further comprising detecting a balanced chromosomal translocation at a genomic locus of the subject DNA sample via one of the plus (+) strand DNA hybridization targets or one of the minus (−) strand DNA hybridization targets.

13. The method of claim 12, further comprising identifying a translocation partner gene associated with the balanced chromosomal translocation.

14. The method of claim 12, wherein detecting a balanced chromosomal translocation at a genomic locus in the subject DNA sample includes detecting a hybridization pattern on the microarray, the pattern indicating one or more of:
a decline in a subject DNA fluorescence signal following or adjacent to a translocation breakpoint in the DNA sequence representing the genomic locus;
a corresponding increase in a subject DNA fluorescence signal at one or more DNA hybridization targets representing the translocation partner gene on the array; and
an absence of corresponding declines and increases in the corresponding control DNA fluorescence signals.

15. The method of claim 6, further comprising selecting first primers to provide plus (+) strand DNA products and minus (−) strand DNA products that enable detection of a genomic translocation in a gene selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB.

16. The method of claim 6, further comprising selecting second primers to provide plus (+) strand DNA products and minus (−) strand DNA products that enable detection of translocation partner genes.

17. The method of claim 6, further comprising labeling the subject DNA sample and the control DNA sample non-enzymatically to prevent making additional plus (+) and/or minus (−) strand copies of DNA during the labeling.

18. The method of claim 6, further comprising labeling the amplified subject DNA product and the amplified control DNA product with separate labels, wherein each separate label can be differentiated.

19. A method for detecting chromosomal rearrangements, comprising:
obtaining a DNA sample;
amplifying the DNA sample to produce plus (+)-stranded DNA and minus (−)-stranded DNA representing chromosomal regions of diagnostic interest within a DNA product that includes amplified DNA and unamplified DNA;
labeling the plus (+)-stranded DNA and the minus (−)-stranded DNA with at least a first label to provide a labeled DNA product;
hybridizing the labeled DNA product to an array that includes plus (+)-stranded DNA targets and complementary minus (−)-stranded DNA targets; and
analyzing the microarray to detect a chromosomal translocation in the labeled DNA product.

20. The method of claim 19, further comprising visualizing hybridization results at the plus (+)-stranded DNA probes and the minus (−)-stranded DNA probes as separate analyses, wherein some chromosomal translocations are detected by the (+)-stranded DNA probes while other chromosomal translocations are detected by the (−)-stranded DNA probes.

21. An array for the detection of chromosomal abnormalities comprising plus (+)-stranded DNA probes and minus (−)-stranded DNA probes.

22. The array of claim 21, wherein at least some of the plus (+)-stranded DNA probes each have a corresponding minus (−)-stranded DNA probe, wherein a plus (+)-stranded DNA probe and a corresponding minus (−)-stranded DNA probe are complementary reciprocals of each other.

23. The array of claim 21, wherein substantially all of the plus (+)-stranded DNA probes each have a corresponding minus (−)-stranded DNA probe, wherein a plus (+)-stranded DNA probe and a corresponding minus (−)-stranded DNA probe are complementary reciprocals of each other.

24. The array of claim 21, wherein the array includes probes specific for a gene selected from the group consisting of ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB.

25. The array of claim 21, wherein the array includes probes specific for at least 10 of the following genes: ABL1, ALK, BCR, CBFB, ETV6, IGH, IGK, IGL, MLL, PDGFB, PDGFRB, PICALM, RARA, RBM15, RPN1, RUNX1, TCF3, TLX3, TRA/D, and TRB.
